(19) United States
(12) Patent Application Publication
(10) Pub. No.: US 2026/0304305 A1
(43) Pub. Date: Oct. 1, 2026

(54) METHODS, ARCHITECTURES, APPARATUSES AND SYSTEMS FOR RADIO AND NON-RADIO MEASUREMENT BASED CONTROL OF LAYER 1/LAYER 2 (L1/L2) MOBILITY

(71) Applicant: InterDigital Patent Holdings, Inc., Wilmington, DE (US)

(72) Inventors: Umer Salim, Vallauris (FR); Pascal Adjakple, Great Neck, NY (US); Ravikumar Pragada, Warrington, PA (US)

(21) Appl. No.: 19/479,460

(22) PCT Filed: Apr. 26, 2024
(86) PCT No.: PCT/US2024/026604

§ 371 Date: Oct. 28, 2025

Related U.S. Application Data
(60) Provisional application No. 63/462,622, filed on Apr. 28, 2023.

(51) Int. Cl. H04W 48/20; H04W 64/00; H04W 88/08

(52) U.S. Cl. CPC H04W 48/20; H04W 64/006; H04W 88/085

(57) ABSTRACT

Procedures, methods, architectures, apparatuses, systems, devices, and computer program products for wireless transmit/receive unit (WTRU) controlled layer 1/layer 2 triggered mobility (LTM). For example, the WTRU may receive information indicating a set of layer 1/layer 2 triggered mobility (LTM) configurations. The set of LTM configurations may be associated with and/or may include a set of events for triggering LTM switching to a set of candidate cells (and/or beams). The WTRU may perform a first set of non-radio measurements to determine a zone. A subset of the LTM configurations may be activated based on the determined zone. The WTRU may perform an LTM switch to one of the candidate cells based on one of the activated LTM configurations. The activated LTM configuration used for the LTM switch may be associated with an event that is triggered (e.g., jointly) using a second set of radio and non-radio measurements.

### CROSS-REFERENCE TO RELATED APPLICATIONS

This application claims the benefit of U.S. Provisional Patent Application No. (i) 63/462,622 filed 28 Apr. 2023, which is incorporated herein by reference.

### TECHNICAL FIELD

The present disclosure is generally directed to the fields of communications, software and encoding, including, for example, to methods, architectures, apparatuses, systems directed to Layer 1/Layer 2 (L1/L2) mobility of wireless transmit/receive units (WTRUs) which may be based on radio and/or non-radio measurements. L1/L2 mobility may be controlled based on radio and/or non-radio measurements.

### BACKGROUND

In wireless communications, legacy mobility procedures may operate at the radio resource control (RRC) layer. The RRC layer may also be referred to as Layer 3 (L3).

### SUMMARY

In a radio access network (RAN), a WTRU may perform (e.g., control) mobility procedures, such as lower layer triggered mobility procedures, such as in 5G New Radio (NR) systems.

In certain representative embodiments, procedures for activation and/or deactivation of L1/L2 configurations, radio and non-radio measurements may be performed by a WTRU for WTRU-controlled L1/L2 triggered mobility (LTM).

In certain representative embodiments, a WTRU may perform procedures for zone-based activation and/or deactivation of mobility configuration(s). For example, a WTRU may send information indicating at least one capability (e.g., a WTRU capability) associated with lower layer mobility and/or LTM handling, and/or relevant assistance information to support LTM procedures based upon joint radio and/or non-radio measurement quantities. For example, a WTRU may receive information indicating coverage and/or deployment topologies and/or relevant configurations associated therewith. For example, a WTRU may receive information indicating one or more LTM configurations and/or suitable LTM radio and/or non-radio measurement quantities and/or (e.g., suitable) joint events for LTM switching. For example, a LTM candidate configuration may indicate a list of active zones where a WTRU may (e.g., shall) activate the configuration. For example, a subset of LTM configurations may be indicated as active (e.g., activated) by a network, such as part of a configuration and/or initialization. For example, a WTRU may receive (e.g., be configured with) information indicating a set of (e.g., additional periodic) measurements for configuration activation and/or deactivation. For example, the measurements may be non-radio measurements, such as those (e.g., necessary) to determine a WTRU zone according to a coverage configuration. For example, a WTRU may be configured to perform (e.g., configured) radio and/or non-radio measurements, such as those associated with an activated LTM configuration. For example, a WTRU may be configured to perform (e.g., configured) non-radio measurements for activation and/or deactivation (e.g., of LTM configurations). For example, a WTRU may determine its zone (e.g., a zone where the WTRU is located) through non-radio measurements.

For example, a WTRU may determine that a (e.g., newly) determined zone is different from a previously determined zone. For example, a WTRU may deactivate any (e.g., all) activated candidate LTM configurations which are not associated with the determined zone (e.g., do not include the newly determined zone in their list of active zones). For example, a WTRU may activate any (e.g., all) candidate LTM configurations which are (e.g., deactivated and) associated with the determined zone (e.g., do include the newly determined zone in their list of active zones). For example, a WTRU may transmit (e.g., uplink) information of any (e.g., all) activated LTM candidate configurations, such as where configured by the network to do so.

In certain representative embodiments, a WTRU may perform procedures for WTRU-controlled L1/L2 triggered mobility with measurements and/or triggers using radio and/or non-radio measurement quantities. For example, a WTRU may send information indicating at least one capability (e.g., a WTRU capability) associated with lower layer mobility and/or LTM handling, and/or relevant assistance information to support LTM procedures based upon joint radio and/or non-radio measurement quantities. For example, a WTRU may receive information indicating coverage and/or deployment topologies and/or relevant configurations associated therewith. For example, a WTRU may receive information indicating one or more LTM configurations and/or suitable LTM radio and/or non-radio measurement quantities and/or (e.g., suitable) joint events for LTM switching. For example, a network may indicate any joint events (e.g., LTM-J1 to LTM-J6) as part of a WTRU-controlled switching configuration for triggering the switching. For example, a WTRU may perform (e.g., configured) radio and/or non-radio measurements according to a (e.g., configured) timing for measurements and/or availability from (e.g., local) sensors. For example, a WTRU may determine its zone (e.g., a zone where the WTRU is located) through non-radio measurements. For example, a WTRU may evaluate a configured joint event with the conditions set over the measurements of radio and/or non-radio quantities.

For example, a WTRU may determine that an event(s) associated with an active configuration is triggered. For example, a WTRU may select one of the configurations for which execution event/conditions get fulfilled, such as where the selection may be based upon a priority indicated with the LTM configurations, intra-DU/inter-DU switching nature, and/or WTRU implementation. For example, a WTRU may perform a LTM mobility switch (e.g., based on a network command). For example, a WTRU may perform protocol stack handling (e.g., based on a network configuration). For example, a WTRU may transmit (e.g., uplink) information indicating any of the foregoing actions, such as where configured by the network to do so.

In certain representative embodiments, a WTRU may receive deployment and/or coverage zone information. The WTRU 102 may receive configuration information indicating a LTM configuration associated with an intra-distributed unit (intra-DU) switch or an inter-DU switch. For example, the LTM configuration may be associated with a joint triggering event based on (i) one or more radio measurement quantities and (ii) one or more non-radio measurement quantities. The WTRU may perform one or more radio measurements and one or more non-radio measurements. The WTRU 102 may perform one of the intra-DU switch or the inter-DU switch which is associated with the LTM configuration based on the joint triggering event being satisfied using (i) the one or more radio measurement quantities obtained from the radio measurements and (ii) the one or more non-radio measurement quantities obtained from the non-radio measurements and the deployment and coverage zone information. The WTRU may, after performing one of the intra-DU switch or the inter-DU switch, send an uplink indication of the one of the intra-DU switch or the inter-DU switch.

In certain representative embodiments, a WTRU may receive configuration information indicating a set of LTM configurations. For example, the set of LTM configurations may be associated with a set of triggering events based on one or more radio measurement quantities. The WTRU may perform one or more L1/L2 radio measurements. The WTRU may determine a subset of the LTM configurations which are associated with a subset of the triggering events which are satisfied using the one or more radio measurement quantities obtained from the one or more L1/L2 radio measurements. The WTRU may perform a L1/L2 mobility switch to one of the subset of the LTM configurations. The WTRU may, after performing the L1/L2 mobility switch, send an uplink indication of the L1/L2 mobility switch (e.g., intra- or the inter-DU switch).

In certain representative embodiments, a WTRU may receive deployment and/or coverage zone information. The WTRU may receive, from the network, configuration information indicating a set of LTM configurations. For example, the set of LTM configurations may be (e.g., respectively) associated with a set of zones, and (e.g., respectively) associated with a set of triggering events based on (i) one or more radio measurement quantities and (ii) one or more non-radio measurement quantities. The WTRU may perform one or more non-radio measurements. The WTRU 102 may determine a current zone of the WTRU (e.g., based on the one or more non-radio measurements). The WTRU 102 may select a first subset of the LTM configurations which are associated with the current zone. The WTRU may perform one or more radio measurements. The WTRU may activate a second subset, from the first subset of the LTM configurations, which are associated with a subset of the triggering events which are satisfied using (i) the one or more radio measurement quantities obtained from the one or more radio measurements and (ii) the one or more non-radio measurement quantities obtained from the non-radio measurements. The WTRU may send, to the network, information indicating the activated second subset of the LTM configurations.

In certain representative embodiments, a WTRU may receive deployment and/or coverage zone information. The WTRU may receive, from the network, configuration information indicating a first set of LTM configurations. For example, the set of LTM configurations may be (e.g., respectively) associated with a set of zones, and may be associated with a set of triggering events based on (i) one or more radio measurement quantities and (ii) one or more non-radio measurement quantities. The WTRU may perform one or more first non-radio measurements. The WTRU may determine a current zone of the WTRU 102 (e.g., based on the one or more first non-radio measurements and the deployment and/or coverage zone information). The WTRU may perform one or more radio measurements and one or more second non-radio measurements based on the set of zones associated with the first set of the LTM configurations not including the current zone (e.g., not having any active LTM configurations for the current zone). The WTRU may send, to the network, information indicating a request for LTM configurations associated with the current zone based on the one or more radio measurements and the one or more second non-radio measurements.

In certain representative embodiments, a WTRU may receive deployment and/or coverage zone information. The WTRU may receive configuration information indicating a set of LTM configurations. For example, the configuration information may include information indicating an active subset of the set of LTM configurations. The WTRU may perform one or more radio measurements and one or more non-radio measurements. The WTRU may perform a LTM switch (e.g., intra- or inter-DU switch) using a respective LTM configuration from the active subset of LTM configurations based on a joint triggering event being satisfied using (i) one or more radio measurement quantities obtained from the radio measurements, (ii) one or more non-radio measurement quantities obtained from the non-radio measurements, and/or (iii) the deployment and/or coverage zone information. The joint triggering event may be associated with the respective LTM configuration. After performing the LTM switch, the WTRU may send an uplink indication associated with the respective LTM configuration.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a procedural diagram illustrating an example procedure for an intra-NR inter-gNB handover;

FIG. 3 is a procedural diagram illustrating an example procedure for intra-NR RAN conditional handover;

FIG. 4 is a system diagram illustrating an example of NCJT-based transmission with single-DCI;

FIG. 5 is a system diagram illustrating an example of NCJT-based transmission with multi-DCI;

FIG. 6 is a procedural diagram of an example procedure for initial coverage and/or LTM configurations and coverage and/or LTM configuration updating;

FIG. 7 is a LTM measurement framework diagram illustrating an example of associations between a LTM measurement identity and LTM measurement resource configurations;

FIG. 8 is a LTM measurement framework diagram illustrating another example of associations between a LTM measurement identity and LTM measurement resource configurations;

FIG. 9 is a LTM measurement framework diagram illustrating another example of associations between a LTM measurement identity and LTM measurement resource configurations, LTM measurement quantity configurations, and reporting configurations;

FIG. 10 is a LTM measurement diagram illustrating an example LTM measurement model with L1/L2 filtering;

FIG. 11 is a LTM measurement diagram illustrating an example LTM measurement model with L1 and L3 based events;

FIG. 12 is a LTM measurement diagram illustrating an example LTM measurement model with measurement biasing;

FIG. 13 is a LTM measurement diagram illustrating an example LTM measurement model unified with L3 based measurements;

FIG. 14 is a syntax diagram illustrating examples of information elements which provide association of measurement identities with activation, deactivation and execution conditions;

FIG. 15 is a procedural diagram illustrating an example of a UE controlled lower layer mobility procedure using radio and non-radio measurements;

FIG. 16 is a procedural diagram illustrating an example procedure for UE controlled non-radio measurement based activation of LTM configurations;

FIG. 17 is a procedural diagram illustrating an example procedure for UE controlled zone based activation of LTM configurations;

FIG. 18 is a procedural diagram illustrating a representative procedure for UE controlled LTM with differentiated intra-DU and inter-DU handling;

FIG. 19 is a procedural diagram illustrating an example procedure for conditional LTM mobility using radio measurements;

FIG. 20 is a procedural diagram illustrating a representative example of a UE candidate configuration request procedure;

FIG. 21 is a procedural diagram illustrating a representative example of a LTM procedure;

FIG. 22 is a procedural diagram illustrating a representative example of another LTM procedure;

FIG. 23 is a procedural diagram illustrating a representative example of another LTM procedure;

FIG. 24 is a procedural diagram illustrating a representative example of another LTM procedure; and

FIG. 25 is a procedural diagram illustrating a representative example of another LTM procedure.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

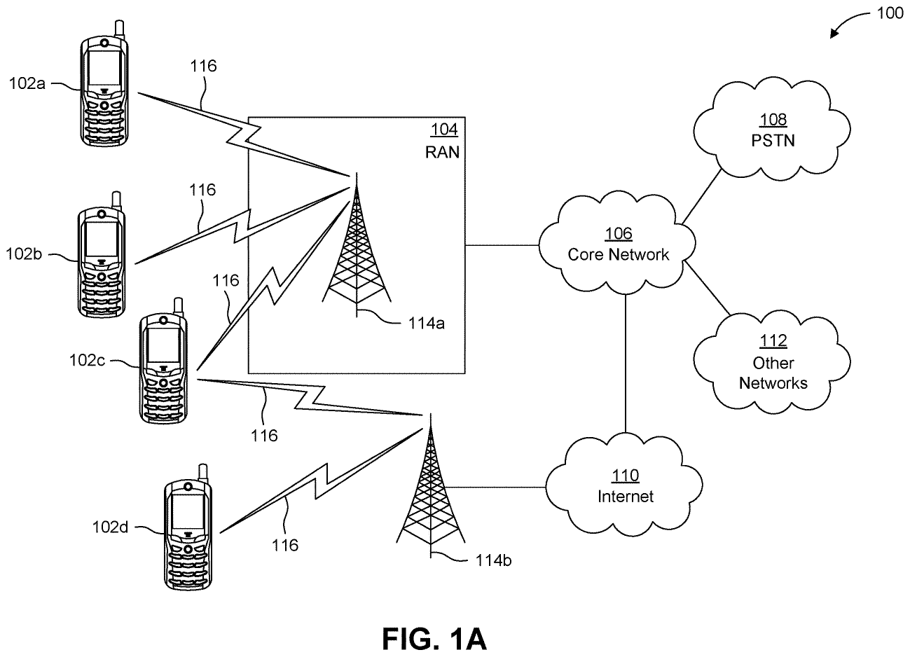

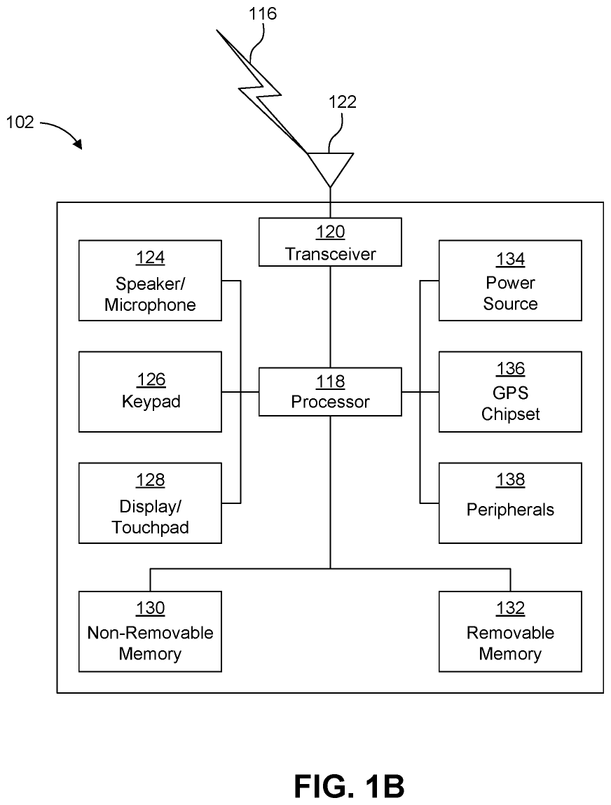

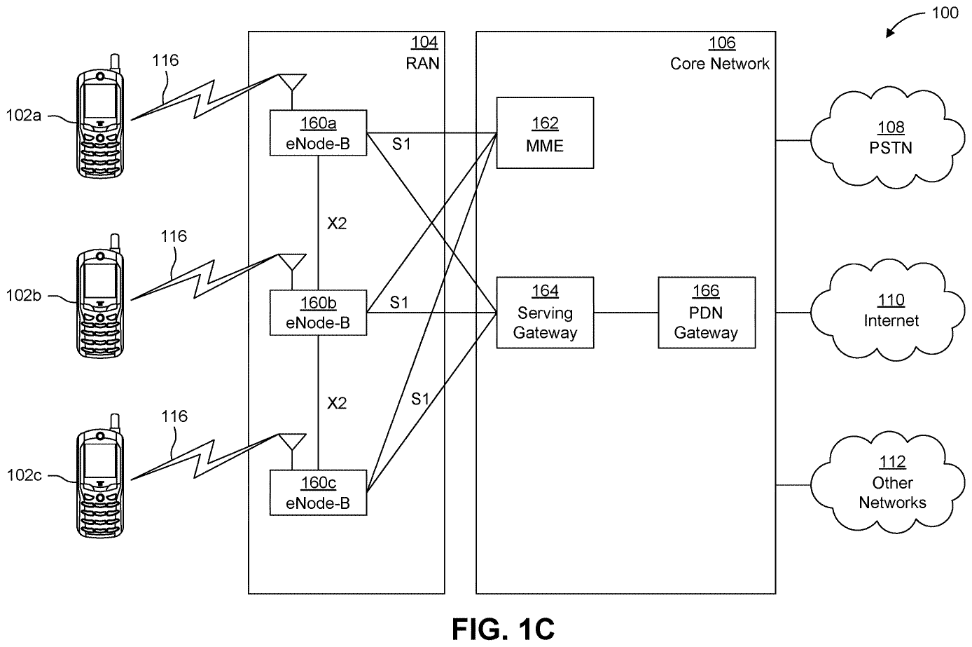

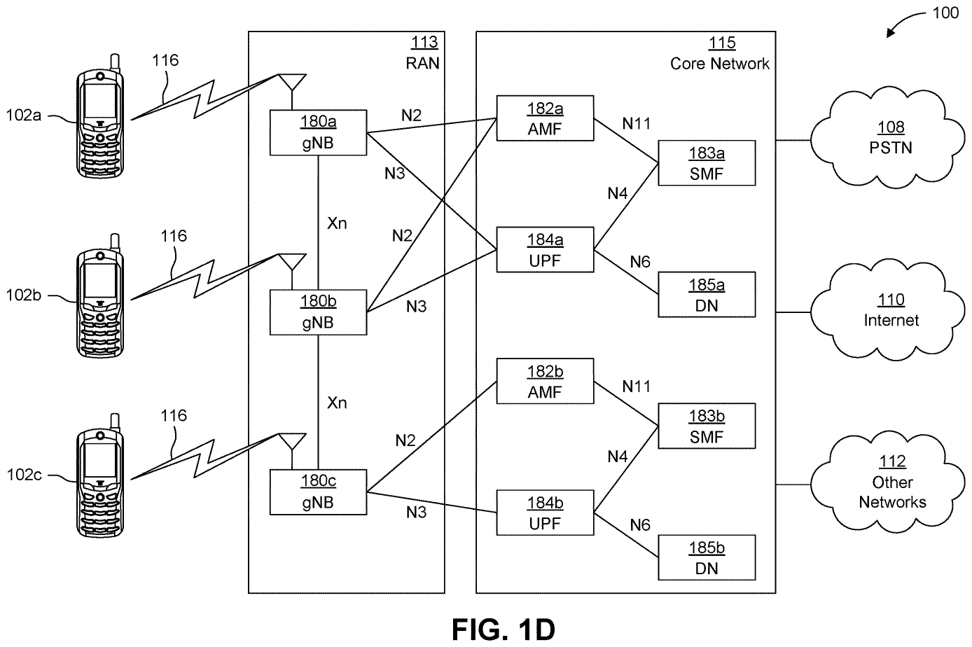

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### INTRODUCTION

The following acronyms and abbreviations may be used herein:

3GPP: 3rd Generation Partnership Project
BFD: Beam Failure Detection
BFI: Beam Failure Instance
BFR: Beam Failure Recovery
BFDR: Beam Failure Detection and Recovery
DAPS: Dual Active Protocol Stack
C-RNTI: Cell RNTI
CE: Control Element
CFRA: Contention Free RACH Access
CHO: Conditional Handover
CN: Core Network
CORESET: Control Resource Set
CSI: Channel State Information
CSI-RS: CSI Reference Signals
CU: Control Unit
DAPS: Dual Active Protocol Stack
DCI: Downlink Control Information
DL: Downlink
DMRS: Demodulation Reference Signals
DRX: Discontinuous Reception
DU: Distributed Unit
E-UTRAN: Enhanced Universal Terrestrial Radio Access Network
FoV: Field of View
FR1: Frequency Range 1
FR2: Frequency Range 2
GCS: Global Coordinate System
gNB: Next Generation Node B
GNSS: Global Navigation Satellite System
GPRS: General Packet Radio Service
GSM: Global System for Mobile Communications
HO: Handover
IE: Information Element
ICBM: Intra-Cell Beam Management
Layer 1: L1
Layer 2: L2
Layer 1/Layer 2: L1/L2
Layer 3: L3
LCS: Local Coordinate System
LAN: Local Area Network
LMF: Location Management Function
LTM: L1/L2 Triggered Mobility
MAC: Medium Access Control
MAC-CE: MAC Control Element
MCG: Master Cell Group
MIB: Master Information Block
MIMO: Multiple Input Multiple Output
mmWave: Millimeter wave
NCJT: Non-Coherent Joint Transmission
NG-RAN: Next Generation Radio Access Network
NR: New Radio
NTN: Non-Terrestrial Network
OOO: Out of Sync
PCI: Physical Cell Identity
PDCCH: Physical Downlink Control Channel
PDCP: Packet Data Convergence Protocol
PDSCH: Physical Downlink Shared Channel
PHY: Physical
PLMN: Public Land Mobile Network
PRACH: Physical Random Access Channel
PSS: Primary Synchronization Sequence
PUCCH: Physical Uplink Control Channel
PUSCH: Physical Uplink Shared Channel
QCL: Quasi Co-Location
QoE: Quality of Experience
QoS: Quality of Service
RACH: Random Access Channel
RAN: Radio Access Network
RAT: Radio Access Technology
RB: Resource Block
RLC: Radio Link Control
RLF: Radio Link Failure
RLM: Radio Link Monitoring
RLM-RS: Radio Link Monitoring Reference Signals
RNA: RAN Notification Area
RNTI: Radio Network Temporary Identifier
RRC: Radio Resource Control
RS: Reference Signal
RSARP: Reference Signal Antenna Relative Phase
RSRP: Reference Signal Received Power
RSRQ: Reference Signal Received Quality
RSSI: Reference Signal Strength Indicator
RSTD: Reference Signal Time Difference
Rx: Receive
SCG: Secondary Cell Group
SCS: Sub-Carrier Spacing
SIB: System Information Block
SINR: Signal to Interference and Noise Ratio
SpCell: Special Cell. This is the primary cell of the master cell group. For dual connectivity
operation, this could be the primary cell of the secondary cell group.
SRS: Sounding Reference Signals
SSB: Synchronization Signal and Physical Broadcast Control Channel Block
SSS: Secondary Synchronization Sequence
TA: Tracking Area
TCI: Transmission Configuration Indication
TRP: Transmission Reception Point
TTT: Time to Trigger
Tx: Transmit
UE: User Equipment
UL: Uplink
UTRAN: Universal Terrestrial Radio Access Network
WLAN: Wireless LAN

In certain representative embodiments, a WTRU may perform procedures for zone-based activation and/or deactivation of mobility configuration(s). For example, a WTRU may send information indicating at least one capability (e.g., a WTRU capability) associated with lower layer mobility and/or LTM handling, and/or relevant assistance information to support LTM procedures based upon joint radio and/or non-radio measurement quantities. For example, a WTRU may receive information indicating coverage and/or deployment topologies and/or relevant configurations associated therewith. For example, a WTRU may receive information indicating one or more LTM configurations and/or suitable LTM radio and/or non-radio measurement quantities and/or (e.g., suitable) joint events for LTM switching. For example, a LTM candidate configuration may indicate a list of active zones where a WTRU may (e.g., shall) activate the configuration. For example, a subset of LTM configurations may be indicated as active (e.g., activated) by a network, such as part of a configuration and/or initialization. For example, a WTRU may receive (e.g., be configured with) information indicating a set of (e.g., additional periodic) measurements for configuration activation and/or deactivation. For example, the measurements may be non-radio measurements, such as those (e.g., necessary) to determine a WTRU zone according to a coverage configuration. For example, a WTRU may be configured to perform (e.g., configured) radio and/or non-radio measurements, such as those associated with an activated LTM configuration. For example, a WTRU may be configured to perform (e.g., configured) non-radio measurements for activation and/or deactivation (e.g., of LTM configurations). For example, a WTRU may determine its zone (e.g., a zone where the WTRU is located) through non-radio measurements.

For example, a WTRU may determine that a (e.g., newly) determined zone is different from a previously determined zone. For example, a WTRU may deactivate any (e.g., all) activated candidate LTM configurations which are not associated with the determined zone (e.g., do not include the newly determined zone in their list of active zones). For example, a WTRU may activate any (e.g., all) candidate LTM configurations which are (e.g., deactivated and) associated with the determined zone (e.g., do include the newly determined zone in their list of active zones). For example, a WTRU may transmit (e.g., uplink) information of any (e.g., all) activated LTM candidate configurations, such as where configured by the network to do so.

In certain representative embodiments, a WTRU may perform procedures for WTRU-controlled L1/L2 triggered mobility with measurements and/or triggers using radio and/or non-radio measurement quantities. For example, a WTRU may send information indicating at least one capability (e.g., a WTRU capability) associated with for lower layer mobility and/or LTM handling, and/or relevant assistance information to support LTM procedures based upon joint radio and/or non-radio measurement quantities. For example, a WTRU may receive information indicating coverage and/or deployment topologies and/or relevant configurations associated therewith. For example, a WTRU may receive information indicating one or more LTM configurations and/or suitable LTM radio and/or non-radio measurement quantities and/or (e.g., suitable) joint events for LTM switching. For example, a network may indicate any joint events (e.g., LTM-J1 to LTM-J6) as part of a WTRU-controlled switching configuration for triggering the switching. For example, a WTRU may perform (e.g., configured) radio and/or non-radio measurements according to a (e.g., configured) timing for measurements and/or availability from (e.g., local) sensors. For example, a WTRU may determine its zone (e.g., a zone where the WTRU is located) through non-radio measurements. For example, a WTRU may evaluate a configured joint event with the conditions set over the measurements of radio and/or non-radio quantities.

For example, a WTRU may determine that an event(s) associated with an active configuration is triggered. For example, a WTRU may select one of the configurations for which execution event/conditions get fulfilled, such as where the selection may be based upon a priority indicated with the LTM configurations, intra-DU/inter-DU switching nature, and/or WTRU implementation. For example, a WTRU may perform a LTM mobility switch (e.g., based on a network command). For example, a WTRU may perform protocol stack handling (e.g., based on a network configuration). For example, a WTRU may transmit (e.g., uplink) information indicating any of the foregoing actions, such as where configured by the network to do so.

### Overview

### NR—Layer 3 Mobility Procedures

Generally, WTRU mobility may result in cell changes for service continuity. Legacy mobility procedures primarily operate at the RRC layer (e.g., L3). A network and a WTRU 102 may exchange messages, measurements and configurations prior to cell change. An overview of L3 mobility procedures is provided as follows.

### NR Inter-gNB Handover Procedure

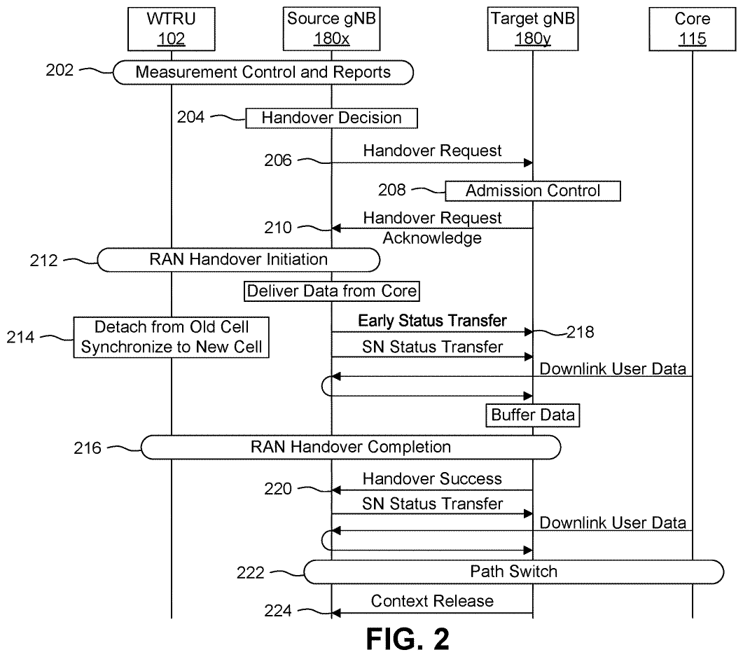

FIG. 2 is a procedural diagram illustrating an example procedure for an intra-NR inter-gNB handover. The procedure shown in FIG. 2 may be referred to as a legacy handover herein. When a WTRU 102 is in RRC_Connected mode, cell and/or gNB-level mobility may require explicit RRC signaling to be triggered. At 202, a WTRU 102 may report a cell quality measurement to a serving (e.g., source) cell of the WTRU 102 when a neighboring cell quality is an offset better for a (e.g., preset) duration of time referred to as a time-to-trigger (TTT). Different events referred to as A1, A2, A3, A4, A5, etc. are defined for WTRU 102 measurement report triggering in 3GPP TS 38.300. The TTT and the cell specific offsets may be specified during the measurement configuration step. If a handover (HO) decision at 204 is made based on the measurement report, the source gNB 180x may issue a handover request at 206 to the target gNB 180y. If the WTRU 102 is admitted by the target gNB 180y at 208, the target gNB 180y may send a handover request acknowledgement to the source gNB 180x (e.g., which contains an RRC message to be sent to the WTRU 102) at 210. Next, the source gNB 180x initiates the handover and sends the RRC Reconfiguration message to the WTRU 102 at 212. The source gNB 180x can also include a set of dedicated RACH resources. After, the WTRU 102 may detach from the old cell and synchronize to the new target cell at 214 and complete the RRC handover procedure at 216. The overall HO procedure is shown in FIG. 2. In FIG. 2, an early status transfer may be performed between the source gNB 180x and 180y at 218. At 220, handover success may be provided by the target gNB 180y to the source gNB 180x. Path switching may be performed at 222. At 224, the target gNB 180y may notify the source gNB 180x of a context release of the WTRU 102.

For example, the HO process may fail due to poor channel qualities of the target gNB 180y, the source gNB 180x or both. In a scenario with directional links, handover problems may be exacerbated because the link qualities of the target and source gNBs 180x can deteriorate quickly due to mobile blockers or WTRU 102 rotations. First, the blockage of a target gNB 180y during a handover procedure may result in a handover failure (HOF). When the WTRU 102 receives RRC Reconfiguration message, a handover failure timer T304 is started. If the T304 timer expires before the handover is completed, a HOF is declared, and the WTRU 102 may (e.g., must) perform connection re-establishment as described in 3GPP TS 38.331. Second, after a sudden WTRU 102 rotation or a blockage, the source gNB 180x may not be able to initiate a handover procedure in time based on the most recent measurement reports. Even the measurement reports from the WTRU 102 may be lost due to poor link quality. Thus, without handover assistance from the source gNB 180x, even when there are potential target gNBs 180y with good channel qualities, the WTRU 102 may need to either wait for the source gNB 180x to recover from outage or declare an RLF.

### Dual-Active Protocol Stack (DAPS) Handover

As a potential solution to the target gNB 180y being blocked, a dual-active protocol stack (DAPS) handover was specified in 3GPP 38.300 Rel-16. In DAPS handover, the WTRU 102 does not release the source cell connection until random access to the target gNB 180y is completed. If the target gNB 180y link deteriorates before random access is completed, the WTRU 102 can fall back to the source gNB 180x.

### UE Controlled Conditional Handover (CHO)

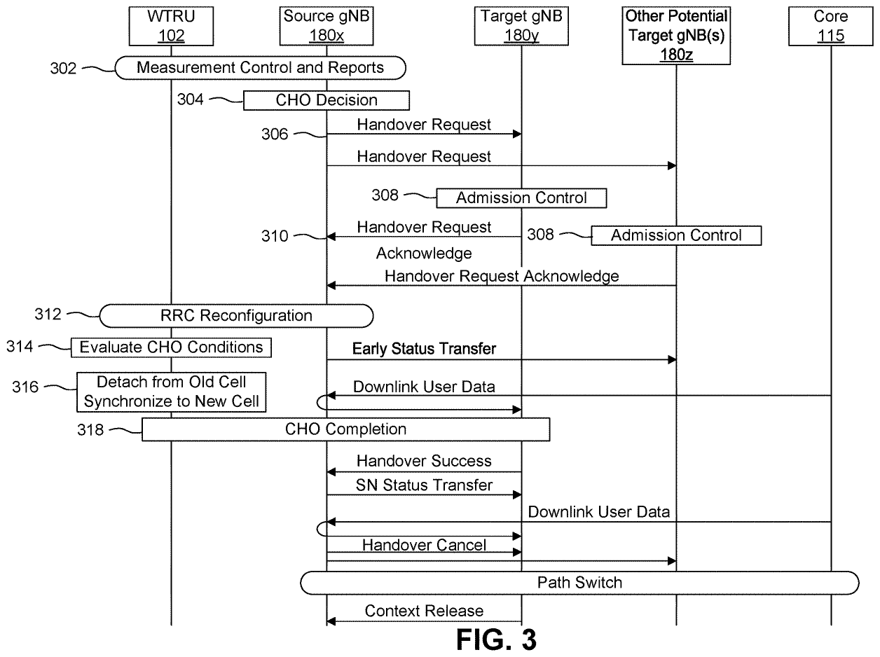

FIG. 3 is a procedural diagram illustrating an example procedure for intra-NR RAN conditional handover. To address the blockage of the source gNB 180x, a conditional handover (CHO) was specified in 3GPP 38.331 Rel-16. At 302, a WTRU 102 may report a cell quality measurement to a serving (e.g., source) cell of the WTRU 102. If a CHO decision at 304 is made based on the measurement report, the source gNB 180x may issue a handover request at 306 to the target gNB 180y and other potential target gNBs 180z. If the WTRU 102 is admitted by the target gNB 180y and other potential target gNBs 180z at 308, the target gNB 180y and other potential target gNBs 180z may send a handover request acknowledgement to the source gNB 180x at 310. Next, the source gNB 180x initiates the handover and sends the RRC Reconfiguration message to the WTRU 102 at 212. In CHO, the WTRU 102 may be configured at 312 to execute a handover when one or more handover execution conditions are met. The source gNB 180x can proactively configure the WTRU 102 to evaluate CHO execution conditions at 314 defined for candidate gNBs 180y and/or 180z. Once the conditions are met (e.g., when the target gNB 180y is an offset better than the source gNB 180x), the WTRU 102 may initiate the handover at 316 to a target gNB 180y without the signaling from the source gNB 180x. Thus, even when the source gNB 180x is in outage state due to a sudden blockage or a rotation, the WTRU 102 can still successfully complete a handover at 318 with the target gNB 180y if a CHO execution condition is satisfied. The overall CHO procedure is illustrated in FIG. 3.

Although CHO is resilient to mobile blockers and can significantly reduce the number of RLFs originating from fast deteriorating links, the success of CHO depends on the availability of candidate gNBs before the failure of the source link, the link quality of the target links, as well as the conditional thresholds for the target gNBs. Even where candidate gNBs are present, a WTRU 102 needs to be able to maintain the link quality with the selected candidate gNB until handover completion. Furthermore, careful configuration of the conditional thresholds for the handover execution may also be needed. Higher threshold values may lead to a WTRU 102 failing to timely execute the handover to a target gNB 180y resulting in a failed handover. On the other hand, lower threshold values may lead to a sub-optimal choice of a new serving gNB and potentially useless handovers in certain cases.

### Rel-16 Multi-TRP Operation and Rel-17 Inter-Cell Beam Management

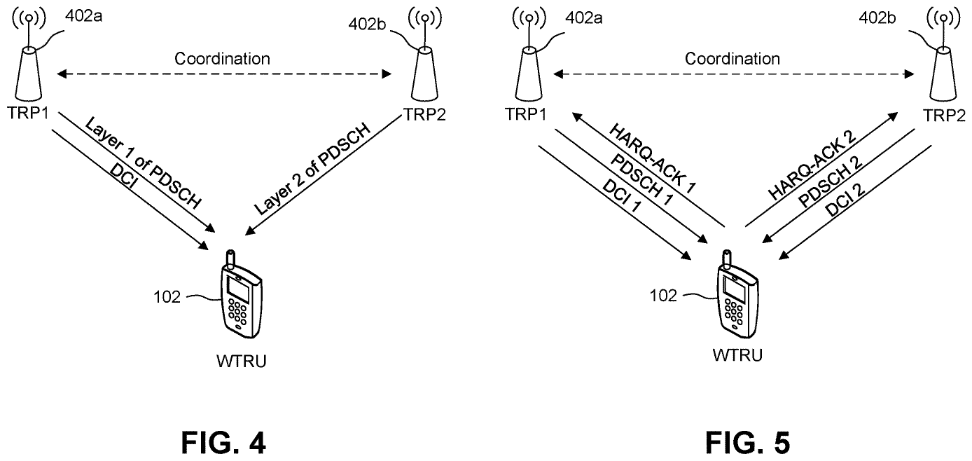

Multi-TRP transmission mechanisms which were standardized in 3GPP Rel-16 are limited to intra-cell cases. These multi-TRP transmission mechanisms are specified to support non-coherent joint transmission (NCJT), which may improve downlink data rates and spectral efficiency, such as for users at a cell edge. Considering various backhaul capabilities (e.g., ideal backhaul, non-ideal backhaul) in practical deployments, two different NCJT-based transmission schemes are supported: single-downlink control information (DCI)-based and multi-DCI-based. FIG. 4 is a system diagram illustrating an example of NCJT-based transmission with single-DCI. In FIG. 4, first and second TRPs 402a, 402b may coordinate to provide downlink communications to a WTRU 102 with a single DCI. For example, the first TRP (e.g., TRP1) 402a may send a first layer of a PDSCH transmission to the WTRU 102, and the second TRP (e.g., TRP2) 402b may send a second layer of the PDSCH transmission to the WTRU 102. FIG. 5 is a system diagram illustrating an example of NCJT-based transmission with multi-DCI. In FIG. 4, first and second TRPs 402a, 402b may coordinate to provide downlink communications to a WTRU 102 with a multiple DCI. For example, the first TRP (e.g., TRP1) 402a may send a first PDSCH transmission scheduled by a first DCI to the WTRU 102, and the second TRP (e.g., TRP2) 402b may send a second PDSCH transmission scheduled by a second DCI to the WTRU 102. The WTRU 102 may provide separate HARQ feedback to the first and second TRPs 402a, 402b.

For example, Rel-16 single DCI based transmission schemes may be more suitable for ideal backhaul between the TRPs as a single DCI may schedule the resources from two TRPs. To receive DL data from different TRPs, the WTRU 102 may be provided with two TCI states, and each TCI state corresponds to one TRP and provides the quasi co-location (QCL) information for the corresponding PDSCH layers. Different TCI code points may be activated by the MAC layer as described in 3GPP 38.321. The scheduling DCI indicates one of the activated TCI code points having 2 TCI states.

For example, Rel-16 multi-DCI based transmission schemes may support scenarios with non-ideal backhaul where each TRP uses its own DCI to schedule its resources. In the RRC configuration, two TRPs may be implicitly represented with two different control resource set (CORESET) groups. Each of which may be identified by the value of RRC parameter “CORESETPoolIndex.”

3GPP standardized inter-cell beam management (ICBM) in Rel-17 where multi-TRP operation has been extended to the inter-cell cases. A TCI state is allowed to be defined from a synchronization signal block (SSB) that is associated with a physical cell identity (PCI) different than the cell to which the WTRU 102 is RRC_Connected, which enables inter-cell multi-TRP operation by proper configuration and activation of TCI states that can be associated with either of the PCls.

Followed by Rel-16 standardization of intra-cell multi-TRP operation and Rel-17 inter-cell multi-TRP operation, L1/L2 triggered mobility (LTM) is part of ongoing 3GPP Rel-18 work.

For example, in networks employing higher carrier frequencies, narrow beam transmissions may occur requiring very dense deployments. A traditional mobility framework based upon higher layer measurements, cell measurements, reporting, cell changes and/or update decisions and executions may involve very large overhead and incur latencies which far exceed the timescale of mobility events with narrow beams.

LTM is one of the promising areas to minimize mobility interruptions. A significant reduction in mobility interruptions may be possible by (i) combining radio based and non-radio based measurements leading to a more deterministic manner of mobility handling, and (ii) minimizing the latency associated with measurement reporting, decision making and transmission of mobility commands.

For example, certain embodiments may enable L1/L2 mobility features, such as by (i) focusing on measurements and events set over a combination of radio and non-radio measurement quantities, and (ii) reducing the WTRU-Network information exchanges. For example, a WTRU may be configured to perform LTM procedures based on a combination of radio and non-radio measurements.

### UE Controlled LTM Procedure Using Radio Measurements

In certain representative embodiments, a WTRU may control lower layer mobility based on using (e.g., only) radio measurements. For example, a WTRU may autonomously make a lower layer mobility decision and switching based upon lower layer events and trigger(s) set over suitable radio measurement quantities.

In certain representative examples, a WTRU may indicate (e.g., to a network) a capability thereof for supporting lower layer mobility and/or LTM handling as well as (e.g., the capability to receive and/or use) relevant assistance information.

In certain representative embodiments, a WTRU may receive at least one LTM configuration with execution triggers on L1/L2 Radio measurement quantities and suitable lower layer events.

In certain representative embodiments, a WTRU may perform configured L1/L2 Radio measurements.

In certain representative embodiments, a WTRU may detect a change in radio measurement quantities.

In certain representative embodiments, a WTRU may determine candidates (e.g., cells) for which it has a LTM configuration.

In certain representative embodiments, a WTRU may evaluate measurements according to the configured conditions for the LTM candidates.

In certain representative embodiments, a WTRU may perform conditional L1/L2 mobility switching to a LTM target configuration after one or more configured events are triggered on lower layers.

In certain representative embodiments, a WTRU may perform a LTM mobility switch to a target LTM configuration.

In certain representative embodiments, a WTRU may perform a MAC and/or RLC reset and initiate PDCP data recovery, such as per the information received with selected LTM candidate configuration.

In certain representative embodiments, a WTRU may send an UL indication, such as per the network configured signaling for WTRU 102 controlled switching.

### UE Controlled LTM Switching Based on Joint Events Over Radio and Non-Radio Quantities

In certain representative embodiments, a WTRU may control lower layer mobility based on using (e.g., a combination of) radio and non-radio measurements. For example, a WTRU may perform differentiated intra- and inter-DU handling.

In certain representative examples, a WTRU may indicate (e.g., to a network) a capability thereof for supporting lower layer mobility and/or LTM handling as well as (e.g., the capability to receive and/or use) relevant assistance information to support LTM procedures based on joint radio and non-radio measurement quantities.

In certain representative examples, a WTRU may receive information indicating coverage and/or deployment topologies. For example, the WTRU may receive one or more relevant configurations related to zone determination.

In certain representative examples, a WTRU may receive one or more LTM Configurations which may include or be received along with (e.g., separately) suitable LTM radio and non-radio measurement quantities and/or joint events configured over the radio and non-radio measurement quantities (e.g., serving to trigger mobility switching). For example, the network may indicate any of the proposed joint events, such as LTM-J1 to LTM-J6, as part of the WTRU 102 controlled switching configuration to trigger the switching. For example, a (e.g., each) LTM configuration may provide information for indicating and/or identifying its applicability for intra- or inter-DU switching with respect to the DU of the serving cell.

In certain representative examples, a WTRU may perform one or more (e.g., configured) radio and one or more (e.g., configured) non-radio measurements according to the (e.g., configured) timing for the measurements and availability from local sensors.

In certain representative examples, a WTRU may determine a zone (e.g., in which the WTRU is currently located) through non-radio measurements.

In certain representative examples, a WTRU may evaluate the (e.g., configured) joint events with the conditions set over (e.g., using) measurements of the radio and the non-radio quantities.

In certain representative examples, a WTRU may determine that conditions and events associated to at least one of the ACTIVATED configurations are triggered. Based on that, the WTRU may select one of the configurations for which the execution events and/or conditions get fulfilled. For example, the selection may be based upon the intra-DU or inter-DU switching nature, such as where the WTRU 102 is instructed (e.g., configured) to prioritize an intra-DU configuration over an inter-DU configuration, or vice versa.

In certain representative examples, a WTRU may switch to a target configuration that results in intra-DU switching. For example, the WTRU may proceed to performing the LTM mobility switch to the target configuration without any reset of MAC/RLC layers. For example, the WTRU may transmit an UL indication, such as per the network configured signaling for intra-DU switching.

In certain representative examples, a WTRU may switch to a target configuration that results in inter-DU switching. For example, the WTRU may proceed to performing the LTM mobility switch to the target configuration. The WTRU may perform a MAC and/or RLC reset and initiate PDCP data recovery. For example, the WTRU may transmit an UL indication, such as per the network configured signaling for inter-DU switching.

### UE Controlled Zone-Based Activation and Deactivation of LTM Candidate Configurations

In certain representative embodiments, a WTRU may control (e.g., perform) activation and deactivation of suitable LTM candidate configurations. For example, the activation and deactivation of network configured candidate configurations by the WTRU may provide (e.g., significant) benefit in terms of latency reduction in having the suitable candidate configurations in an activated state for potential LTM switching. For example, the WTRU may refer to zone information for activation and/or deactivation of candidate configuration. For example, validation of a configuration may be achieved using measurements, such as joint measurements over radio and non-radio signals.

In certain representative embodiments, for WTRU 102 autonomous activation, a (e.g., each) LTM candidate configuration may include the conditions and/or events over radio and non-radio measurement quantities with on WTRU 102 zone criterion (or criteria) included therein.

In certain representative embodiments, a WTRU may indicate (e.g., to a network) a capability thereof for supporting lower layer mobility and/or LTM handling as well as (e.g., the capability to receive and/or use) relevant assistance information to support LTM procedures based on joint radio and non-radio measurement quantities.

In certain representative examples, a WTRU may receive information indicating coverage and/or deployment topologies. For example, the WTRU may receive one or more relevant configurations related to zone determination.

In certain representative embodiments, a WTRU may receive information indicating one or more LTM configurations which may include or be received along with (e.g., separately) suitable LTM radio and non-radio measurement quantities and/or which may include or be received along with (e.g., separately) suitable joint events for LTM switching. For example, a (e.g., each) LTM candidate configuration may include information indicating a list of active zones. An active zone may refer to a zone (e.g., area) where the WTRU 102 may (e.g., shall) activate the configuration based on the (e.g., additional) radio and non-radio activation conditions being fulfilled. For example, a subset of LTM configurations may be indicated as activated by the network as part of the configuration and/or initialization.

In certain representative embodiments, a WTRU may receiving information (e.g., a configuration) indicating a set of additional periodic measurements, conditions, and/or events for configuration activation and/or deactivation. For example, the measurements may be non-radio measurements which may be used to determine a WTRU zone (e.g., zone the WTRU is located in) according to the coverage configuration.

In certain representative embodiments, a WTRU may perform one or more radio and one or more non-radio (e.g., configured) measurements associated with an activated LTM configuration(s).

In certain representative embodiments, a WTRU may perform one or more (e.g., configured) non-radio measurements for the activation and/or deactivation of LTM configured candidates.

In certain representative embodiments, a WTRU may determine its zone using non-radio measurements.

In certain representative embodiments, a WTRU may determine that a current (e.g., newly determined zone) is different than a previous (e.g., prior determined zone). For example, the WTRU may deactivate any (e.g., all) the activated candidate LTM configurations which do not have the current (e.g., newly determined) zone in their list of active zones. For example, the WTRU may determine one or more configured LTM candidate configurations currently in deactivated state which have the current (e.g., newly determined) zone indicated in the list of active zones. For example, the WTRU may measure and evaluate the activation conditions (e.g., where configured in addition to the zone information) for the determined candidate configurations set over radio and non-radio measurements. For example, the WTRU may activate any (e.g., each of) the determined candidate configurations for which radio and non-radio activation conditions/events are fulfilled. For example, the WTRU may transmit an UL indication of any (e.g., each) activated LTM candidate configurations, such as per the network configuration.

### UE Initiated Request to Receive LTM Configuration Candidates Based on Radio and Non-Radio Measurements

In certain representative embodiments, a WTRU may perform procedures where the WTRU requests (e.g., indicates a request) to a network to receive (e.g., suitable) LTM candidate configurations based on radio and/or non-radio measurements. For example, location and/or position information of the WTRU, which may be present in zone information, may be used by the WTRU, such as to trigger the request for LTM candidates.

### Preparation Phase

In certain representative embodiments, a WTRU may indicate (e.g., to a network) a capability thereof for supporting lower layer mobility and/or LTM handling as well as (e.g., the capability to receive and/or use) relevant assistance information to support LTM procedures based on joint radio and non-radio measurement quantities.

In certain representative embodiments, a WTRU may receive information indicating coverage and/or deployment topologies. For example, the WTRU may receive one or more relevant configurations related to zone determination.

In certain representative embodiments, a WTRU may receive information indicating one or more LTM Configurations which may include or be received along with (e.g., separately) suitable LTM radio and non-radio measurement quantities and/or joint events (e.g., for LTM switching). For example, a (e.g., each) LTM candidate configuration may include a list of active zones where the WTRU may (e.g., shall) activate the configuration. For example, a subset of LTM configurations may be indicated as activated by the network as part of the configuration and/or initialization. For example, the WTRU may be configured with a set of (e.g., additional) periodic measurements for configuration activation and/or deactivation. The (e.g., additional) measurements may be non-radio measurements, such as may be used to determine a WTRU 102 zone according to the coverage configuration. For example, the WTRU may be configured to request candidate configurations on a zone basis under the condition that it has no configured candidate for the determined zone. For example, for any candidates associated to a zone, the WTRU 102 may be configured to select a most suitable candidates for the radio conditions (e.g., at the WTRU 102).

### Execution Phase—Request for Suitable LTM Candidate Configurations

In certain representative embodiments, a WTRU may be configured to perform periodic non-radio measurements.

In certain representative embodiments, a WTRU determine its (e.g., current) zone through non-radio measurements, such as non-radio measurements according to a topology configuration.

In certain representative embodiments, a WTRU may determine that a current (e.g., newly determined) zone is different from a previous (e.g., previously determined) zone. The WTRU may also determine that no candidate configuration is available having the determined zone in their list of active zones.

In certain representative embodiments, a WTRU may determine one or more mobility candidates for the current zone using a topology configuration (e.g., received from the network). For example, the WTRU may perform (e.g., additional) radio and non-radio measurements to select suitable LTM candidates. For example, the non-radio measurements may include distance and/or orientation computations for the LTM candidates. For example, the radio measurements may include SSB and/or CSI-RS signal qualities for the LTM candidates.

In certain representative embodiments, a WTRU may select a (e.g., configured) number of cells as potential candidates to which the WTRU may transmit an indication to the network requesting to receive configurations of the potential candidates.

In certain representative embodiments, a WTRU may transmit (e.g., uplink) information indicating a request for the network to provide the configuration candidates for the determined zone. For example, an UL indication for configuration request may include the transmission of any determined zone identity and the candidate cell IDs selected after radio and non-radio measurements acquired previously.

In certain representative embodiments, a WTRU may receive information indicating the updated configurations for LTM with the candidate configurations having the determined zone as part of their list of active zones.

In certain representative embodiments, a WTRU a UL indication for configuration request may be transmitted as a MAC CE.

In certain representative embodiments, a WTRU select the cell IDs associated to the determined zone, such as on the basis of the cells being aligned with the orientation of the WTRU. For example, the WTRU 102 may choose the cell IDs for which TRPs are located in the directions matching the WTRU 102 orientation within a configured threshold margin. For example, the WTRU 102 may be configured with a measurement configuration (e.g., with event LTM-OT1) where the target cells are the ones associated to the WTRU 102 determined zone, and the reporting may be performed for the cell IDs that match the WTRU 102 orientation within a (e.g., configured) threshold.

In certain representative embodiments, the determined cell IDs may be (e.g., additionally) validated based upon radio measurements. For example, the radio measurements can be made over (e.g., performed on) SSBs of the cells associated with the determined cell IDs. For example, the WTRU 102 may be configured to select a (e.g., configured) number of cells for indication as part of the request to the network. As an example, the selected cells may be the strongest measured cells. The cell strength may be configured to be estimated based on RSRP or RSRQ values.

### UE Controlled Joint Radio and Non-Radio Measurements to Minimize Mobility Interruptions

The evolution of wireless systems with new applications requiring low-latency, high-reliability, and/or high-availability has resulted in greater focus and activity to service continuity while undergoing mobility and/or to minimize the service interruptions due to mobility. To that end, 3GPP has defined and standardized several mechanisms where mobility interruptions may be minimized through faster switching of beams, cells and network nodes.

In certain representative embodiments, a WTRU may achieve and/or control lower layer (e.g., L1/L2) triggered mobility using combined radio and non-radio measurement quantities for improving predictive mobility and/or avoiding the latency introduced by the message exchanges between the WTRU 102 and the network. The message exchanges between the WTRU 102 and the network may avoided by making the deployment information available at the WTRU 102 and/or moving the mobility decision making to the WTRU 102 side. For example, improvements may be achieved in certain embodiments using any of (i) the knowledge of network deployment of nodes, cells, and/or beams available to the WTRU 102 and (ii) the capabilities of WTRU 102s to make non-radio measurements in different forms such as tracking WTRU movements, determining updated geographic location, position, and/or orientation (e.g., non-radio measurements), (iii) the joint usage of non-radio measurements with measurements made over radio signals, (iv) a lower latency measurement framework for event evaluation leading to suitable target cell and/or beam configuration selection at the WTRU 102, and/or (v) fast execution of the lower layered triggered mobility procedure to the determined configuration.

For example, WTRU 102 controlled LTM procedures based upon joint radio and non-radio measurements and events may be broadly split into two major phases. The first phase may be referred to as a joint radio and non-radio measurements based LTM preparation phase. The preparation phase may include WTRU 102 capability signaling to the network relevant to support of the WTRU 102 controlled LTM procedure, and the network configuration. The second phase may be referred to as the execution phase.

The ability for a WTRU to quickly detect its location and/or orientation and/or geographic coordinates may be used to choose a suitable node, cell, and/or beam to which the WTRU 102 may (e.g., should) connect with. The network may provide (e.g., a portion or finite piece of) the deployment and/or coverage topology (e.g., map) of the network to the WTRU 102s. A WTRU 102 may use the deployment and/or coverage topology to locate itself in the deployment and/or coverage topology and determine the most suitable network points through which they may (e.g., should) communicate to the network. Various embodiments for the coverage topology contents, configuration, maintenance, signaling mechanisms, and WTRU 102 post-processing are described herein.

Various embodiments for L1/L2 triggered mobility (LTM) procedures, the design for such LTM configurations and the updating procedure are described herein. Various embodiments for WTRU 102 capability and assistance information that the WTRU 102 may provide to the network prior to receiving configured for LTM configurations are described herein.

In certain representative embodiments, non-radio measurements may be combined with radio measurements in LTM procedures. Various embodiments for measurement frameworks combined over radio and non-radio measurements are described herein. For example, a WTRU may integrate (e.g., combine) measurements over 3GPP radio signals, non-3GPP radio signals, data from local sensors and other interfaces. To reduce latency and achieve stable measurements, different measurement models are proposed which may select measurement quantities from either L1, L3 or combinations thereof. Various embodiments for the framework for LTM measurements including measurement modeling, configuration, quantities, and/or event definitions are described herein. Various embodiments for events which are used as trigger conditions include combinations of radio and non-radio measurement quantities are described herein. Various embodiments may achieve zero interruption mobility.

In certain representative embodiments, LTM switching procedures may be referred to as WTRU 102 controlled. For example, a WTRU 102 may locally decide to switch from its serving cell to a target cell as per the conditions set in a network configuration. Various embodiments for how the network provides configurations and/or indications to the WTRU 102 about handling of its data and control planes while the WTRU 102 is performing the cell switching through LTM procedure are described herein. For example, once a WTRU 102 switches to one of the configured target cells, the WTRU 102 may inform the network about the selected target. Various embodiments for indication mechanisms through which the network can configure the WTRU 102 to provide indications on the target cell after the LTM cell switching are described herein.

In certain representative embodiments, WTRU 102 controlled LTM switching procedures may include various aspects of the preparation and execution phases (e.g., assistance, configurations, measurements, WTRU 102 evaluation of the execution conditions, selection of the target cell configuration, WTRU 102 switching to the selected target configuration, and WTRU 102 indication to the network making up a representative LTM cell switching procedure).

In certain representative embodiments, a WTRU 102 may perform autonomous activation and/or deactivation of suitable LTM configurations configured by the network. For example, any (e.g., each) activated LTM configuration may be tracked and monitored for its relevant configured measurements to be able to use as a target candidate. For a (e.g., mobile) WTRU 102, the set of activated configurations may change with its movements. For example, the network may provide a set of LTM configurations and associated WTRU 102 measurements, such as location and/or zone from a topology configuration which may, in some embodiments, be combined with radio measurements. The WTRU 102 may choose suitable LTM configurations based on changes in the location and/or geographic coordinates of the WTRU. Various embodiments for WTRU 102 based activation and/or deactivation of LTM configurations, and the suitable configuration details and procedures for activation and/or deactivation are described herein.

As used herein, the phrases lower layer triggered mobility and L1/L2 triggered mobility (LTM) may be used to refer to procedures where the cell switching triggers, exchanges and confirmations are performed (e.g., primarily) at lower layers (e.g., L1 and/or L2) of the WTRU 102 and/or the network. For example, legacy mobility procedures are performed at the RRC layer (e.g., L3). L1 may be used to refer to the PHY layer and L2 may be used to refer to the MAC layer. L1/L2 may refer to any of L1, L2, and/or a combination of both L1 and L2.

As used herein, WTRU 102 controlled lower layer mobility, WTRU 102 controlled LTM switching, WTRU 102 autonomous LTM switching, conditional LTM switching, and/or WTRU 102 controlled lower layer mobility handling may be used synonymously.

### Joint Radio and Non-Radio Measurements Based WTRU 102 Controlled LTM-Preparation Phase

In certain representative embodiments, a preparation phase for joint radio and non-radio measurements based WTRU 102 controlled LTM procedure may refer to and/or include procedures relating to the configuration of the deployment topology, LTM cell configurations with the conditions and/or events which a WTRU 102 may evaluate to determine any target candidate configurations locally (e.g., without network command), measurement configurations and WTRU 102 capability signaling to the network to support LTM procedures.

### Deployment and Coverage Zones

Generally, cellular networks are planned networks with operators deploying network nodes at suitable locations to provide sufficient coverage to their subscribers. It should be expected that a network operator has (e.g., very precise) knowledge of its deployment of cells, and the beams within those cells in terms of coverage zone attributes, such as the locations (e.g., reference locations) of cells and/or transmission points (TRPs), potential spatial directions of transmissions (e.g., defined by azimuth, elevation angles and location coordinates of the TRPs), beam width information (e.g., 3-dimentional beam width information, horizontal and vertical direction information, transmission range information, and/or coverage shape information, such as location coordinates of points that constitute the coverage border of a beam, cell and/or TRP).

### Deployment Topology

In certain representative embodiments, a deployment topology may include information indicating the locations of TRPs, coverage of beams and/or orientation of beams. For example, a location (e.g., of a TRP) may be represented in terms of 2D coordinates, such as latitude and longitude coordinates. For example, a location may be represented in terms of 3D coordinates, such as with the addition of altitude or height to 2D coordinates. For example, 2D and/or 3D location representations may be in global and/or local coordinate systems.

In certain representative embodiments, beams from a given TRP may be represented using azimuthal and elevation angles. For example, suitable references may be used like cardinal directions and zenith, or reference directions can be provided as part of the configuration. Such angles may be provided with suitable refinements and/or quantization to capture meaningfully the mobility procedures and signal strengths within or out of the coverage for a given beam. In addition to the angles, the beam widths in these directions may be (e.g., additionally) provided, such as explicitly, for the beams. With the TRP location parameters and/or the beam angles (e.g., plus widths), a WTRU 102 can prepare a local topology where it can determine (e.g., see) the coverage of different beams from different TRPs. In certain embodiments, additional attributes, such as range and/or power can be added to cell and/or beam information to further refine the deployment topology.

### Coverage Topology

In certain representative embodiments, a coverage topology may include information indicating the geographic coverage from different TRPs, such as for different beams. For example, a coverage topology may provide the coverage boundaries of different TRPs and/or different beams. A coverage topology may incorporate and/or indicate the nature of the terrain, topographic aspects, buildings, and other geographic parameters on the deployment topology to prepare suitable zones and boundaries associated to the coverage of different TRPs and/or different beams.

In certain representative embodiments, a coverage topology may include information indicating (e.g., be provided in the form of suitable) geometric shapes. To indicate the shapes delimiting the cells and/or beam level coverage, different reference shapes may be defined (e.g., predefined). The reference shapes can include (e.g., be in the form) any of circles, ovals, ellipses, and/or ellipsoids or other geometric shapes, such as with suitable parameterization. For example, a coverage topology may be indicated using these shapes with suitable attributes. These attributes may be associated with (e.g., provide links to) the cell and/or beam identities to which a given shape and/or area is associated.

### Configuration

As used herein, the terms deployment topology and coverage topology may be used synonymously (e.g., unless otherwise distinguished).

In certain representative embodiments, a coverage topology may be associated with an area, which may be referred to as a coverage topology area. For example, a coverage topology area may correspond to any of one or more cells, a RAN Notification Area (RNA), a tracking area (TA), and/or a PLMN, etc.

For example, each coverage topology may be defined at different granularities. The granularity of a coverage topology may be part of a coverage topology configuration. In an example, a coverage topology may be defined at a cell level. The information of geographic coverage from different gNBs and/or TRPs may be indicated to WTRU 102s with suitable signaling. For example, cell level coverage can be useful for different hand-over and cell change procedures.

For example, a coverage topology granularity may be represented (e.g., reflected in) the form of coverage zones. For cell level procedures, one or more coverage topology zones may have a (e.g., given) cell level granularity. For beam level procedures, where for example a WTRU 102 may need to track, maintain, and/or switch beams, the coverage topology granularity may be defined (e.g., differently), such as at a beam level. Zones in a coverage topology may be associated with (e.g., attributed to) different beams.

For example, one or more zones can be attributed to one or more (e.g., given) beams from one or more (e.g., given) TRPs. A (e.g., further refined) granularity may be achieved by defining and associating zones to different directions from any (e.g., each) gNB and/or TRP. The zones in the coverage topology can be indicative of the geographic area which corresponds to a given set of reference signals. For beam level zones, in one design, each zone can indicate the coverage area for an SSB beam. In another beam level zone design, each zone can indicate the coverage area for an SSB beam or a CSI-RS beam where SSB/CSI-RS beam is the coverage for the corresponding SSB/CSI-RS signals. The configuration may specify a one-to-one or one-to-many correspondence where one-to-many correspondence may exist when criteria for zone delimitation is not SSB but some other signal or GPS coordinates. The one-to-many correspondence many exist as well for overlaid networks where multiple cells/beams may be serving overlapping areas.

For example, any (e.g., each) zone can be identified with an identity, which can be provided as part of the configuration. For example, any (e.g., each) zone identity may be any (e.g., deterministic combination) of identities of cells, TRPs, SSB and/or CSI-RS beams that it is attributed to. In certain representative embodiments, one or more formulae to compute a zone identity may be known to the network and/or the device a-priori. The network and/or devices may use (e.g., additional) modulating parameters, such as lengths, widths, number of SSB beams etc., which can be part of system information or the configuration.

For example, a different granularity for the zones can be at any of the gNB, TRP and/or cell level. For cell level zones, a zone may indicate an area where the cell has sufficient coverage. One or more criteria for sufficient coverage may be specified in terms of existing cell selection, re-selection criterion, and/or new criterion associated to suitable reference signals may be specified. For example, a cell level zone may group any (e.g., all) the SSB and/or CSI-RS zones associated to a given cell. A cell level zone may represent an area where any of the SSB and/or CSI-RS signals for the cell may be received with a known and/or configured quality. A zone representation may be extended to a (e.g., larger) granularities for RNA, TA and/or PLMN based coverage zones. A cell level zone identity may be a cell identity. A cell level zone identify may be a (e.g., deterministic) modification of the cell identity by combining it with one or more other parameters. For example, a same design may be used for zones to represent the coverage for RNA, TA, and/or PLMN etc.

In certain representative embodiments, a zone may be defined for any (e.g., each) location using longitude and latitude values. For example, zone dimension (e.g., length) information may be provided as part of the configuration. One or more formulas to compute the zones may be pre-defined and/or may be signaled as part of the configuration (e.g., from a pre-defined set). For example, a WTRU 102 may compute zone identity as standardized in the 3GPP NR Sidelink work in Release-16. For example, the longitude and latitude values may be the geodesic distances from the geographical coordinates (0,0), as in used in the NR sidelink framework. Suitable parameters may be provided as part of the configuration to choose the zone modularity along the longitude and latitude directions. A (e.g., only one) single parameter may be used to choose the same modularity along longitude and latitude directions. For example, the parameter may be a fixed value to ease (e.g., reduce overhead signaling of) the configuration. In certain representative embodiments, all the devices may compute their zones and the zones for any location against the longitude and latitude coordinates of that location.

### Network Deployment Configuration

In certain representative embodiments, a deployment topology comprises of information about the location of TRPs and coverage/orientation of beams. For example, a location of one or more TRPs may be represented in terms of 2D coordinates, such as latitude and longitude coordinates. For example, a location may be represented in 3D coordinates, such as with the addition of altitude and/or height to 2D coordinates. 2D and/or 3D representations may be reference global or local coordinate systems. A zone configuration follows sidelink design, the TRP locations may be provided against the zones (e.g., instead of the longitude and latitude coordinates).

For example, one or more beams from a given TRP may be represented using azimuthal and elevation angles. Suitable references may be used like cardinal directions and zenith, or reference directions may be provided as part of the configuration. These angles may be provided with suitable refinement and/or quantization to meaningfully capture the mobility procedures and signal strengths within or out of the coverage for a given beam. For example, (e.g., in addition to the angles) the beam widths, such as in these directions, may be provided, such as explicitly for the beams.

### Network Coverage Configuration

In certain representative embodiments, the network may (e.g., directly) provide a coverage configuration in the form of (e.g., rich) shapes which may capture any (e.g., all) of the specific aspects of the local terrain, such as shadowing from buildings and/or other objects. For example, the network may not only precisely know the deployment of its cells, TRPs and/or beams but may also have access to topographical data using a navigation system, cameras, and/or the ongoing measurements on cells and/or beams from the devices which allow the network to (e.g., advantageously) have very precise coverage topology information. For example, using historic data in the form of network measurements, cells and/or beam transitions may be used to update and/or refine the coverage topologies. On the downside, this approach may have a large signaling overhead. For example, an amount of information that may need to be exchanged may be huge as the precise coverage for even a single beam may require a set of objects and their attributes communicated to a WTRU 102. The (e.g., large) signaling overhead may require several message exchanges at the RRC level leading to increased configuration latency.

In certain representative embodiments, zone configuration may the sidelink design. For example, the network may (e.g., will) provide different cells and/or beams coverage indication which provides the association of these cells and beams to zones.

### Hybrid Configuration

In certain representative embodiments, a topology configuration may be a hybrid of two approaches described herein. For example, a part of a configuration may be indicated in the form of a network deployment based configuration and a part of the configuration may be indicated using a coverage topology based configuration.

### Initial Configuration of Deployment and Coverage Topology

In certain representative embodiments, an initial configuration for a coverage topology may be communicated to a WTRU 102 in the form of dedicated RRC signaling. For example, a WTRU 102 in the RRC active state with mobility may be provided an initial coverage topology configuration. From the WTRU 102 perspective, the signaling may be dedicated but the network may provide the same information to a set of WTRU 102s. These WTRU 102s can be in the vicinity of each other. Hence, the same coverage topology may be relevant for them.

In certain representative embodiments, the network (e.g., the base station) may broadcast coverage topology information. A (e.g., new) coverage topology system information block (SIB) may be specified. It should be understood that the coverage topology information broadcasted by a cell and/or a TRP may be configured to reflect the local deployment environment of the cell or TRP broadcasting the coverage topology.

In certain representative embodiments, an initial configuration may provide a coarse coverage topology which may need to be refined. Refinement to suitable granularities and coverage extension may be performed on the initial coverage topology (e.g., to be fully useful). For example, a coverage topology may be refined (e.g., suitably) through dedicated signaling. For example, a refinement may be network initiated, such as when configuring certain applications and/or flows with QoS constraints (e.g., necessitating proactive mobility). For example, a WTRU 102 may request (e.g., initiate) the refinement of the coverage topology.

### UE Processing to Achieve Effective Coverage Topology

In certain representative embodiments, a network deployment topology may be shared with multiple WTRU 102s following the configuration solutions as described herein. For example, additional attributes may be added to a cell configuration. For example, a (e.g., new) configuration may be added having the geographic attributes and may link TRP and/or beam level configurations to legacy cell configurations. For mobility events and effective selection of beams, cells, and/or TRPs, a WTRU 102 may be configured with (e.g., receive) a detailed effective coverage topology that may be referred to as an on-the-ground coverage topology. For example, a deployment topology may need to be rich (e.g., detailed) enough so that the deployment topology captures all the topographical and shadowing aspects. For example, a coverage topology may (e.g., should) take into account not only the TRP locations and beam attributes, but may (e.g., should also) incorporate the physical nature of the environment around including the specifics of the terrain, the buildings with all their physical attributes which may shadow, block and/or reflect the beams. In certain representative embodiments, a WTRU 102 may acquire and/or fabricate an on-the-ground coverage topology.

### UE Processing Over Network Provided Coverage Topology

In certain representative embodiments, a network provided deployment configuration may be made detailed (e.g., very rich) and refined and provided in the form of rich shapes which capture any (e.g., all) the specific aspects of the local terrain, shadowing from buildings and/or other objects. To indicate the shapes delimiting the cells and/or beam level coverage, different reference shapes may be defined. For example, reference shapes can be in the form of circles, ovals, ellipses, ellipsoids or other geometric forms, such as with suitable parameterization. The network may indicate these shapes with suitable attributes and provide their links (e.g., association) to the cell and/or beam identities. One advantage of doing so is that the network may know precisely the deployment details of its cells, TRPs and/or beams. For example, topographical data may be accessed using any of a navigation system, cameras, and/or the ongoing measurements on cells and/or beams from the devices which let it know very precise coverage topology. One additional advantage is the use of (e.g., all) historic data in the form of network measurements, cell and/or beam transitions that may be used to update and refine detailed coverage topologies. On the downside, there may be a large signaling overhead incurred. For example, the amount of information that may need to be exchanged may be huge as the precise coverage for (e.g., even) a single beam may require a set of objects and their attributes communicated to a WTRU 102. The large signaling overhead may require several message exchanges at the RRC level leading which may lead to increased configuration latency as well.

### UE Processing Over Network Provided Deployment Topology

In certain representative embodiments, a network may provide to WTRU 102s a snapshot of the network's node deployments and (e.g., limited) information about the beams transmitted therefrom. For example, a network may provide such information as part of a deployment configuration. For example, the network may provide information about the TRP locations, beam angles and/or beam specific parameters (e.g., without modulating the coverage with the features of the local terrain). Due to reduced information as compared to the approach where the network provides a detailed coverage topology, the signaling overhead and latency performance may be improved.

In certain representative embodiments, devices may receive deployment features and/or parameters for TRPs and/or beams and may use local knowledge obtained through other technologies (e.g., local stored topography, positioning systems, cameras) to prepare a refined coverage topology which adds topographical aspects to a deployment configuration. For example, after local processing and fabrication, a WTRU 102 may have an effective topology which delimits different coverage zones associated to different beams and/or cells. A refined coverage topology may be used in the beam and/or cell level mobility procedures at the WTRU 102. A local physical coverage topology may be refined with the mobility and/or additional information obtained from other sensors. As devices prepare effective topology information using the network provided deployment parameters combined with the information from local sensors, this requires availability of local sensors, additional storage and/or compute capabilities to prepare an effective topology by combing network deployment topology with the information from local sensors.

In certain representative embodiments, the obtaining of a refined coverage topology at the devices may be standardized. For example, there may be devices which are not equipped with the necessary local sensors, or the devices don't have the necessary compute power to process and fabricate a topology themselves. The network may send a refined topology to such devices. For example, the devices having the necessary local sensors, compute and/or storage power may receive only limited deployment features from the network and prepare an effective topology locally. The manner in which a topology is received may be dependent upon WTRU 102 power consumption requirements, battery quality, remaining battery and/or as a function of active applications and their attributes.

### Maintenance of Deployment and Coverage Topologies

In certain representative embodiments, based on the detection of change in a coverage topology area, a WTRU 102 may re-acquire a coverage topology for its current location. For example, the re-acquisition of a topology may use dedicated RRC signaling. For example, the re-acquisition of a topology may use a coverage topology SIB. For example, a WTRU 102 may detect (e.g., determine) a change in coverage topology area based on any of the following:
a change in a serving cell and/or (re)selection to a cell that doesn't belong to a current coverage topology area;
a (re)selection to a RNA that doesn't belong and/or doesn't correspond to the current coverage topology area;
execution of a RNA update procedure and/or transmission of a RNA update message to the network (e.g., a base station);
a (re)selection to a TA that doesn't belong and/or a topology doesn't correspond to the current coverage topology area;
execution of a TA update procedure and/or transmission of a TA update message to the network (e.g., core network); and/or.
(re)selection to a PLMN that doesn't belong and/or a or topology doesn't correspond to the current coverage topology area.

### Release of Deployment and Coverage Topology Configurations

In certain representative embodiments, a WTRU 102 may discard information of a topology configuration, such as when the information becomes outdated. For example, an outdated indication may be derived if a WTRU 102 changes its coverage area and is not able to acquire an updated coverage topology. For example, a topology configuration may be associated with the use of one or more time intervals (e.g., explicit timers) which may result in a WTRU 102 releasing a configuration if expired. For example, a time interval (e.g., timer) may be refreshed if the WTRU 102 is staying (e.g., remains) in the area associated with its current coverage topology. For example, a coverage topology area may be defined in terms of a RNA, TA, PLMN and/or another suitable criterion.

For example, the network may send an (e.g., explicit) indication to the WTRU 102 to release its coverage topology configuration.

For example, a WTRU 102 may (e.g., will) release a coverage topology configuration after the WTRU 102 transitions out of a RRC active state (e.g., after receiving an RRC Release message)

### Network Indication of Deployment and Coverage Topologies

In certain representative embodiments, a deployment and/or coverage topology may be provided to a WTRU 102 (e.g., by the network). Cell and/or beam configurations and/or mobility configurations may be associated with a deployment and/or coverage topology.

Topology Indication as part of Cell/Beam Configuration

In certain representative embodiments, a (e.g., deployment) topology may be part of a cell configuration. For example, a cell configuration may be part of a conditional (re) configuration associated to a PsCell or SCell. The cell configuration may be part of a conditional handover or conditional PSCell change/addition procedure. A deployment topology may be associated to any of the serving cell configurations and may be used for any of the beam management procedures, such as for beam switching, beam failure recovery. In certain representative embodiments, new attributes may be added to (e.g., included in) the cell configuration which may define the TRPs where this cell is being transmitted, the locations of these TRPs in suitable global or local coordinate systems, and/or the beam coverage attributes for the beams being transmitted through these TRPs. The cell configuration may provide the information on SSB beams and/or CSI-RS beams. The attributes for beams may be in the form of azimuthal and elevation angles with suitable reference directions. The reference directions may be taken from cardinal directions and/or may be indicated as part of the configuration itself. The range for the beams may be indicated as a per beam attribute or a single value which may indicate the unobstructed range (e.g., in view of the transmit power). The beam attributes may (e.g., additionally) define the beam width in horizontal and/or vertical directions. For example, a simple deployment may specify one single beam width attribute for the horizontal direction and one for the vertical direction which may be assumed to be the same for any (e.g., all) of the configured beams. For example, in deployments with varying beam width sizes, the network may provide one value for a TRP, and delta values may be provided for each beam. For example, the network may provide beam width as part of the beam configuration without any TRP or cell level indication. For example, the coverage for any (e.g., each) beam may be specified as an ellipsoid with suitable parametrization.

### Topology Indication as an Independent Dedicated Configuration

In certain representative embodiments, a topology may be provided as an individual configuration to WTRU 102s. For example, a coverage topology configuration may not be part of the cell configuration and/or the conditional (re-)configuration. A coverage topology may depend upon the geographic deployment and coverage but the configuration and signaling may be provided by the network independent of the cell configuration and/or other conditional (re-)configurations.

For example, a coverage topology configuration may be in the form of network nodes deployment and beam attributes. For example, a coverage topology configuration may be in the form of on the ground detailed coverage incorporating the topographic and terrain specific features. A coverage and/or deployment topology configuration may provide the linkage (e.g., association) of indicated TRP locations and beam attributes to the cell identities and cell configurations.

### Topology Indication as Broadcast Signaling

In certain representative embodiments, a deployment and/or coverage topology indication may be transmitted by the network in the form of broadcast signaling. This information can be broadcast by the network and the relevant devices may be pre-informed or may have prior knowledge of how to receive and decode this information. For example, the control information to locate topology related broadcast information may be broadcast, such as through (e.g., special) paging and/or downlink control information informing all the devices about the broadcast based topology information.

In certain representative embodiments, a topology indication may be treated as part of the system information. For example, a (e.g., new) system information block (SIB) may be designed which carries and conveys the deployment and/or coverage topology indication. The network may use periodic transmission of a topology SIB to keep the WTRU 102s aware of the topology information. The WTRU 102s which may be starting the relevant services where outages need to be minimized may send a (e.g., explicit) request to the network requesting the transmission of the topology SIB.

### Activation of Deployment and Coverage Topologies

In certain representative embodiments, the network may provide one or more snapshots of a deployment and/or coverage topology through RRC signaling. For example, the RRC signaling may be broadcast based or WTRU 102 dedicated signaling. For example, the network may send a MAC-CE which may include information indicating one of the deployment/coverage topology snapshots which is considered as an activated topology. The activated topology may be used in LTM procedures, such as those described herein.

In certain representative embodiments, any of RRC signaling, MAC-CE and/or DCI may be used for topology activation. For example, a customized MAC-CE may be designed for this purpose, such as where the identity of the topology provides a pointer to one of the topologies configured through RRC signaling. For example, PHY based signaling, such as DCI, may be used to activate one of the configured topologies.

### LTM Configurations

As used herein, the terms LTM configuration, LTM candidate configuration, candidate configuration, target configuration and configuration, in general, may be used synonymously (e.g., unless otherwise distinguished).

For example, a LTM configuration may include a cell configuration (e.g., cell configuration information). A cell configuration may be provided by the network to the WTRU 102 at various abstraction levels. As an example, the network may provide a cell configuration to the WTRU 102 in the form of a serving cell configuration, such as by providing the information elements of “SCellConfig” or “SpCellConfig”. As an example, the network may provide a cell group configuration. A cell group configuration may include at least one “SpCellConfig”. As an example, the network may provide a cell configuration through an RRC-reconfiguration. An RRCReconfiguration message which may include a cell group configuration.

For example, a LTM configuration may include a measurement configuration (e.g., measurement configuration information). A measurement configuration may indicate a set of measurements over suitable radio and non-radio measurements. A measurement configuration may specify conditions which may trigger events upon fulfillment. For example, a LTM configuration may provide an association of one or more cell configurations and one or more measurement configurations.

In certain representative embodiments, a lower layer triggered mobility procedure may be used to switch a current serving cell for a more suitable target cell. For example, a current serving cell may be a primary cell of a master cell group, the primary cell of a secondary cell group, or any of the serving cells in the master, or secondary, cell group. Cell switching may require applying the cell configuration of a target LTM candidate configuration. For example, the LTM configuration may be provided as part of a cell group configuration, such as with a “CellGroupConfig” information element. For example, the LTM configuration may be provided through “SpCellConfig” or “SCellConfig” information elements (e.g., but may impose certain limitations in terms of LTM mobility scope).

For example, a WTRU 102 may perform procedures related to monitoring and/or evaluating certain suitable LTM measurement quantities and, based on certain conditions getting fulfilled, events may be triggered. Any (e.g., each) event is associated with certain target configurations and triggering of an event may result in the WTRU 102 executing the mobility to the associated target configuration. Details on LTM measurements and example events are described herein. An event may be linked to certain LTM configurations and triggering of the event may subsequently result in WTRU 102 performing the mobility switch to the relevant candidate configuration for which the execution conditions are fulfilled.

With LTM, a suitable set of configurations may be provided to the WTRU 102 prior to mobility events, such configurations may be based on (e.g., exploit) the knowledge of cells (e.g., deployed through a same DU or through different DUs). With dense networks using access points serving smaller areas through narrow beams and with the roll out of LTM feature, a WTRU 102 may (e.g., potentially) be configured with several LTM configurations in addition to higher layer configurations already supported. Supporting many LTM configurations may provide the advantage that a WTRU 102 may be able to make a faster LTM switch to one of the configured LTM candidates. One downside may be that the network needs to provide all these configurations to the WTRU 102 which may consume transmission resources. In addition, the WTRU 102 needs to keep all these configurations locally available to apply in case of LTM switching and needs to make measurements over the configured candidates and provide reporting to the network. This sets higher compute requirements at the WTRU 102 and making various measurements on LTM candidates may result in power and/or latency disadvantages.

Following are some of the approaches that can be used how the configurations are provided from the network to the WTRU 102 and how they are maintained at the WTRU 102.

### LTM Candidate Cells and Beams as Individual Configuration

In certain representative embodiments, the network may provide an (e.g., individual) configuration for any (e.g., each) LTM candidate, such as at the granularity of a cell and/or a beam. For example, a (e.g., extremely) large overhead may be incurred in terms of transmission resources and the WTRU 102 maintaining individual configurations.

### LTM Candidate Cell as Individual Configuration

In certain representative embodiments, the network may provide an individual configuration for any (e.g., each) LTM candidate cell. For example, the configuration may be linked to (e.g., associated with) different beams of a candidate cell. The beams may be identified through any of a SSB index, a CSI-RS index and/or a suitable TCI state (e.g., representing QCL relation to a suitable reference signal).

### LTM Candidate Cell as Delta Configuration

In certain representative embodiments, a cell configuration for any (e.g., each) LTM candidate cell may be provided as a delta configuration with respect to a suitable reference configuration. For example, the cell configuration may be applied for configured beams and/or TCI states of the candidate cell.

For example, a suitable reference configuration against which a delta configuration is provided can be a primary serving cell. For example, using dual connectivity, the reference configuration may be the primary serving cell of a corresponding cell group.

For example, a reference configuration may be explicitly provided to the WTRU 102. The network may choose (e.g., indicate) a suitable configuration which may best minimize the delta configurations' size and the overhead (e.g., in view of a serving DU and/or neighboring DUs).

For example, to minimize the signaling overhead, the network may choose (e.g., indicate) a suitable reference configuration as part of a LTM delta candidate configuration. As an example, the network may provide a LTM configuration for a cell C1 as a delta configuration. Within the delta configuration for C1, information (e.g., a pointer) may indicate which reference configuration is to be used as the reference configuration for the candidate C1. The network may select the reference configuration suitably, such as by providing the reference to one of the cell configurations which the WTRU 102 has been provided with and/or is the cell configuration over a same DU. If the WTRU 102 has not received any cell configuration on the same DU as candidate C1, the network may indicate (e.g., provide a pointer) to a cell configuration on a different DU.

For example, the network may provide one or more reference-DU-configurations associated to DUs for which the network intends to provide candidates for LTM switching. The identities of DUs may be provided in suitable format as part of these reference configurations. Any (e.g., each) delta configuration may be provided as a delta configuration on top of the reference-DU-configuration. For example, the reference-DU-configuration identity may be indicated with each candidate delta configuration.

In the examples with reference and delta configurations, a WTRU 102 may perform LTM switching and may apply a complete configuration which is derived jointly from a reference configuration and a delta configuration for the LTM candidate. In cases of conflict and/or overlap, the WTRU 102 may prioritize the configuration values and/or parameters, such as by using those provided as part of the delta configuration.

### LTM Configuration Activation and Updates

### Initial Activation of LTM Configurations

In certain representative embodiments, the network may provide one or more LTM configurations to a WTRU 102. The WTRU 102 may (e.g., initially) activate a subset of the LTM configurations. Depending upon application requirements, WTRU 102 mobility levels, WTRU 102 capabilities to support simultaneous LTM configurations, WTRU 102 subscription level and/or other network level consideration, the network may indicate (e.g., choose) to activate only a subset of the configured LTM configurations. For example, an activation status may be provided as ACTIVATED for some of the configurations while (e.g., at the time) they are being configured. The network may (e.g., also) activate suitable configurations after providing these configurations.

For example, the network may use any of RRC signaling, MAC-CE, and/or DCI to activate a LTM configuration. For example, the network may send a MAC-CE which can activate one or more LTM configurations. Two different MAC-CEs may be used to accommodate a different number of LTM configurations which may need to be activated for an eventual LTM procedure. For example, customized MAC-CEs can be used where the identities of the LTM configurations provide an indication (e.g., pointers) to the LTM configurations configured through RRC signaling. For example, a PHY based signaling, such as DCI, may be used to activate one or more of the configured LTM configurations.

### Network Activation and Deactivation for LTM Configuration

In certain representative embodiments, the network may provide a (e.g., initial) configuration of suitable LTM candidate cells and/or beams, such as to a WTRU 102 in RRC_Connected state. Prior to receiving an initial configuration, the WTRU 102 may send initial mobility assistance information to the network. The assistance information may include radio and/or non-radio measurement quantities. The network may provide initial coverage information to the WTRU 102 which is suitable according to its geographic location and/or the network deployment. The network may (e.g., also) provide the initial mobility configuration which may be associated with L1/L2 triggered mobility. For example, an initial LTM configuration may include suitable LTM configurations which may be triggered (e.g., based on L1/L2 measurements). For example, the choice of the suitable configuration candidates may be based on any of WTRU 102 capability for LTM mobility (e.g., as indicated to the network), WTRU 102 mobility requirements for active services and/or applications (e.g., QoS and/or QoE), WTRU 102 non-radio measurements (e.g., geographic coordinates and/or orientation), and/or network dynamics (e.g., cell load, amount of active traffic with different QoS, subscription levels, differentiated services). For example, the network may provide an initial configuration of LTM candidates to a given WTRU 102 based on any of the above (e.g., combinations thereof).

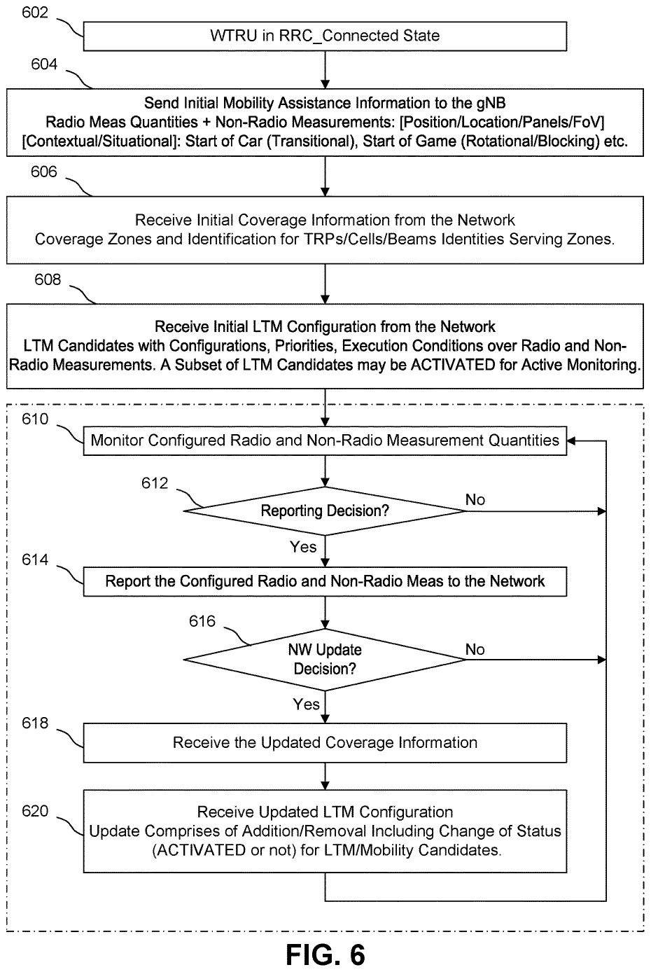

FIG. 6 is a procedural diagram of an example procedure for initial coverage and/or LTM configurations and coverage and/or LTM configuration updating. In certain representative embodiments, the procedure in FIG. 6 may be performed by a WTRU 102 in RRC_Connected state (e.g., after sending a RRCResumeComplete and/or RRCSetupComplete message) at 602. The WTRU 102 may send initial mobility assistance information to a base station (e.g., gNB 180) at 604. For example, the assistance information may include radio measurement quantities and/or non-radio measurement quantities (e.g., position, location, panels, and/or field of view). For example, the WTRU 102 may send the assistance information at the start of a car (e.g., transitional) and/or a start of a game (e.g., rotational and/or blocking). The WTRU 102 may receive initial coverage information from the network at 606. For example, the initial information may include coverage zones and/or identification of TRP, cell, and/or beam identities serving zones. The WTRU 102 may receive information indicating one or more initial LTM configurations from the network at 608. For example, the LTM candidates may be associated with configurations, priorities, execution condition (e.g., using radio and/or non-radio measurements), and/or activation status. For example, a subset of LTM candidates may be indicated as ACTIVATED for active monitoring by the WTRU 102. The WTRU 102 may monitor the configured radio and/or non-radio measurement quantities at 610. The WTRU 102 may determine whether or not a reporting decision is triggered at 612 and may proceed to report information indicating the configured radio and/or non-radio measurement quantities at 614. The network may determine whether to provide updated information, such as updates associated with the existing LTM configurations (e.g., the initial and/or activated LTM configurations), at 616. For example, the network may send information indicating updated coverage information to the WTRU 102 at 618. For example, the network may send information indicating one or more updated LTM configurations to the WTRU 102 at 620. For example, the network may update by addition and/or removal and/or change activation status of one or more LTM configurations and/or mobility candidates.

In certain representative embodiments, the initial configurations related to coverage information and/or LTM candidates may not be suitable anymore, such as where the WTRU 102 moves away from its previously reported location to a new location which may have a different set of suitable LTM candidate configurations. Thus, if the reported measurements from the WTRU 102, for radio and/or non-radio measurement quantities, change such that the previously configured LTM candidates are not suitable anymore, the network may update the configuration. The update process may an update of network coverage information and/or LTM candidate configurations as described herein. For example, an update may be the incremental addition and/or removal of previously provided configurations. For example, the network may decide to provide a new configuration.

Although not shown in the flowchart, the network can decide to update the configurations without explicit reports from the WTRU 102. One scenario can be where the network can estimate change of WTRU 102 location/position through uplink signals. These uplink signals can be the WTRU 102 uplink transmissions like PUSCH, PUCCH or some suitable reference signals, e.g., sounding reference signals etc.

In certain representative embodiments, the network may decide to update a LTM configurations independent of WTRU 102 reported information. The update may be made without any report from the WTRU 102, and/or after WTRU 102 reporting, such when indicating no change in the WTRU 102 location and/or position. A network update may be triggered based on a change in network dynamics in terms of active traffic and/or active devices. This may lead to a situation where some of the previously configured LTM candidates may not have resources to support an incoming WTRU 102 through the LTM procedure. The network may remove some of the previously configured LTM candidates and provide the configuration of additional LTM candidates to the WTRU 102.

### Joint Radio and Non-Radio Quantity Based LTM Measurements

In certain representative embodiments, radio measurements and/or non-radio measurements (e.g., any combinations thereof) may be used in lower layer mobility procedures. In certain representative embodiments, radio measurements and/or non-radio measurements (e.g., any combinations thereof) may be used in LTM procedures. For example, the measurement framework, configurations, quantities, and reporting mechanisms may be used by the WTRU 102 to evaluate configured conditions jointly over radio and non-radio quantities. For example, based on certain conditions being fulfilled and/or events triggered, a WTRU 102 may perform LTM switching to a candidate configuration according to the network configuration. The WTRU 102 may choose a suitable target configuration for LTM switching to a given target cell and/or beam(s), such as where the target cell and/or beam(s) may be broadcast by the network from a same DU (e.g., intra-DU scenarios) or from a different DU (e.g., inter-DU scenarios), as compared to a current serving cell and/or beam(s). For example, the cells and/or beams, execution conditions, and/or measurement quantities may be pre-configured by the network.

In certain representative embodiments, LTM measurements may be (e.g., primarily) lower layer measurements where the processing, necessary filtering (e.g., when configured) and/or reporting (e.g., when configured) occur at lower layers. For example, the lower layers may refer to L1 and/or L2. For example, L3 (e.g., the RRC layer of the radio protocol stack) may provide the configurations of the lower layers (e.g., PHY layer and MAC layer), and the lower layers may make and process measurements according to the configuration received through the RRC. In certain representative embodiments, LTM procedures may include involvement from L3 as described herein.

In certain representative embodiments, one or more WTRU 102s may be equipped with interfaces from any of non-3GPP RATs, local sensors, and/or may obtain environmental information and/or quantities from certain accumulation points. Use of these quantities and their integration with the measurements over 3GPP standardized RATs may be provided in a (e.g., harmonized) framework where the WTRU 102s may use the data from one or more non-3GPP RATs alone or in combination with the data and/or measurements over one or more 3GPP RATs. For example, measurements and/or data quantities from non-3GPP RATs and/or sensors may be used for beam change and/or cell change procedures.

Although the measurement framework may be described over (e.g., using) 3GPP radio signals, non-3GPP radio signals and/or local sensors in the context of lower layer mobility, some representative embodiments may be applied to other procedures and/or scenarios (e.g., other than LTM). For example, measurements and/or events may be used to adapt certain aspects of lower layer procedures, such as channel state information feedback. For example, measurements and/or events may be employed to start monitoring certain frequencies, cells, TRPs and/or beams at the trigger of certain events. For example, measurements and/or events may be employed for higher layer procedures, such as any of legacy handover, conditional handover, and/or conditional PSCell change and/or addition procedures.

### UE Capabilities for LTM PHY Measurements

In certain representative embodiments, a WTRU 102 may provide information indicating one or more capabilities of the WTRU 102 to make PHY layer measurements on radio signals and/or non-radio signals and/or sources. For example, a capability may be provided (e.g., initiated) by the WTRU 102 itself while attaching to the network and/or when transitioning RRC states. For example, the network may (e.g., also explicitly) request the WTRU 102 capability to make PHY layer and/or LTM measurements and the WTRU 102 may respond with information indicating the one or more capabilities of the WTRU 102.

For example, one or more relevant PHY layer measurements for LTM procedures are quantities computed over one or more reference signals. For example, a reference signal may refer to any of a (e.g., secondary) synchronization sequence (SS), a channel state information reference signal (CSI-RS), a positioning reference signal (PRS) and/or a sounding reference signal (SRS). For example, the resources and the reference antenna connectors may be defined similar to 3GPP 38.215, such as for any of the computation of reference signal received power (RSRP), reference signal received quality (RSRQ), signal-to-noise and interference ratio (SINR) and/or Received Signal Strength Indicator (RSSI).

Measurements on 3GPP Radio Quantities: In certain representative embodiments, a WTRU 102 may be capable of measuring one or more quantities on the PHY layer and may indicate the WTRU 102 capability for any of these quantities, a number of measurements on intra- and inter frequencies, and/or a number of frequencies and/or bands it can support for simultaneous measurements. In certain representative embodiments, PHY measurement quantities may be determined using (e.g., estimated over) any of SSBs, CSI-RSs, PRSs and/or SRSs.

In certain representative embodiments, a WTRU 102 may perform measurements to determine radio quantities which may include any of: SS reference signal received power (SS-RSRP); CSI reference signal received power (CSI-RSRP); SS reference signal received quality (SS-RSRQ); CSI reference signal received quality (CSI-RSRQ); SS signal-to-noise and interference ratio (SS-SINR); CSI signal-to-noise and interference ratio (CSI-SINR); SRS reference signal received power (SRS-RSRP); Received Signal Strength Indicator (RSSI); DL PRS reference signal received power (DL PRS-RSRP); DL reference signal time difference (DL RSTD); WTRU 102 Rx-Tx time difference; and/or SS reference signal antenna relative phase (SS-RSARP). A WTRU 102 may determine other radio quantities (e.g., in addition to) the above quantities.

Measurements on Non-3GPP Radio Quantities: In certain representative embodiments, a WTRU 102 may provide information indicating the WTRU 102 capability to measure and report one or more non-3GPP signal quantities through other available receivers on the device (e.g., of the WTRU 102). For example, non-3GPP signal quantities may be based on any of GNSS, WLAN and/or Bluetooth relevant measurements and the like.

GNSS Code Measurements: For example, GNSS measurements may include a GNSS code phase measurement (e.g., integer and/or fractional parts) of the spreading code of a GNSS satellite signal, such as provided by configuration or having a reference power.

GNSS Carrier Phase Measurements: For example, GNSS measurements may include a number of carrier-phase cycles measurement (e.g., integer and/or fractional parts) of a GNSS satellite signal, such as provided by configuration or having a reference power.

WLAN RSSI: For example, WLAN measurements may include an IEEE 802.11 WLAN RSSI measurement.

Bluetooth Measurements: For example, Bluetooth measurements may include any of a Bluetooth signal power and/or source ID measurements.

RF Pattern Identification and Matching based Measurements: For example, other non-3GPP radio measurements may include measurements for RF pattern identification and/or matching.

Terrestrial Beacon Systems: For example, other non-3GPP radio measurements may include measurements of terrestrial beacon signals.

Non-Radio Measurements available from local sensors: In certain representative embodiments, a WTRU 102 may have one or more (e.g., local) sensors which may provide (e.g., additional) non-radio measurements. Some examples are motion sensors (e.g., accelerometers, gyroscopes), environmental sensors (e.g., barometer or barometric pressure sensor), position sensors (e.g., magnetometers, orientation sensors) and/or velocity measurement sensors. For example, the sensors may provide any of the following measurements: linear acceleration and/or change of linear acceleration; velocity and/or change of velocity; orientation and/or change of orientation; angular velocity and/or change of angular velocity; atmospheric pressure and/or change of atmospheric pressure; and/or magnetic field and/or change of magnetic field.

In certain representative embodiments, a WTRU 102 may obtain quantities through non-3GPP interfaces. For example, a WTRU 102 capability indication may provide information associated with and/or identifying one or more sensors, one or more measurements available through the sensors, and/or an accuracy indication for those measurements.

Combinations of Radio and Non-Radio Measurements: In certain representative embodiments, one or more measurements may be defined which may be obtained by combining one or more radio measurements and/or one or more non-radio measurements. For example, a measurement may be a combination of WTRU 102 orientation with respect to a reference TRP. For example, WTRU 102 self-orientation may be defined in a suitable manner (e.g., the principal angle of its primary antenna (or antenna array) and can be obtained from local sensors). For example, the WTRU 102 self-orientation may be known at the network or may be conveyed as part of capability exchange information. In certain representative embodiments, a WTRU 102 orientation (e.g., with respect to a reference TRP) may be be defined as an angle at the WTRU 102 between its self-orientation and a line joining the WTRU 102 to the reference TRP. This determination may then use a variety of sources and methods. For example, a WTRU 102 can use GPS signals processed at WTRU 102 local sensors (e.g., hardware, firmware, and/or software) combined with a TRP location provided by the network over 3GPP radio signals. For example, a WTRU 102 may process TRP transmitted 3GPP radio signals and local estimates made over these signals, such as angle of arrival, to determine an angle of a reference TRP from a principal or broadside angle of its antenna array. The determination may use local sensors, such as a magnetometer and/or other orientation sensors in addition to the processing performed over the 3GPP radio signals. This information may be used at the WTRU 102 along with its self-orientation information to estimate the WTRU 102 orientation with respect to the reference TRP. For example, this class of measurements may be used (e.g., stored) as a sub-group of non-radio measurements.

In certain representative embodiments, a WTRU 102 may be a multi-panel WTRU 102 and a reference panel may be used at the WTRU 102 side. For example, a reference panel may have a larger number of antenna elements, have better sensitivity, and/or be a primary antenna panel by implementation and/or better connection to WTRU 102 Tx/Rx chains. For a multi-panel WTRU 102, reference panel information may be shared with the network, such as when the WTRU 102 provides information about their antenna panels implementation.

In certain representative embodiments, multi-TRP transmission may occur and a reference TRP may be used, such as for orientation determination purposes. A reference TRP may be a TRP transmitting DCI for single DCI based multi-TRP transmissions. For multi-DCI based multi-TRP, a reference TRP may identified, such as the TRP having a lower CORESETPooIndex. For example, the network may indicate explicitly the reference TRP. For WTRU 102 based selection, a WTRU 102 may choose a TRP that it receives through its reference antenna panel in cases of multi-panel WTRU 102s. For example, a reference TRP selection may be left to the WTRU 102 and the WTRU 102 may provide information indicating the reference TRP to the network through suitable signaling.

For measurement configurations which are part of 3GPP positioning and location services, an RRC request to a location management function (LMF) may be used to obtain positioning service for a target WTRU 102. The WTRU 102 may then be configured with suitable reference signals and methods for positioning purposes, the results of which can be used in LTM based procedures. For example, the RRC layer may be permitted to request a target WTRU 102 to launch the location services with the LMF and then the LMF may provide the information related to positioning signals and procedures to the RRC layer of the WTRU 102.

### Configuration for LTM Measurements

In certain representative embodiments, LTM measurements may be defined for each cell group. For example, in cases of dual connectivity, one configuration may be provided for a master cell group (MCG) and another configuration may be provided for asecondary cell group (SCG).

LTM configuration as part of Cell Group Configuration: In certain representative embodiments, a LTM measurement configuration may be provided as part of a cell group configuration. For example, a (e.g., new) structure of “LTM_meas_config” may be defined within the “CellGroupConfig”. Providing the configuration of LTM measurements within the CG configuration may be advantageous in that the configuration does not need to be provided with each cell change.

LTM configuration as part of RRC Configuration: In certain representative embodiments, a LTM measurement configuration may be provided through RRC_Reconfiguration signaling. For example, a WTRU 102 may associate one configuration to the MCG and another configuration to the SCG. The configurations may advantageously be maintained after a cell group configuration gets updated.

LTM configuration as part of Serving Cell Configuration: In certain representative embodiments, a LTM measurement configuration may be embedded inside a serving cell configuration. The serving cell configuration may provide the configuration for LTM measurements. For example, a (e.g., new) structure of “LTM_meas_config” within the “ServingCellConfig” may be provided. Each cell may be advantageously configured with relevant LTM measurements. The serving cell configuration may increase in size and serving cell updates requiring configuration updates may result in higher overhead.

In certain representative embodiments, the network configuration provides the mapping and/or association of LTM candidate configurations and the relevant measurement configurations, such as where one or more measurement configurations associated to a given LTM candidate configuration may provide the conditions under which the candidate configuration gets activated, deactivated and/or executed by the WTRU 102. Associations between LTM candidate configurations and measurement configurations are described herein.

In certain representative embodiments, a LTM measurement configuration may include information indicating the configuration of LTM measurement resources and/or LTM reporting configuration. For example, the configuration may include the quantity configuration. The quantity configuration may provide the lower layer filtering, processing and/or other measurement criteria applied to the LTM measurements (e.g., prior to reporting according to the reporting configuration).

In certain representative embodiments, a LTM measurement configuration may provide a plurality of (e.g., different) LTM measurement resources and/or LTM measurement reporting configurations. A high overhead may be incurred for a WTRU 102 in terms of making measurements, processing, and reporting them to the network, such as where the WTRU 102 has to make and report all these measurements to the network for the configured candidates. For example, a WTRU 102 may (e.g., will only) make measurements for the LTM candidates which have been indicated and/or determined to be ACTIVATED. The activation for LTM candidate configurations may be done through explicit network configuration, conditional upon radio or non-radio conditions, and/or after timer expiry. For example, the activation for LTM candidate configurations may be WTRU 102 controlled activation and deactivation through the monitoring and evaluating of conditions set by the network configuration. For WTRU 102 controlled activation of LTM candidate configurations, the network can configure the WTRU 102 to make the measurements relevant for the activation of the configured candidates. For example, the periodicity, reporting and other parameters for activation relevant measurements may be configured, such as to keep the WTRU 102 overhead minimal.

### LTM Measurement Resources

In certain representative embodiments, a set of measurement resources may be related to radio measurement resources which are being transmitted from a 3GPP RAT (e.g., NG-RAN, EUTRAN, UTRAN, GPRS, and/or GSM). For example, sources may be configured with suitable parametrization. The sources may include any of SSBs, CSI-RSs, PRSs, SRSs and/or other reference signals, such as those designed for measurement purposes. In addition to resource identification, a suitable resource mapping in terms of time and frequency, sub-carrier spacing (SCS), power control relevant parameters, periodicities for periodic resources, cell identities associated to measurement resources, and/or QCL information for measurement resources may be provided.

For example, one or more (e.g., new and/or additional) parameters may be provided to the measurement resources which may be used in LTM procedures. For example, the parameters may include any of DU identity or a suitable DU identifier, CU identity or a suitable CU identifier, and/or TRP identity or identifier. In certain embodiments, these parameters may be provided where some aspects of LTM procedures need such information to be known at the WTRU 102, such as based upon which WTRU 102 is expected to take certain actions.

### LTM Activation, Switching, Execution and Reporting Configuration

In certain representative embodiments, LTM measurements may provide a set of conditions. These conditions may be associated with (de-)activation, switching of LTM candidate configuration, and/or WTRU 102 reporting the measurements to the network. For example, a measurement configuration may provide generic conditions which can be used for activation, deactivation, switching, and/or execution purposes. For example, a measurement configuration may provide explicit conditions for activation, deactivation, switching, and/or execution purposes. Switching or execution conditions for LTM configurations may include the conditions under which a WTRU 102 may be configured to switch to a relevant candidate configuration.

For example, an execution or reporting configuration may provide the LTM triggers and execution conditions on the measurement quantities which are associated to a given reporting configuration. For example, a reference to the measurement identity may be provided as part of the LTM cell configuration.

For example, a WTRU 102 may be configured for reporting and reporting attributes may be provided in terms of periodic, semi-persistent and/or aperiodic nature of the configured measurement reporting. A reporting configuration may include the resources to be used to provide the report to the network. LTM reporting resources may include PUCCH resources, PUSCH resources, and/or a service request (SR) sent to the network when reporting conditions or trigger conditions are fulfilled. A reporting configuration may provide a sub-selection of measurement resources according to one or more criteria. For example, a reporting configuration may indicate the reporting of the N quantities which are measured to be strongest and/or largest in the configured measurement period. For example, a reporting configuration may provide the reporting of the N largest quantities, such as if they are larger than a configured threshold. The value of N may be configurable. In some cases, N may take the value of 1, 2, 3 or more. For example, where N is configured as 1, only the strongest measurement may be reported among the measurements made on configured resources.

### LTM Measurement Quantities for Activation, Switching, Execution and Reporting

In certain representative embodiments, a LTM measurement framework may provide the measurement quantities which are used for (de-)activation, switching, execution and/or reporting purposes. A configuration for measurement quantities may provide the additional processing and/or filtering that is to be applied to raw measurements prior to reporting. For example, the processing may include any of thresholding, quantization in particular formats, mapping to certain formats and/or bit ranges. For example, filtering coefficients may be specified to achieve a certain level of noise and/or channel variation filtering. For example, to achieve seamless mobility within shorter intervals of time, filtering may be enabled and/or disabled by configuration. For example, filtering coefficients may be set to values such that they enable raw measurement reporting.

For example, a LTM measurement configuration may include the 3GPP Based radio measurement quantities such as any of SSB-index-RSRP, SSB-index-RSRQ, SSB-index-SINR, CRI-RSRP, CRI-RSRQ, CRI-CQI, CRI-SINR, PRS and/or SRS quantities as described herein.

For example, a LTM measurement configuration may include the quantities for reporting and relevant post-processing/filtering for non-radio measurement quantities (e.g., of non-3GPP based radio signals available from local sensors and/or other interfaces).

### LTM Measurement Framework

In certain representative embodiments, LTM measurements may use an identity of a LTM reporting configuration as a LTM measurement identity. For example, a reporting configuration may include information indicating (e.g., pointers) to the LTM measurement resource configurations and LTM quantity configurations. For example, LTM measurements may be enabled, disabled, activated, deactivated or triggered by signaling, such as through DCI using the identify of a LTM reporting configuration.

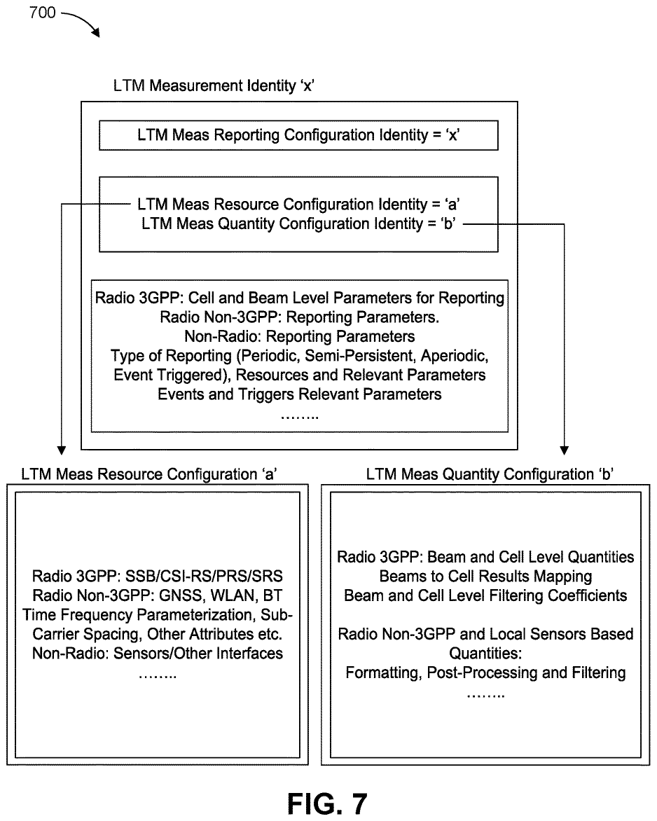

FIG. 7 is a LTM measurement framework diagram illustrating an example of associations 700 between a LTM measurement identity and LTM measurement resource configurations. In FIG. 7, a LTM measurement reporting configuration having an identity ‘x’ may include information indicating one or more LTM measurement resource configurations having identities ‘a’ and ‘b’. As shown in FIG. 7, the LTM measurement resource configuration ‘a’ may include a first set of radio 3GPP measurement types, radio non-3GPP measurement types, and non-radio measurement types (e.g., from sensors and/or other interfaces), and the LTM measurement resource configuration ‘b’ may include a second (e.g., different) set of radio 3GPP measurement types, radio non-3GPP measurement types, and non-radio measurement types (e.g., from local sensors).

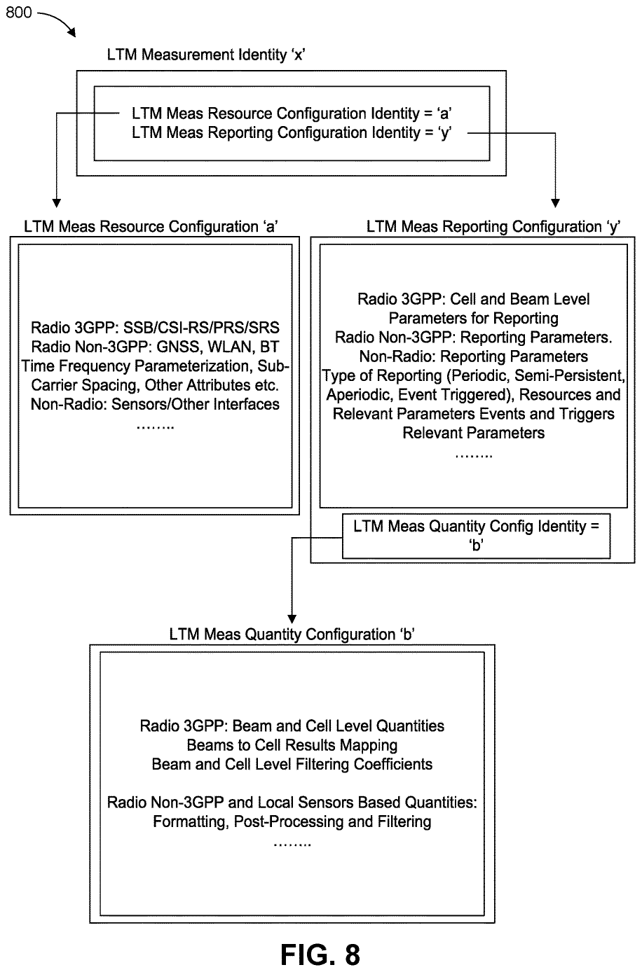

In certain representative embodiments, LTM measurements may use separate configurations for LTM measurement resources and LTM reporting. For example, a separate LTM measurement identity may include information indicating two configurations (e.g., provides two pointers). For example, one indication (e.g., pointer) is to a set(s) of LTM measurement resource identities, and another indication (e.g., pointer) is to an LTM reporting configuration. For example, a reporting configuration identity (e.g., object) may not be distinguishable (e.g., unique) using a LTM measurement identity as the LTM measurement identity may link a given reporting configuration to different sets of measurement resources to generate multiple LTM measurements. For example, a LTM measurement reporting configuration may include another indication (e.g., pointer) to a suitable LTM measurement quantity configuration. FIG. 8 is a LTM measurement framework diagram illustrating another example of associations 800 between a LTM measurement identity and LTM measurement resource configurations. As shown in FIG. 8, a LTM measurement reporting configuration ‘y’ may include an association with a LTM measurement quantity configuration ‘b’. In another example, parameters of a quantity configuration may be directly specified within a reporting configuration.

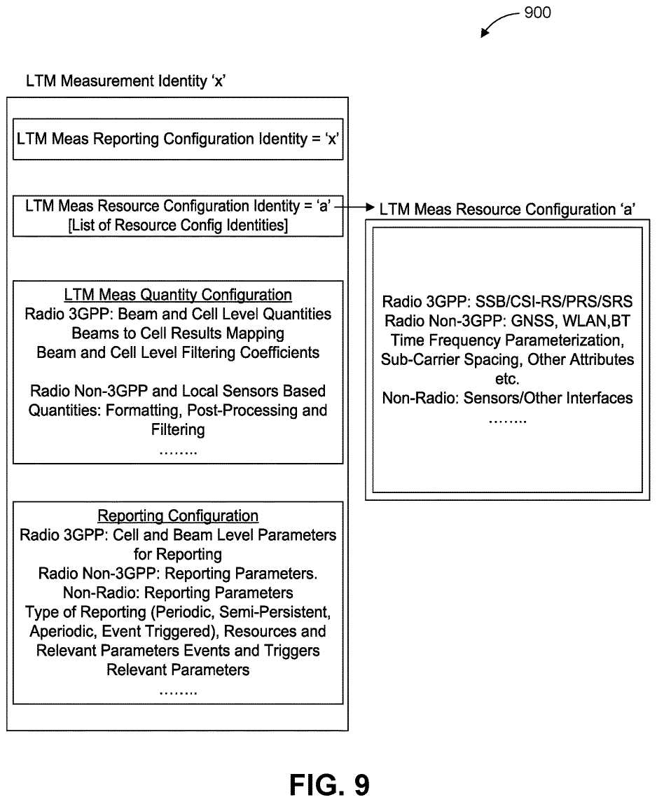

In certain representative embodiments, a reporting configuration may provide all the parameters related to reporting, quantity configuration and a list or a set of indications (e.g., pointers) to LTM measurement resource configuration identities. FIG. 9 is a LTM measurement framework diagram illustrating another example of associations 900 between a LTM measurement identity and LTM measurement resource configurations, LTM measurement quantity configurations, and reporting configurations.

In certain representative embodiments, the frameworks shown in FIGS. 7, 8 and 9 may be modified and/or combined to provide associations between the different configurations.

Activation and Deactivation of Measurements Associated with Non-Radio Quantities and Events

In certain representative embodiments, LTM measurements associated with LTM candidate configurations may be associated with non-radio quantities and/or events.

For example, a LTM measurement configuration may provide one or more activation conditions using one or more non-radio quantities. The non-radio quantities may be specified as conditional events with suitable definitions of thresholds and/or offsets used to determine the conditions. As an example, the activation of an LTM measurement configuration may be conditioned upon ab event when WTRU 102 enters a specific zone. Various events which may be used are described herein.

For example, LTM measurement configuration activation may be based on (e.g., conditioned upon) an event when a WTRU 102 device approaches (e.g., moves closer) to a network deployed transmission point (e.g., and its orientation is aligned with the transmission point). For example, the activation condition may be achieved by evaluating a set of events as described herein.

For example, one or more deactivation conditions may be specified (e.g., explicitly) as part of a LTM measurement configuration. As an example, when activation conditions are not fulfilled, a WTRU 102 may (e.g., will) deactivate the corresponding measurement configuration. As an example, if the activation condition is based (e.g., conditioned) on a WTRU 102 entering a specific zone, if the WTRU 102 exits the activation zone, the WTRU 102 may be configured to use the exit as a deactivation condition and may (e.g., will) stop making the measurements for the corresponding measurement configuration.

For example, the activation and/or deactivation conditions for LTM measurement configurations may be specified as part of a reporting configuration.

For example, the activation conditions may be specified as part of or using a measurement identity.

For example, the activation conditions may be specified as part of or using a resource identity.

### Integration of Non-3GPP and Non-Radio Measurements in LTM Measurement Reports

In certain representative embodiments, a LTM measurement framework may be enhanced to report radio measurements made over non-3GPP radio signals and/or non-radio measurement quantities.

For example, non-radio quantities may refer to the measurements available through local sensors and/or other non-radio interfaces.

For example, non-3GPP based radio measurements may refer to radio measurements which are made over (e.g., using) non-3GPP signals. Non-3GPP based radio measurements may refer to measurements defined for positioning and NTN ephemeris data. Non-3GPP based radio measurements may include the measurements from GNSS, WLAN, Bluetooth, and/or signals from other radio technologies that WTRU 102 may be capable of measuring and reporting.

In certain representative embodiments, a LTM measurement framework may be enhanced with a reporting identity that may provide a reporting configuration for non-radio measurements. The reporting configuration may provide a combination of radio measurement resources (by indicating their identities) and non-radio measurement quantities through suitable parameterization. The configuration may comprise non-radio quantities (e.g., only) and the LTM report may comprise of non-radio measurements (e.g., only). For non-radio-measurements, the reporting configuration may provide the information about the quantities with the events that need to be evaluated, reported and used for decision making to perform LTM switching, or otherwise broadly used in some form of conditional evaluation which may lead to switching or reconfiguration. These measurements may also indicate the type of filtering to be applied to the non-radio-measurement quantities through suitable parameters of quantity configurations. The filtering operation may be specified using the existing filtering mechanisms and/or coefficients for radio measurements, or other (e.g., new) filtering procedures and/or coefficients may be provided which are suitable to non-radio measurements.

Measurements Available from Local Sensors: In certain representative embodiments, such as in addition to the above mentioned measurements, a WTRU 102 may have local sensors which may provide additional measurements. Some examples are gyroscopes, accelerometers, barometric sensors, and/or velocity measurement sensors which may provide measurements, such as velocity, acceleration, orientation, atmospheric pressure and the like. These measurements can be further processed to compute other (e.g., more elaborate) quantities. For example, some of these quantities may in addition be obtained through non-3GPP interfaces.

### LTM Measurement Models and Processing

### Measurement Modeling

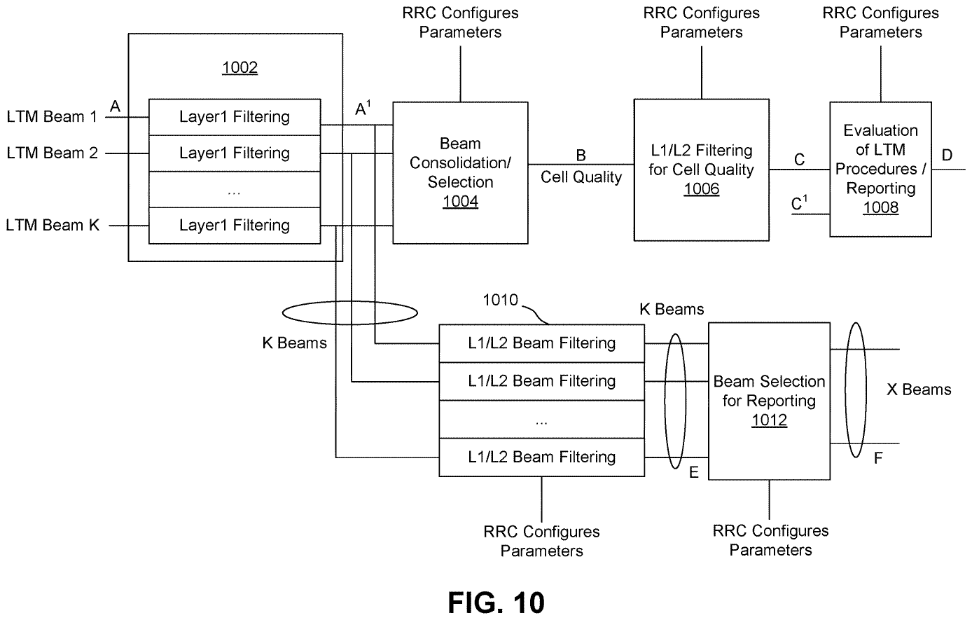

FIG. 10 is a LTM measurement diagram illustrating an example LTM measurement model with L1/L2 filtering. In certain representative embodiments, L1 filtering may be left to WTRU 102 implementation, such as with specified performance requirements. For example, in FIG. 10, beam consolidation to cells and filtering procedures may be specified by the RRC layer. L1/L2 filtered values may then be used to evaluate the trigger conditions for LTM procedures and/or for reporting procedures.

In FIG. 10, the LTM measurement model includes the following features:
A: Measurements (beam specific samples) internal to the physical layer.
Layer 1 filtering: Internal layer 1 filtering at 1002 of the inputs measured at point A. The exact filtering may implementation dependent. For example, how the measurements are actually executed in the physical layer by an implementation (inputs A and Layer 1 filtering) is not constrained by the standard.
A1: Measurements (e.g., beam specific measurements) reported by L1 to L3 after L1 filtering.
Beam Consolidation/Selection: Beam specific measurements are consolidated at 1004 to derive cell quality. The behaviour of the Beam consolidation/selection may be standardised, and the configuration may be provided by RRC signalling. Reporting period at B may be equal to one measurement period at point A1.
B: Measurement (e.g., cell quality) derived from beam-specific measurements reported to L3 after beam consolidation/selection.
L1/L2 filtering for cell quality: Filtering at 1006 performed on the measurements provided at point B. The behaviour of the L1/L2 filtering may be configured by the network. Filtering reporting period at point C may equal one measurement period at point B.
C: Measurement after processing in the L1/L2 filter. The reporting rate may be identical to the reporting rate at point B. This measurement may be used as input for one or more evaluation of reporting criteria.
Evaluation of reporting criteria: Checks at 1008 whether actual measurement reporting is necessary at point D. The evaluation may be based on more than one flow of measurements at reference point C (e.g., to compare between different WTRU 102 measurements). This is illustrated by inputs at points C and C1. The WTRU 102 may evaluate the reporting criteria at least every time a new measurement result is reported at points C, C1. The reporting criteria may be standardised, and the configuration may be provided by RRC signalling.
D: Measurement report information (message) sent on the radio interface.
L1/L2 Beam filtering: Filtering at 1010 performed on the measurements (e.g., beam specific measurements) provided at point A1. The behaviour of the L1/L2 beam filters may be part of the configuration. Filtering reporting period at E may equal one measurement period at A1.
E: Measurement (e.g., beam-specific measurement) after processing in the beam filter. The reporting rate may be identical to the reporting rate at point A1. This measurement may be used as input for selecting the X measurements to be reported.
Beam Selection for beam reporting: Select the X measurements at 1012 from the measurements provided at point E. The behaviour of the beam selection may be standardised, and the configuration of this module may be provided by RRC signalling.
F: Beam measurement information included in or with the measurement report information sent on the radio interface

In certain representative embodiments, a LTM measurement configuration may provide the framework through which the network may configure LTM measurements including radio and/or non-radio measurement quantities. The configured measurement quantities may be candidates for periodic, semi-persistent, aperiodic and/or event triggered reporting, such as may be indicated in “LTM Measurement Reporting Configuration”. For example, the events once triggered can in turn trigger the reporting of event fulfillment and execution of relevant LTM switching to a target candidate cell and/or beam. For example, any of one or more conditions, events, thresholds may be provided as part of the “LTM Measurement Reporting Configuration”.

Although the configuration to lower layers may be (e.g., primarily) managed through the RRC layer, the configured measurement quantities, radio and non-radio measurement based, may be configured with suitable conditions used to trigger certain LTM relevant events on the PHY layer. A number of example conditions and events are described herein. In the PHY based evaluation, the PHY layer itself may (e.g., will) perform the configured post-processing and filtering after making the measurements and/or getting the measurement quantities from other interfaces and local sensors.

In certain representative embodiments, condition evaluation may be performed to generate events and trigger certain procedures at the MAC layer. For example, the PHY layer may be kept simple, and the measurements may be passed on to the MAC layer at suitable intervals according to the configuration. The post-processing and filtering can be configured to be performed at the PHY layer or MAC layer or partially at both layers (e.g., L1 and L2). For example, the MAC layer may be responsible to evaluate the conditions on the processed quantities and generate suitable events. One advantage of this approach may be that by disabling the MAC processing/filtering, the latency can be similar to PHY latency.

In certain representative embodiments, the configuration may specify the filtering and post-processing to be performed with the periodicity specified and/or indicated. It may be up to WTRU 102 implementation to implement the filtering and post-processing in any of its layers. For example, the processing and time availability for the final quantities used to evaluate LTM triggers may be independent as to at which layer and/or block they are implemented.

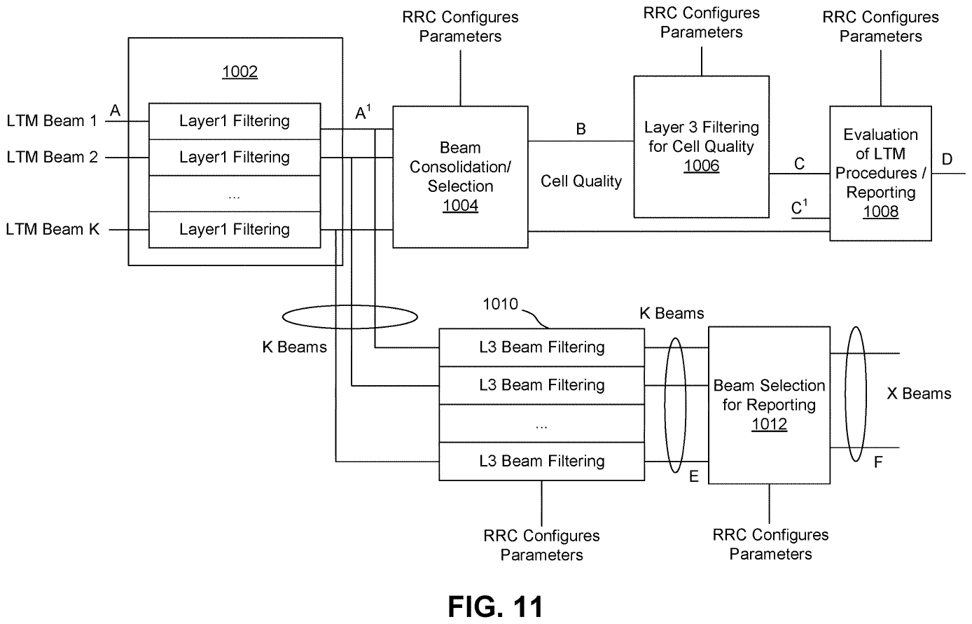

FIG. 11 is a LTM measurement diagram illustrating an example LTM measurement model with L1 and L3 based events. In FIG. 11, the LTM measurement model may include features which are generally the same as FIG. 10.

In certain representative embodiments, a LTM measurement framework may combine L1 and L3 filtered measurements and the LTM events may be set to be evaluated on the L1 measurement quantities or L3 measurement quantities or a combination of the measurement quantities (e.g., L1 and L3). For example, the combining may be specified by the network and configured by the RRC layer as shown in FIG. 11. As shown in FIG. 11, the L1 beam consolidated measurements may be provided from the beam consolidation/selection block at 1004 to the evaluation block at 1008, which also receives L3 filtered quantities. For example, the event triggers and execution conditions may need to specify whether the quantities to be evaluated are L1 or L3 or both.

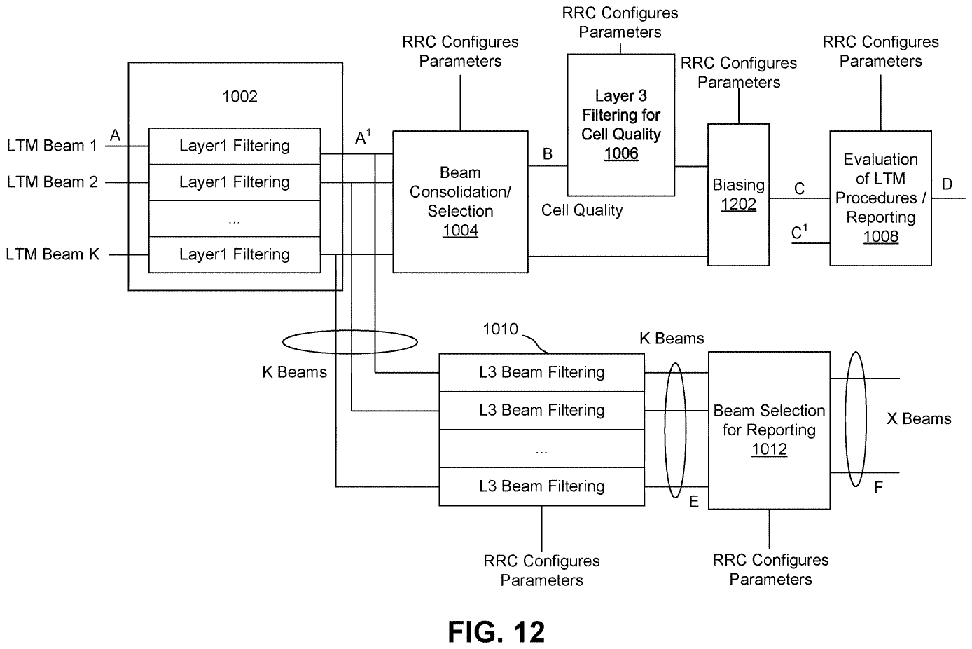

FIG. 12 is a LTM measurement diagram illustrating an example LTM measurement model with measurement biasing. In FIG. 12, the LTM measurement model may include features which are generally the same as FIGS. 10 and 11.

In certain representative embodiments, the L1 and L3 measurement quantities may be combined prior to the evaluation of events. For example, the combining may be performed at the biasing processing block at 1202 in FIG. 12. This block may be configured with appropriate configuration parameters through which lower layer measurements may be biased with L3 filtered quantities. The biasing block may be configured to apply biasing to lower layer measurements based upon L3 filtered measurements according to the configuration parameters. The biasing block may be modeled as a weighted combining of the L1 and L3 measurements. For example, the weights may be provided as part of the configuration. In another example, the biasing block may be considered as combining and filtering of input L1 and L3 quantities. The network may provide control (e.g., using RRC) configuring) over a suitable stable operating point for biased measurements which may be used to evaluate the execution conditions prior to triggering the reporting and/or the LTM cell switching procedures.

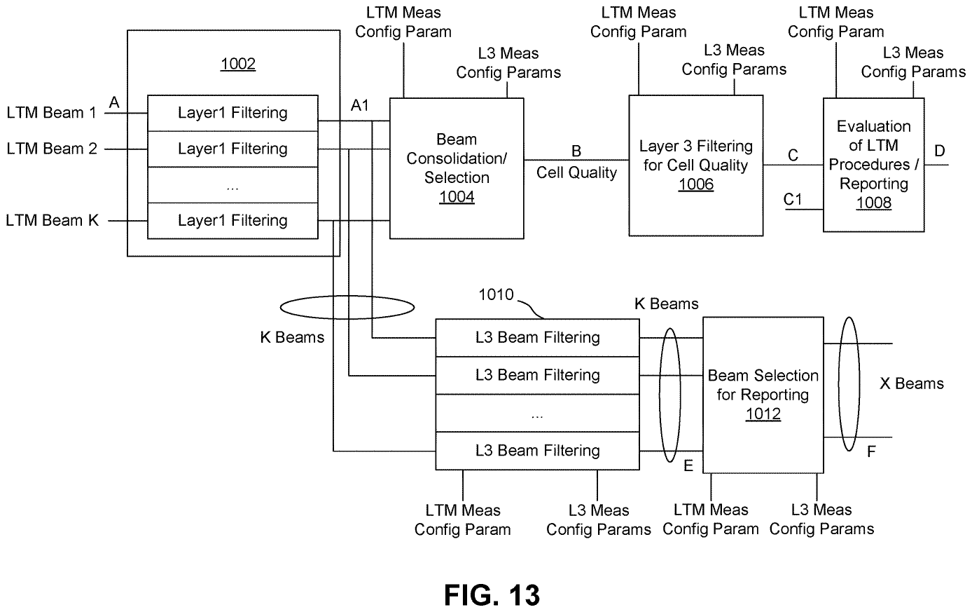

FIG. 13 is a LTM measurement diagram illustrating an example LTM measurement model unified for LTM and L3 measurements. In FIG. 13, the LTM measurement model may include features which are generally the same as FIGS. 10-12.

In certain representative embodiments, a (e.g., unified) model for L3 and LTM measurements may be used. Each of the blocks (e.g., beam consolidation, L3 filtering for cells/beams, and/or event evaluation parameters, such as offsets, hysteresis) may be provided with two sets of configuration parameters. One set may be used for L3 legacy measurements, and the second set may be used for LTM relevant measurements processing and events evaluation and/or monitoring. For example, a unified model for L3 and LTM measurements is shown in FIG. 13, where LTM measurement configuration parameters and L3 measurement configuration parameters are provided (e.g., separately). Though not shown in FIGS. 11-14, the candidate quantities may include radio and non-radio measurements as described herein.

As described herein, the network may share (e.g., a piece of) deployment and/or coverage information and one or more WTRU 102s may be configured with suitable LTM measurements comprising radio and non-radio quantities toward target cells and/or beams. A WTRU 102 may monitor and evaluate the configured quantities and, upon triggering of certain events, execute a LTM switch to a target candidate cell and/or beam for which configured conditions get satisfied.

In certain representative embodiments, the reporting configurations may be expanded to include the (e.g., new) non-radio measurements based events where WTRU 102s will use the data from local sensors. These events may use the deployment attributes of cells and beams, both serving (from primary cell group or secondary cell group), neighboring cells/beams, and/or LTM configured candidate cells/beam as provided by the network configuration. That is, the events may be created based upon the non-data measurements. The events may then be combined with the radio measurements based events to validate the suitability of cells and/or beams, such as for satisfactory signal strength.

In certain representative embodiments, composite events may be used where conditions are specified for both non-radio measurement quantities (e.g., location, position, orientation) and radio measurement quantities (e.g., RSRP, RSRQ, SINR of SSBs, CSI-RSs or other reference signals) and these composite events may be triggered when the suitable conditions from both radio and non-radio measurement groups are fulfilled. The triggering of composite events may be used as a trigger to execute certain WTRU 102 procedures and actions. For example, the events from LTM measurements (e.g., radio and non-radio based) may be used to trigger procedures, such as but not limited to, LTM switching to a suitable target cell and/or beam.

### Post-Processing and Filtering

In certain representative embodiments, a configuration may provide the selection of the suitable parameters related to additional post-processing and/or filtering coefficients which can be applied to one or more of the (e.g., raw) LTM measurements. For example, post-processing and/or filtering may be configured for any (e.g., all) LTM measurements. For example, post-processing and/or filtering may be fully applicable to any of 3GPP radio, non-3GPP radio, and/or non-radio measurements. Filtering and/or post-processing may be applied (e.g., as additional processing) to make the measurements quantities suitable for use in LTM procedures, such for any of intra-DU cell and/or beam switching, inter-DU cell and/or beam switching, and/or inter-CU cell and/or beam switching. Th measurement framework described herein may be used in other cell and/or beam level procedures (e.g., non-LTM procedures).

Derivation of Cell Quantities from Beam Measurements

In certain representative embodiments, a LTM measurement framework may include the derivation of cell level quantities from beam level measurements (e.g., addition to the post-processing and/or filtering). The parameters and/or thresholds to derive the cell level quantities for reporting and/or event evaluation purposes (e.g., when configured) from beam level measured quantities may be specified as part of a “LTM Measurement Quantity configuration.” For example, a “LTM Measurement Quantity configuration” may be indicated using an association (e.g., identity) from a “LTM Measurement Reporting Configuration”. For example, a mapping (e.g., mapping rules and relevant parameters) may be provided (e.g., directly) as part of a “LTM Measurement Reporting Configuration”.

### LTM Measurement Events and Triggers for Conditional Switching, Execution and Reporting

In certain representative embodiments, a WTRU 102 configured with LTM measurements may monitor and evaluate events configured over a suitable combination of radio and non-radio measurements. The measurement quantities over which the event conditions are set may follow measurement models as described herein. For example, reference measurement models may include where event conditions may be set on any of the following: L1 measurement quantities alone; L3 measurement quantities alone; Joint events on L1 and L3 measurement quantities; and/or L1 measurement quantities biased with L3 measurement quantities.

In certain representative embodiments, for non-radio measurement quantities, filtering information may be specified separately, or the non-radio measurement quantities may be configured to processed using the LTM measurement models described herein. For example, the non-radio measurements (e.g., after processing and/or filtering) are fed (e.g., input) to the event evaluation block.

Examples of procedures which use examples of these events are described herein. For example, some of the exemplary events may be based on using radio, non-radio and/or joint measurements. For example, a WTRU 102 may perform autonomous mobility handling, where the WTRU 102 evaluates certain configured conditions and events through local measurements and under suitable conditions may activate suitable LTM configurations and/or perform autonomous switching to suitable LTM candidate configurations.

As described below, a plurality of events are provided which relate to radio quantities from 3GPP and/or non-3GPP RATs and/or non-radio quantities. A plurality of joint events over these quantities are also described. For the example events, trigger conditions may use offsets and/or hysteresis values (e.g., which may not always be used) for LTM measurements. For example, trigger conditions without offset and/or hysteresis values may allow for a WTRU 102 to react quickly with changing channel conditions. For example, tuning parameters, offsets and/or hysteresis values may be removed altogether from the condition definitions, and/or they can be assigned zero or suitable values to achieve a desired latency.

The events described below may be be used in a variety of ways for different procedures. In certain representative embodiments, WTRU 102 controlled activation, deactivation, switching, and/or execution of LTM mobility may use the events. In other embodiments, the events may be used for non-LTM mobility. For example, suitable configuration of entering and leaving conditions in these events and/or conditions with suitable parameter sets may allow for (de-)activation, switching, and/or execution. For example, the (e.g., same) events and/or conditions may be used for activation and/or execution by providing suitable thresholds for each procedure.

### LTM Events Using 3GPP Radio Signal Measurements

In certain representative embodiments, a set of events may be referred to using the prefix, LTM-Ax. The nomenclature for these events may resemble the events defined in TS 38.331. For example, the set of events may be performed over measurements which are LTM measurements (e.g., which may be lower layer measurements with or without filtering as indicated in “LTM Measurement Configuration”). For example, the set of events may be evaluated at lower layers (e.g., L1, L2) and/or may trigger LTM measurement reporting or suitable LTM cell switching procedures.

LTM Event LTM-A1 (Serving Becomes Better than Threshold)

In certain representative embodiments, an event LTM-A1 may be used to slow down LTM based measurements monitoring and reporting. For example, a WTRU 102 may (e.g., shall):
consider the entering condition for this event to be satisfied when condition A1-1, as specified below, is fulfilled; and/or
consider the leaving condition for this event to be satisfied when condition A1-2, as specified below, is fulfilled;
for this measurement, consider the NR serving cell corresponding to the associated measObjectNR associated with this event.

For example, an inequality A1-1 (e.g., an entering condition) may be defined as Ms>Thresh.

For example, an inequality A1-2 (e.g., a leaving condition) may be defined as Ms<Thresh.

For example, the above conditions may be defined with some hysteresis values (e.g., which can be provided as part of the measurement configuration).

For example, the inequality A1-1 (e.g., an entering condition) may be defined as Ms−Hys>Thresh.

For example, the inequality A1-2 (e.g., a leaving condition) may be defined as Ms+Hys<Thresh.

For example, any of the foregoing variables may be defined as follows:
Ms may be the measurement result of the serving cell, not taking into account any offsets;
Hys may be the hysteresis parameter for this event (e.g., hysteresis as defined within reportConfigNR for this event);
Thresh may be the threshold parameter for this event (e.g., a1-Threshold as defined within reportConfigNR for this event);
Ms may be expressed in dBm in case of RSRP, or in dB in case of RSRQ and RS-SINR;
Hys may be expressed in dB; and/or
Thresh may be expressed in the same units as Ms.
   LTM Event LTM-A2 (Serving Becomes Worse than Threshold)

In certain representative embodiments, an event LTM-A2 may be used to trigger fast reporting and/or a change of LTM measurement periodicity. For example, a WTRU 102 may (e.g., shall):
consider the entering condition for this event to be satisfied when condition A2-1, as specified below, is fulfilled; and/or
consider the leaving condition for this event to be satisfied when condition A2-2, as specified below, is fulfilled;
for this measurement, consider the serving cell indicated by the measObjectNR associated to this event.

For example, an inequality A2-1 (e.g., an entering condition) may be defined as Ms+Hys<Thresh.

For example, an inequality A2-2 (e.g., a leaving condition) may be defined as Ms−Hys>Thresh.

For example, any of the foregoing variables may be defined as follows:
Ms may be the measurement result of the serving cell (e.g., not taking into account any offsets);
Hys may be the hysteresis parameter for this event (e.g., hysteresis as defined within reportConfigNR for this event);
Thresh may be the threshold parameter for this event (e.g., a2-Threshold as defined within reportConfigNR for this event);
Ms may be expressed in dBm in case of RSRP, or in dB in case of RSRQ and RS-SINR;
Hys may be expressed in dB; and/or
Thresh may be expressed in the same units as Ms.
   LTM Event LTM-A3 (Neighbor Becomes Offset Better than SpCell)

In certain representative embodiments, an event LTM-A3 may be used to conditionally trigger WTRU 102 reporting and/or conditional LTM switching. The event may be used to increase the measurement and/or reporting periodicity for a target neighbor candidate. For example, a WTRU 102 may (e.g., shall):
consider the entering condition for this event to be satisfied when condition A3-1, as specified below, is fulfilled; and/or
consider the leaving condition for this event to be satisfied when condition A3-2, as specified below, is fulfilled;
use the SpCell for Mp, Ofp and Ocp.

For example, any cell(s) that triggers the event may have reference signals indicated in the measObjectNR associated to this event which may be different from the NR SpCell measObjectNR.

For example, an inequality A3-1 (e.g., an entering condition) may be defined as Mn+Ofn+Ocn−Hys>Mp+Ofp+Ocp+Off.

For example, an inequality A3-2 (e.g., a leaving condition) may be defined as Mn+Ofn+Ocn+Hys<Mp+Ofp+Ocp+Off.

For example, any of the foregoing variables may be defined as follows:
Mn may be the measurement result of the neighbouring cell (e.g., not taking into account any offsets);
Ofn may be the measurement object specific offset of the reference signal of the neighbour cell (e.g., offsetMO as defined within measObjectNR corresponding to the neighbour cell);
Ocn may be the cell specific offset of the neighbour cell (e.g., cellIndividualOffset as defined within measObjectNR corresponding to the frequency of the neighbour cell), and set to zero if not configured for the neighbour cell;
Mp may be the measurement result of the SpCell (e.g., not taking into account any offsets);
Ofp may be the measurement object specific offset of the SpCell (e.g., offsetMO as defined within measObjectNR corresponding to the SpCell);
Ocp may be the cell specific offset of the SpCell (e.g., cellIndividualOffset as defined within measObjectNR corresponding to the SpCell), and is set to zero if not configured for the SpCell;
Hys may be the hysteresis parameter for this event (e.g., hysteresis as defined within reportConfigNR for this event);
Off may be the offset parameter for this event (e.g., a3-Offset as defined within reportConfigNR for this event);
Mn, Mp may be expressed in dBm in case of RSRP, or in dB in case of RSRQ and RS-SINR; and/or Ofn, Ocn, Ofp, Ocp, Hys, Off may be expressed in dB.
   LTM Event LTM-A4 (Neighbor Becomes Better than Threshold)

In certain representative embodiments, an event LTM-A4 may be used to conditionally trigger WTRU 102 reporting and/or conditional LTM switching. The event may also be used to increase the measurement and/or reporting periodicity for a target neighbor candidate. For example, a WTRU 102 may (e.g., shall):
consider the entering condition for this event to be satisfied when condition A4-1, as specified below, is fulfilled; and/or
consider the leaving condition for this event to be satisfied when condition A4-2, as specified below, is fulfilled.

For example, an inequality A4-1 (e.g., an entering condition) may be defined as Mn+Ofn+Ocn−Hys>Thresh.

For example, an inequality A4-2 (e.g., a leaving condition) may be defined as Mn+Ofn+Ocn+Hys<Thresh.

For example, any of the foregoing variables may be defined as follows:
Mn may be the measurement result of the neighbouring cell (e.g., not taking into account any offsets);
Ofn may be the measurement object specific offset of the neighbour cell (e.g., offsetMO as defined within measObjectNR corresponding to the neighbour cell);
Ocn may be the measurement object specific offset of the neighbour cell (e.g., cellIndividualOffset as defined within measObjectNR corresponding to the neighbour cell), and may be set to zero if not configured for the neighbour cell;
Hys may be the hysteresis parameter for this event (e.g., hysteresis as defined within reportConfigNR for this event);
Thresh may be the threshold parameter for this event (e.g., a4-Threshold as defined within reportConfigNR for this event);
Mn may be expressed in dBm in case of RSRP, or in dB in case of RSRQ and RS-SINR;
Ofn, Ocn, Hys are expressed in dB; and/or
Thresh may be expressed in the same units as Mn.
   LTM Event LTM-A5 (SpCell Becomes Worse than Threshold1 and Neighbour Becomes Better than Threshold2)

In certain representative embodiments, an event LTM-A5 may be used to conditionally trigger WTRU 102 reporting and/or WTRU 102 controlled LTM switching. The event may also be used to increase the measurement and/or reporting periodicity for a target neighbor candidate. For example, a WTRU 102 may (e.g., shall):
consider the entering condition for this event to be satisfied when both condition A5-1 and condition A5-2, as specified below, are fulfilled; and/or
consider the leaving condition for this event to be satisfied when condition A5-3 or condition A5-4, (e.g., at least one of the two, as specified below) is fulfilled;
use the SpCell for Mp.

For example, the parameters of the reference signal(s) of the cell(s) that triggers the event may be indicated in the measObjectNR associated to the event which may be different from the measObjectNR of the NR SpCell.

For example, an inequality A5-1 (e.g., an entering condition 1) may be defined as Mp+Hys<Thresh1.

For example, an inequality A5-2 (e.g., an entering condition 2) may be defined as Mn+Ofn+Ocn Hys>Thresh2.

For example, the inequality A5-3 (e.g., a leaving condition 1) may be defined as Mp−Hys>Thresh1.

For example, the inequality A5-4 (e.g., a leaving condition 2) may be defined as Mn+Ofn+Ocn+Hys<Thresh2.

For example, any of the foregoing variables may be defined as follows:
Mp may be the measurement result of the NR SpCell (e.g., not taking into account any offsets);
Mn may be the measurement result of the neighbouring cell (e.g., not taking into account any offsets);
Ofn may be the measurement object specific offset of the neighbour cell (e.g., offsetMO as defined within measObjectNR corresponding to the neighbour cell);
Ocn may be the cell specific offset of the neighbour cell (e.g., cellIndividualOffset as defined within measObjectNR corresponding to the neighbour cell), and set to zero if not configured for the neighbour cell;
Hys may be the hysteresis parameter for this event (e.g., hysteresis as defined within reportConfigNR for this event);
Thresh1 may be the threshold parameter for this event (e.g., a5-Threshold1 as defined within reportConfigNR for this event);
Thresh2 may be the threshold parameter for this event (e.g., a5-Threshold2 as defined within reportConfigNR for this event);
Mn, Mp may be expressed in dBm in case of RSRP, or in dB in case of RSRQ and RS-SINR;
Ofn, Ocn, Hys may be expressed in dB;
Thresh1 may be expressed in the same units as Mp; and/or
Thresh2 may be expressed in the same units as Mn.
   LTM Event LTM-A6 (Neighbour Becomes Offset Better than SCell)

In certain representative embodiments, an event LTM-A6 may be used to conditionally trigger WTRU 102 reporting and/or conditional LTM switching for Scell replacement. The event may also be used to increase the measurement and/or reporting periodicity for the target neighbor candidate. For example, a WTRU 102 may (e.g., shall):
consider the entering condition for this event to be satisfied when condition A6-1, as specified below, is fulfilled; and/or
consider the leaving condition for this event to be satisfied when condition A6-2, as specified below, is fulfilled;
for this measurement, consider the (secondary) cell corresponding to the measObjectNR associated to this event to be the serving cell.

For example, the reference signal(s) of the neighbour(s) and the reference signal(s) of the Scell are both indicated in the associated measObjectNR.

For example, an inequality A6-1 (e.g., an entering condition) may be defined as Mn+Ocn-Hys>Ms+Ocs+Off.

For example, an inequality A6-2 (e.g., a leaving condition) may be defined as Mn+Ocn+Hys<Ms+Ocs+Off.

For example, any of the foregoing variables may be defined as follows:
Mn may be the measurement result of the neighbouring cell (e.g., not taking into account any offsets);
Ocn may be the cell specific offset of the neighbour cell (e.g., cellIndividualOffset as defined within the associated measObjectNR), and set to zero if not configured for the neighbour cell;
Ms may be the measurement result of the serving cell (e.g., not taking into account any offsets);
Ocs may be the cell specific offset of the serving cell (e.g., cellIndividualOffset as defined within the associated measObjectNR), and is set to zero if not configured for the serving cell;
Hys may be the hysteresis parameter for this event (e.g., hysteresis as defined within reportConfigNR for this event);
Off may be the offset parameter for this event (e.g., a6-Offset as defined within reportConfigNR for this event);
Mn, Ms may be expressed in dBm in case of RSRP, or in dB in case of RSRQ and RS-SINR; and/or
Ocn, Ocs, Hys, Off may be expressed in dB.

### LTM Events Using Non-3GPP Radio and Non-Radio Measurements

In certain representative embodiments, LTM events may use the information from local sensors and/or non-3GPP interfaces, such as non-3GPP and/or non-radio measurements. In some embodiments, 3GPP radio signals may be used to improve the quality of the measurement quantities, such as for positioning related measurements. For example, a WTRU 102 may be capable of obtaining non-3GPP and/or non-radio measurements through local sensors and/or interfaces without using 3GPP radio signals.

For example, minimization of mobility interruptions through lower layer cell switching where additional benefit and deterministic mobility aspects may be gained by making use of information from non-3GPP radio signals. For example, combines non-3GPP radio signals and information data from local sensors, other interfaces may achieve such effects. Any of the following events may be used in LTM procedures.

LTM Non-Radio Event LTM-V1 (Velocity becomes larger than a threshold)

In certain representative embodiments, an event LTM-V1 may be used. For example, a WTRU 102 may (e.g., shall):
consider the entering condition for this event to be satisfied when condition V1-1, as specified below, is fulfilled; and/or
consider the leaving condition for this event to be satisfied when condition V1-2 as specified below, is fulfilled.

For example, an inequality V1-1 (e.g., an entering condition) may be defined as Mv-Hys>Thresh1.

For example, an inequality V1-2 (e.g., a leaving condition) may be defined as Mv+Hys<Thresh2.

For example, any of the foregoing variables may be defined as follows:
Mv may be the WTRU 102 velocity estimated by WTRU 102 through its local sensors (e.g., not taking into account any offsets);
Hys may be the hysteresis parameter for this event (e.g., hysteresis as defined within configuration for this event);
Thresh1 may be the threshold for this event defined as a reference velocity within configuration for this event and used as velocity threshold to enter this event;
Thresh2 may be the threshold for this event defined as a reference velocity within configuration for this event and used as velocity threshold to exit this event;
Mv may be expressed in Km/hour;
Hys may be expressed in the same units as Mv; and/or
Thresh1 and Thresh1 may be expressed in the same units as Mv.

LTM Non-Radio Event LTM-R1 (Device Rotation occurring for an amount larger than a Threshold)

In certain representative embodiments, an event LTM-R1 may be used. For example, a WTRU 102 may (e.g., shall):
consider the entering condition for this event to be satisfied when condition R1-1, as specified below, is fulfilled; and/or
consider the leaving condition for this event to be satisfied when condition R1-2, as specified below, is fulfilled.

For example, an inequality R1-1 (e.g., an entering condition) may be defined as Mr−Hys>Thresh1.

For example, an inequality R1-2 (e.g., a leaving condition) may be defined as Mr+Hys<Thresh2.

For example, any of the foregoing variables may be defined as follows:
Mr may be the WTRU 102 rotation estimated by WTRU 102 through its local sensors (e.g., not taking into account any offsets), where the rotation estimation is over a duration not exceeding a duration Td configured as part of the configuration;
Hys may be the hysteresis parameter for this event (e.g., hysteresis as defined within configuration for this event);
Thresh1 may be the threshold for this event defined as an amount of reference rotation within configuration for this event and used as rotation threshold to enter this event;
Thresh2 may be the threshold for this event defined as an amount of reference rotation within configuration for this event and used as rotation threshold to exit this event;
Mr may be expressed in degrees. Mr may be expressed in radians. The unit for Mr may be configured as part of the configuration;
Hys may be expressed in the same units as Mr; and/or
Thresh1 and Thresh2 may be expressed in the same units as Mr.
   LTM Non-Radio Event LTM-O1 (Device Orientation Changing from Current Orientation Larger than a Threshold)

In certain representative embodiments, an event LTM-O1 may be used. For example, a WTRU 102 may (e.g., shall):
consider the entering condition for this event to be satisfied when condition 01-1, as specified below, is fulfilled; and/or
consider the leaving condition for this event to be satisfied when condition 01-2, as specified below, is fulfilled.

For example, an inequality 01-1 (e.g., an entering condition) may be defined as Mo−Hys>Thresh1.

For example, an inequality 01-2 (e.g., a leaving condition) may be defined as Mo+Hys<Thresh2.

For example, any of the foregoing variables may be defined as follows:
Mo may be the change in WTRU 102 orientation estimated by WTRU 102 through its local sensors (e.g., not taking into account any offsets), where the orientation estimation is over a duration not exceeding a duration Td configured as part of the configuration;
Hys may be the hysteresis parameter for this event (e.g., hysteresis as defined within configuration for this event);
Thresh1 may be the threshold for this event defined as an amount of reference orientation change within configuration for this event and used as threshold to enter this event;
Thresh2 may be the threshold same as Thresh1 and used as rotation threshold to exit this event;
Mo may be expressed in degrees. Mo may be expressed in radians. The units for Mo may be configured as part of the configuration;
Hys may be expressed in the same units as Mo; and/or
Thresh1 and Thresh2 may be expressed in the same units as Mo.
   LTM Non-Radio Event LTM-OT1 (Device Orientation Matching the Direction of a Given TRP/Cell within Thresholds)

In certain representative embodiments, an event LTM-OT11 may be used.

For example, the conditions for this event evaluate if the WTRU 102 orientation is aligned towards a given TRP within a configured threshold. For example, the WTRU 102 self-orientation may be defined in a suitable manner, such as the principal angle of its primary antenna, antenna array, and/or obtained from local sensors. For example, the WTRU 102 orientation with respect to a reference TRP may be defined as the angle at the WTRU 102 between its self-orientation and a line joining the WTRU 102 to the reference TRP. This determination can then use a variety of sources and methods. For example, a WTRU 102 may use GPS signals processed at WTRU 102 local sensor (e.g., hardware, firmware, and/or software) combined with a TRP location provided by the network. In another example, a WTRU 102 may process TRP transmitted 3GPP radio signals and by local estimates made over these signals, such as angle of arrival, determine the angle of the reference TRP from a principal or broadside angle of its antenna array. This information may then be used at the WTRU 102 along with its self-orientation information to estimate the WTRU 102 orientation with respect to the reference TRP.

In certain representative embodiments, a current event LTM-OT1 can be configured such that the network provides a reference location to be used to evaluate WTRU 102 orientation alignment with respect to the reference orientation. For example, the network may ensure WTRU 102 orientation alignment with respect to any reference orientation and/or direction which may have no link to any of deployment topology. For example, a WTRU 102 may (e.g., shall):
consider the entering condition for this event to be satisfied when condition OT1-1, as specified below, is fulfilled; and/or
consider the leaving condition for this event to be satisfied when condition OT1-2, as specified below, is fulfilled.

For example, an inequality OT1-1 (e.g., an entering condition), such as the device has an absolute orientation matching a target cell beam, may be defined as abs(Ou-Thresh1)<Hys1.

For example, an inequality OT1-2 (e.g., a leaving condition) may be defined as abs(Ou-Thresh1)>Hys1.

For example, any of the foregoing variables may be defined as follows:
Ou is the WTRU 102 orientation estimated by WTRU 102 through its local sensors (e.g., not taking into account any offsets). The reference for orientation estimation for this event may be the TRP location or a suitable RS (e.g., beam) of the target cell and/or TRP. The use of TRP location and/or a signal from the TRP as reference makes this orientation estimation alignment with respect to the given TRP. The reference TRP indication, location, and/or signal to be used as reference from a given TRP may be provided as part of the network configuration;
Hys1 may be the hysteresis parameter for orientation condition used for this event;
Thresh1 may be the threshold for this event defined as an amount of reference orientation within the configuration for this event and used as a rotation threshold to enter this event;
Ou may be expressed in degrees with respect to a configured measurement reference. Ou may be expressed in radians. The units for Ou may be configured as part of the configuration;
Hys1 may be expressed in the same units as Ou; and/or
Thresh1 may be expressed in the same units as Ou.
   LTM Non-Radio Event LTM-OD1 (Device Orientation and Distance matching the location of a given TRP/Cell-Coverage within thresholds)

In certain representative embodiments, an event LTM-OD1 may be used. For example, a WTRU 102 may (e.g., shall):
consider the entering condition for this event to be satisfied when both condition OD1-1 and condition OD1-2, as specified below, are fulfilled; and/or
consider the leaving condition for this event to be satisfied when condition OD1-3 or condition OD1-4, as specified below, is fulfilled.

For example, an inequality OD1-1 (e.g., an entering condition 1), such as where the device has an absolute orientation matching a target cell beam, may be defined as abs(Ou-Thresh1)<Hys1.

For example, an inequality OD1-2 (e.g., an entering condition 2), such as where the device is within a suitable distance from a target TRP, may be defined as MI+Hys2<Thresh2.

For example, an inequality OD1-3 (e.g., a leaving condition 1) may be defined as abs(Ou-Thresh1)>Hys1.

For example, an inequality OD1-4 (e.g., a leaving condition 2) may be defined as MI+Hys2>Thresh2.

For example, any of the foregoing variables may be defined as follows:
MI may be the WTRU 102 location, represented by the distance between WTRU 102 and a reference location parameter for this event (e.g., a reference location of candidate TRP for this event and/or not taking into account any offsets);
Ou may be the WTRU 102 orientation estimated by WTRU 102 through its local sensors (e.g., not taking into account any offsets). The reference for orientation estimation for this event can be a suitable RS (e.g., beam) of a target TRP;
Hys1 may be the hysteresis parameter for orientation condition used for this event;
Thresh1 may be the threshold for this event defined as an amount of reference orientation within the configuration for this event and used as rotation threshold to enter this event;
Thresh2 may be the threshold for this event defined as a distance from a reference location configured in configuration for this event;
Ou may be expressed in degrees with respect to a configured measurement reference. Ou may be expressed in radians. The units for Ou may be configured as part of the configuration;
Hys1 may be expressed in the same units as Ou;
Thresh1 may be expressed in the same units as Ou;
MI may be expressed in meters;
Hys2 may be expressed in the same units as MI, and/or
Thresh2 may be expressed in the same units as MI.
   LTM Non-Radio Event LTM-OD2 (Device Orientation and Distance Matching Better the Location of a Given TRP/Cell-Coverage than the Serving TRP/Cell According to Configured Thresholds)

In certain representative embodiments, an event LTM-R1 may be used. For example, a WTRU 102 may (e.g., shall):
consider the entering condition for this event to be satisfied when both condition OD2-1 and condition OD2-2, as specified below, are fulfilled; and/or
consider the leaving condition for this event to be satisfied when condition OD2-3 or condition OD2-4, as specified below, is fulfilled.

For example, an inequality OD2-1 (e.g., an entering condition 1), such as where the device has an absolute orientation aligning better with a target cell TRP than a serving cell orientation, may be defined as abs(Ou−On)−Hys1<abs(Ou−Op).

For example, an inequality OD2-1 (e.g., an entering condition 2), such as where the device is within a suitable distance from a target TRP, may be defined as Dn-Hys2<Dp.

For example, an inequality OD2-3 (e.g., a leaving condition 1) may be defined as abs(Ou−On)+Hys1>abs(Ou−Op).

For example, an inequality OD2-4 (e.g., a leaving condition 2) may be defined as Dn+Hys2>Dp. For example, any of the foregoing variables may be defined as follows:
Ou may be the WTRU 102 reference orientation in absolute units estimated by WTRU 102 through its local sensors (e.g., not taking into account any offsets);
Op may be the orientation of the serving TRP in absolute units from the WTRU 102 as estimated by WTRU 102 using the location of the serving TRP received in the configuration;
On may be the orientation of the neighbour TRP in absolute units from the WTRU 102 as estimated by WTRU 102 using the location of the neighbour TRP received in configuration;
Hys1 may be the hysteresis parameter for orientation condition used for this event;
Dp may be the distance between WTRU 102 location and the location of the serving TRP where the location of the serving TRP is part of the configuration;
Dn may be the distance between WTRU 102 location and the location of the neighbour TRP where the location of the neighbour TRP is part of the configuration;
Hys2 may be the hysteresis parameter for distance condition used for this event;
Ou may be expressed in degrees with respect to a configured measurement reference. Ou may be expressed in radians. The units for Ou may be configured as part of the configuration;
Op, On and Hys1 may be expressed in the same units as Ou;
Dn may be expressed in meters; and/or
Dp and Hys2 may be expressed in the same units as Dn.

### LTM Non-Radio Event LTM-CM1 (Device Crossing Out the Boundary of a Specific Zone in the Coverage Topology)

In certain representative embodiments, an event LTM-CM1 may be used. For example, a WTRU 102 may (e.g., shall):
consider the entering condition for this event to be satisfied when condition CM1-1, as specified below, is fulfilled; and/or
consider the leaving condition for this event to be satisfied when condition CM1-2, as specified below, is fulfilled.

For example, an inequality CM1-1 (e.g., an entering condition), such as where the device crosses a boundary in the coverage topology, may be defined as MI1−Hys>Thresh1.

For example, an inequality CM1-2 (e.g., a leaving condition) may be defined as MI1+Hys<Thresh1.

For example, any of the foregoing variables may be defined as follows:
MI1 may be the WTRU 102 location, represented by the distance between WTRU 102 and a reference location parameter for this event (e.g., not taking into account any offsets);
Hys may be the hysteresis parameter for this event (e.g., hysteresis as defined within reportConfigNR for this event);
Thresh1 may be the threshold for this event defined as a distance from a reference location (e.g., serving TRP) to a boundary of the coverage topology. WTRU 102 may (e.g., will) derive Thresh1 from the coverage topology using the information of its current location, the serving TRP location, and/or the boundary definition according to the configuration. A boundary definition may correspond to the coverage of a RNA, TA, PLMN, and/or TRP coverage. The configuration may provide the information whether Thresh1 is LOS distance (in that case, Thresh1 is the distance of the coverage boundary on the line joining the serving TRP and WTRU 102) or a different calculation is to be used;
MI1 may be expressed in meters;
Hys may be expressed in the same units as MI1; and/or
Thresh1 may be expressed in the same units as MI1.

### LTM Non-Radio Event LTM-CM2 [Device Entering a Specific Zone)

In certain representative embodiments, an event LTM-CM2 may be used.

In certain representative embodiments, this event may evaluate the WTRU 102 entering a specific zone. A zone identification may be provided to the WTRU 102 through configuration. For example, the network may provide the coordinates for the zone center, its shape, and/or the lengths delimiting the zone. For example, a zone may be in the form of hexagon, square, or a rectangle. The network may provide the center coordinates, 1 length parameter for square zones, 2 length parameters for rectangular zones, or more parameters for other refined shaped zones. For example, a zone may represent sidelink style zones which are obtained through a configured processing over the GPS coordinates. The network may provide the WTRU 102 the configuration to compute the zones. The WTRU 102 may obtain its location and/or position estimate through local sensors. The WTRU 102 location information may be aided by using radio and/or non-radio signals. The computed location may allow the WTRU 102 to calculate its distance from the center of the zone. Knowing the zone boundary, the WTRU 102 may determine whether it has entered into a zone or not.

In certain representative embodiments, the zones may be associated to the network deployment and/or coverage. For example, the network may specify the zone center as a deployed TRP. The zone boundaries may be provided through suitable choice of parameters which could be delimited in the square, rectangular or hexagon shapes by specifying associated parameters as described herein.

In certain representative embodiments, the network may associate the configured zones to the effective coverage information of its cells, beams, and/or TRPs, such as through acquisition of past measurements reports from WTRU 102s, drive tests and the like.

For example, a WTRU 102 may (e.g., shall):
consider the entering condition for this event to be satisfied when condition CM2-1, as specified below, is fulfilled; and/or
consider the leaving condition for this event to be satisfied when condition CM2-2, as specified below, is fulfilled.

For example, an inequality CM2-1 (e.g., an entering condition), such as where the device crosses into a specific zone in the coverage topology, may be defined as MI1−Hys<Thresh1.

For example, an inequality CM1-2 (e.g., a leaving condition) may be defined as MI1+Hys>Thresh1.

For example, any of the foregoing variables may be defined as follows:
MI1 may be the WTRU 102 location, represented by the distance between WTRU 102 and a reference location parameter for this event (e.g., not taking into account any offsets). The reference location is attributed to the specific zone to which this event is associated;
Hys may be the hysteresis parameter for this event (e.g., hysteresis as defined within reportConfigNR for this event);
Thresh1 may be the threshold for this event defined as a distance from a reference location (e.g., reference gNB/TRP location of the reference zone) to a boundary of the coverage topology. The WTRU 102 may (e.g., will) derive Thresh1 from the coverage topology using the information of its current location, the reference gNB/TRP location, and/or the boundary definition according to the configuration. A boundary definition may correspond to the coverage of a RNA, TA, PLMN and/or gNB/TRP coverage. The configuration may provide the information whether Thresh1 is LOS distance (in that case, Thresh1 is the distance of the coverage boundary on the line joining the reference TRP and WTRU 102) or a different calculation is to be used. The network may provide the value for Thresh1 matching the zone configuration. If zone configuration suffices, the network may expect the WTRU 102 to derive the values for this threshold;
MI1 may be expressed in meters;
Hys may be expressed in the same units as MI1; and/or
Thresh1 may be expressed in the same units as MI1.
   LTM Non-Radio Event LTM-CM2V1 [LTM-CM2 && LTM-V1] (Device Entering a Specific Zone in the Coverage Topology and Velocity Becoming Larger than a Configured Threshold)

In certain representative embodiments, an event LTM-CM2V1 may be used.

The LTM-CM2V1 event may be used to conditionally trigger WTRU 102 reporting and/or conditional LTM switching based upon non-radio measurements, such as location coordinates and/or velocity estimation. The event may also be used to increase the measurement and/or reporting periodicity for a target neighbor candidate.

For example, this joint event is set on location estimation (e.g., which may be obtained through non-radio measurements) and velocity estimation (e.g., non-radio measurements). For example, this event may be specified solely over non-radio measurement quantities. In other examples, configurations may be provided where the location estimates are obtained (e.g., solely) over radio measurements, measurements over 3GPP radio signals, or a combination of any or more the former sets.

For example, a WTRU 102 may (e.g., shall):
consider the entering condition for this event to be satisfied when condition CM2V1-1 and condition CM2V1-2, as specified below, are fulfilled; and/or
consider the leaving condition for this event to be satisfied when condition CM2V1-3 or CM2V1-4, as specified below, is fulfilled.

For example, an inequality CM2V1-1 (e.g., an entering condition 1), such as where the device crosses into a specific zone in the coverage topology, may be defined as MI-Hys1<Thresh1.

For example, an inequality CM2V1-1 (e.g., an entering condition 2) may be defined as Mv−Hys2>Thresh2.

For example, an inequality CM2V1-3 (e.g., a leaving condition) may be defined as MI+Hys1>Thresh1.

For example, an inequality CM2V1-4 (e.g., a leaving condition) may be defined as Mv+Hys2<Thresh2.

For example, any of the foregoing variables may be defined as follows:
MI may be the WTRU 102 location, represented by the distance between WTRU 102 and a reference location parameter for this event (e.g., not taking into account any offsets). The reference location is attributed to the specific zone to which this event is associated;
Hys1 may be the hysteresis parameter for this event (e.g., hysteresis as defined within reportConfigNR for this event) to be used in location conditions;
Thresh1 may be the threshold for this event defined as a distance from a reference location (e.g., reference gNB/TRP location of the reference zone) to a boundary of the coverage topology. A WTRU 102 may (e.g., will) derive Thresh1 from the coverage topology using the information of its current location, the reference gNB/TRP location, and/or the boundary definition according to the configuration. A boundary definition may correspond to the coverage of a RNA, TA, PLMN and/or gNB/TRP coverage. The configuration may provide the information whether Thresh1 is LOS distance (in that case, Thresh1 is the distance of the coverage boundary on the line joining the reference TRP and WTRU 102) or a different calculation is to be used;
Mv may be the WTRU 102 velocity estimated by WTRU 102 through its local sensors (e.g., not taking into account any offsets);
Hys2 may be the hysteresis parameter for this event (e.g., hysteresis as defined within the configuration for this event) to be used for velocity condition evaluation;
Thresh2 may be the threshold for this event defined as a reference velocity within the configuration for this event and used as velocity threshold to enter/exit this event. For example, two separate thresholds may be configured for entry and exit conditions;
MI may be expressed in meters;
Hys1 may be expressed in the same units as MI;
Thresh1 may be expressed in the same units as MI;
Mv may be expressed in Km/hour or mph;
Hys2 may be expressed in the same units as Mv, and/or
Thresh2 may be expressed in the same units as Mv.
   LTM Non-Radio Event LTM-CM201 [LTM-CM2 && LTM-OT1] (Device Entering a Specific Zone in the Coverage Topology and Orientation Matching a Configured Orientation within a Threshold)

In certain representative embodiments, an event LTM-CM2OM1 may be used.

In certain representative embodiments, the event LTM-CM201 may be used to trigger WTRU 102 reporting based upon non-radio measurements, such as location coordinates providing zone entry information and/or orientation to a given TRP for a candidate configuration. The event may also be used to increase the measurement and/or reporting periodicity for a target neighbor candidate.

For example, this joint event is set on location estimation (e.g., which may be obtained through non-radio measurements) and orientation estimation (e.g., non-radio measurements). For example, this event may be specified solely over non-radio measurement quantities. In other examples, configurations may be provided where the location and/or orientation estimates are obtained (e.g., solely) over radio measurements, measurements over 3GPP radio signals, or a combination of any or more the former sets.

For example, a WTRU 102 may (e.g., shall):
consider the entering condition for this event to be satisfied when condition CM201-1 and condition CM201-2, as specified below, are fulfilled; and/or
consider the leaving condition for this event to be satisfied when condition CM201-3 or CM201-4, as specified below, is fulfilled.

For example, an inequality CM201-1 (e.g., an entering condition 1), such as where the device crosses into a specific zone in the coverage topology, may be defined as MI-Hys1<Thresh1.

For example, an inequality CM201-2 (e.g., an entering condition 2) may be defined as abs(Mo−Hys2)<Thresh2.

For example, an inequality CM201-3 (e.g., a leaving condition) may be defined as MI+Hys1>Thresh1.

For example, an inequality CM201-4 (e.g., a leaving condition) may be defined as abs(Mo+Hys2)>Thresh2.

For example, any of the foregoing variables may be defined as follows:
MI may be the WTRU 102 location, represented by the distance between WTRU 102 and a reference location parameter for this event (e.g., not taking into account any offsets). The reference location is attributed to the specific zone to which this event is associated;
Hys1 may be the hysteresis parameter for this event (e.g., hysteresis as defined within reportConfigNR for this event) to be used in location conditions;
Thresh1 may be the threshold for this event defined as a distance from a reference location (e.g., reference gNB/TRP location of the reference zone) to a boundary of the coverage topology. A WTRU 102 may (e.g., will) derive Thresh1 from the coverage topology using the information of its current location, the reference gNB/TRP location, and/or the boundary definition according to the configuration. A boundary definition may correspond to the coverage of a RNA, TA, PLMN and/or gNB/TRP coverage. The configuration may provide the information whether Thresh1 is LOS distance (in that case, Thresh1 is the distance of the coverage boundary on the line joining the reference TRP and WTRU 102) or a different calculation is to be used;
Mo may be the WTRU 102 orientation estimated by WTRU 102 through its local sensors (e.g., not taking into account any offsets), where the orientation estimation is over a duration not exceeding a duration Td configured as part of the configuration. The reference for orientation estimation for this event can be one of the cardinal directions, a suitable location (e.g., GPS coordinates), from WTRU 102 antenna (e.g., a TRP location), and/or a suitable RS (e.g., beam) of the target TRP. An orientation estimation may (e.g., will) provide a measure how closely WTRU 102 is aligned to a reference location and/or direction with respect to a reference WTRU 102 antenna or antenna panel. The reference location and/or direction and the reference WTRU 102 antenna for orientation estimation may all be provided as parts of the configuration;
Hys2 may be the hysteresis parameter for this event (e.g., hysteresis as defined within configuration for this event);
Thresh2 may be the threshold for this event defined as an amount of reference orientation change within the configuration for this event and used as threshold to enter this event;
MI may be expressed in meters;
Hys1 may be expressed in the same units as MI;
Thresh1 may be expressed in the same units as MI;
Mo may be expressed in degrees. Mo may be expressed in radians. The units for Mo may be configured as part of the configuration;
Hys2 may be expressed in the same units as Mo; and/or
Thresh2 may be expressed in the same units as Mo.

### LTM Joint Events Using Conditions Over Radio and Non-Radio Measurements

In certain representative embodiments, LTM events may use trigger conditions which are set over (e.g., evaluated using) radio and non-radio measurement quantities. For example, the non-radio quantities use the information from local sensors and/or non-3GPP interfaces. For example, 3GPP radio signals may be used to improve (e.g., modify) the quality of the non-radio measurement quantities. For example, the LTM events may radio and non-radio quantities to aid finding an accurate time, location, and/or zone for when the reporting should be made for (e.g., to aid) LTM procedures. For example, combinations of radio and non-radio quantities with known deployment, coverage, and/or environmental condition information and/or measurements of statistical radio quantities may be beneficial in the avoidance of mobility interruptions.

Joint Event LTM-J1 [LTM-CM2 && LTM-A4] (Device Entering a Specific Zone in the Coverage Topology and the Reference Cell in this Zone Becomes Better than a Threshold)

In certain representative embodiments, a joint event LTM-J1 may be used.

In certain representative embodiments, the joint event LTM-J1 may be used to trigger WTRU 102 controlled LTM switching and/or WTRU 102 initiated reporting for LTM switching based upon radio measurements and location coordinates. The event may also be used to increase the measurement and/or reporting periodicity for a target neighbor candidate.

For example, the joint event LTM-J1 may be used (e.g., set on) location estimation (e.g., which may be obtained through non-radio measurements) and reference cell quality (e.g., radio measurements). For example, a WTRU 102 may (e.g., shall):
consider the entering condition for this event to be satisfied when condition J1-1 and condition J1-2, as specified below, are fulfilled; and/or
consider the leaving condition for this event to be satisfied when condition J1-3 or J1-4, as specified below, is fulfilled.

For example, an inequality J1-1 (e.g., an entering condition), such as where the device crosses into a specific zone in a coverage topology, may be defined as MI-Hys1<Thresh1.

For example, an inequality J1-2 (e.g., an entering condition) may be defined as Mn+Ofn+Ocn−Hys2>Thresh2.

For example, an inequality J1-3 (e.g., a leaving condition) may be defined as MI+Hys1>Thresh1.

For example, an inequality J1-4 (e.g., a leaving condition) may be defined as Mn+Ofn+Ocn+Hys2<Thresh2.

For example, any of the foregoing variables may be defined as follows:
MI may be the WTRU 102 location, represented by the distance between WTRU 102 and a reference location parameter for this event (e.g., not taking into account any offsets). The reference location is attributed to the specific zone to which this event is associated;
Hys1 may be the hysteresis parameter for this event (e.g., hysteresis as defined within reportConfigNR for this event) to be used in location conditions;
Thresh1 may be the threshold for this event defined as a distance from a reference location (e.g., reference gNB/TRP location of the reference zone) to a boundary of the coverage topology. A WTRU 102 may derive Thresh1 from the coverage topology using the information of its current location, the reference gNB/TRP location, and/or a boundary definition according to the configuration. A boundary definition may correspond to the coverage of a RNA, TA, PLMN, and/or gNB/TRP coverage. The configuration provides the information whether Thresh1 is LOS distance (in that case, Thresh1 is the distance of the coverage boundary on the line joining the reference TRP and WTRU 102) or a different calculation is to be used;
Mn may be the measurement result of the neighbouring cell (e.g., not taking into account any offsets);
Ofn may be the measurement object specific offset of the neighbour cell (e.g., offsetMO as defined within measObjectNR corresponding to the neighbour cell);
Ocn may be the measurement object specific offset of the neighbour cell (e.g., cellIndividualOffset as defined within measObjectNR corresponding to the neighbour cell), and set to zero if not configured for the neighbour cell;
Hys2 may be the hysteresis parameter for this event (e.g., hysteresis as defined within reportConfigNR for this event) to be used in cell measurement conditions;
Thresh2 may be the threshold parameter for this event (e.g., a4-Threshold as defined within reportConfigNR for this event);
MI may be expressed in meters;
Hys1 may be expressed in the same units as MI1;
Thresh1 may be expressed in the same units as MI1;
Mn may be expressed in dBm in case of RSRP, or in dB in case of RSRQ and RS-SINR;
Ofn, Ocn, Hys2 may be expressed in dB; and/or
Thresh2 may be expressed in the same units as Mn.
   Joint Event LTM-J2 [LTM-OD2 && LTM-A4] (Device Orientation and Distance Matching Better the Location of a Given TRP than the Serving TRP According to the Configured Thresholds)

In certain representative embodiments, a joint event LTM-J2 may be used.

In certain representative embodiments, the joint event LTM-J2 may be used to trigger WTRU 102 controlled LTM switching and/or WTRU 102 initiated reporting for LTM switching based upon radio measurements and local estimation of orientation and/or distance. The event may also be used to increase the measurement and/or reporting periodicity for a target neighbor candidate.

For example, the joint event LTM-J2 may be set on location plus orientation estimation (e.g., which may be obtained through radio, non-radio, or combined radio and non-radio Measurements) and reference cell quality (e.g., radio measurements). For example, the event may provide (e.g., very) refined control when a WTRU 102 should be moved from one LTM cell to another cell, such as under network control or WTRU 102 control itself through a prior configuration.

For example, a WTRU 102 may (e.g., shall):
consider the entering condition for this event to be satisfied when conditions J2-1, J2-2 and J2-3, as specified below, are fulfilled; and/or
consider the leaving condition for this event to be satisfied when any of the conditions J2-4, or J2-5 or J2-6, as specified below, is fulfilled.

For example, an inequality J2-1 (e.g., an entering condition 1), such as where the device has an absolute orientation aligning better with a target cell TRP than a serving cell orientation, may be defined as abs(Ou−On)−Hys1<abs(Ou−Op).

For example, an inequality J2-2 (e.g., an entering condition 2), such as where the device is within a suitable distance from a target TRP, may be defined as Dn-Hys2<Dp.

For example, an inequality J2-3 (e.g., an entering condition 3) may be defined as Mn+Ofn+Ocn−Hys3>Thresh3.

For example, an inequality J2-4 (e.g., a leaving condition 1) may be defined as abs(Ou−On)+Hys1>abs(Ou−Op).

For example, an inequality J2-5 (e.g., a leaving condition 2) may be defined as Dn+Hys2>Dp.

For example, an inequality J2-6 (e.g., a leaving condition 3) may be defined as Mn+Ofn+Ocn+Hys3<Thresh3.

For example, any of the foregoing variables may be defined as follows:
Ou may be the WTRU 102 reference orientation in absolute units estimated by WTRU 102 through its local sensors (e.g., not taking into account any offsets);
Op may be the orientation of the serving TRP in absolute units from the WTRU 102 as estimated by WTRU 102 using the location of the serving TRP received in configuration;
On may be the orientation of the neighbour TRP in absolute units from the WTRU 102 as estimated by WTRU 102 using the location of the neighbour TRP received in configuration;
Hys1 may be the hysteresis parameter for orientation condition used for this event;
Dp may be the distance between WTRU 102 location and the location of the serving TRP where the location of the serving TRP is part of the configuration;
Dn may be the distance between WTRU 102 location and the location of the neighbour TRP where the location of the neighbour TRP is part of the configuration;
Hys2 may be the hysteresis parameter for distance condition used for this event;
Mn may be the measurement result of the neighbouring cell (e.g., not taking into account any offsets);
Ofn may be the measurement object specific offset of the neighbour cell (e.g., offsetMO as defined within measObjectNR corresponding to the neighbour cell);
Ocn may be the measurement object specific offset of the neighbour cell (e.g., cellIndividualOffset as defined within measObjectNR corresponding to the neighbour cell), and set to zero if not configured for the neighbour cell;
Hys3 may be the hysteresis parameter for this event (e.g., hysteresis as defined within reportConfigNR for this event) to be used in cell measurement conditions;
Thresh3 may be the threshold parameter for this event (e.g., a4-Threshold as defined within reportConfigNR for this event);
Ou may be expressed in degrees with respect to a configured measurement reference. Ou may be expressed in radians. The units for Ou may be configured as part of the configuration.
Op, On and Hys1 may be expressed in the same units as Ou;
Dn may be expressed in meters;
Dp and Hys2 may be expressed in the same units as Dn;
Mn may be expressed in dBm in case of RSRP, or in dB in case of RSRQ and RS-SINR;
Ofn, Ocn, Hys3 may be expressed in dB; and/or
Thresh3 may be expressed in the same units as Mn.
   Joint Event LTM-J3 [LTM-CM2 && LTM-A3] (Device Entering a Specific Zone in the Coverage Topology and the Reference Cell in this Zone Becomes Better than SpCell)

In certain representative embodiments, a joint event LTM-J3 may be used.

In certain representative embodiments, the joint event LTM-J3 may be used to trigger WTRU 102 controlled LTM switching and/or WTRU 102 initiated reporting leading to LTM switching replacing the SpCell based upon radio measurements and/or location coordinates according to the coverage information from the network. The event may also be used to increase the measurement and/or reporting periodicity for the target neighbor candidate.

For example, the joint event LTM-J3 may be set on location estimation (e.g., which may be obtained through non-radio measurements) and a comparison of a cell quality with a SpCell quality (e.g., radio measurements).

For example, a WTRU 102 may (e.g., shall):
consider the entering condition for this event to be satisfied when condition J3-1 and condition J3-2, as specified below, are fulfilled; and/or
consider the leaving condition for this event to be satisfied when condition J3-3 or J3-4, as specified below, is fulfilled.

For example, an inequality J3-1 (e.g., an entering condition), such as where the device crosses into a specific zone in a coverage topology, may be defined as MI-Hys1<Thresh1.

For example, an inequality J3-2 (e.g., an entering condition) may be defined as Mn+Ofn+Ocn−Hys2>Mp+Ofp+Ocp+Off.

For example, an inequality J3-3 (e.g., a leaving condition) may be defined as MI+Hys1>Thresh1.

For example, an inequality J3-4 (e.g., a leaving condition) may be defined as Mn+Ofn+Ocn+Hys2<Mp+Ofp+Ocp+Off.

For example, any of the foregoing variables may be defined as follows:
MI may be the WTRU 102 location, represented by the distance between WTRU 102 and a reference location parameter for this event (e.g., not taking into account any offsets). The reference location is attributed to the specific zone to which this event is associated;
Hys1 may be the hysteresis parameter for this event (e.g., hysteresis as defined within reportConfigNR for this event) to be used in location conditions.
Thresh1 may be the threshold for this event defined as a distance from a reference location (e.g., reference gNB/TRP location of the reference zone) to a boundary of the coverage topology. A WTRU 102 may derive Thresh1 from the coverage topology using the information of its current location, the reference gNB/TRP location, and/or a boundary definition according to the configuration. A boundary definition may correspond to the coverage of a RNA, TA, PLMN, and/or gNB/TRP coverage. The configuration provides the information whether Thresh1 is LOS distance (in that case, Thresh1 is the distance of the coverage boundary on the line joining the reference TRP and WTRU 102) or a different calculation is to be used;
Mn may be the measurement result of the neighbouring cell (e.g., not taking into account any offsets);
Ofn may be the measurement object specific offset of the neighbour cell (e.g., offsetMO as defined within measObjectNR corresponding to the neighbour cell);
Ocn may be the measurement object specific offset of the neighbour cell (e.g., cellIndividualOffset as defined within measObjectNR corresponding to the neighbour cell), and set to zero if not configured for the neighbour cell;
Mp may be the measurement result of the SpCell (e.g., not taking into account any offsets);
Ofp may be the measurement object specific offset of the SpCell (e.g., offsetMO as defined within measObjectNR corresponding to the SpCell);
Ocp may be the cell specific offset of the SpCell (e.g., cellIndividualOffset as defined within measObjectNR corresponding to the SpCell), and is set to zero if not configured for the SpCell;
Off may be the offset parameter for this event (e.g., a3-Offset as defined within reportConfigNR for this event);
Hys2 may be the hysteresis parameter for this event (e.g., hysteresis as defined within reportConfigNR for this event) to be used in cell measurement conditions;
MI may be expressed in meters;
Hys1 may be expressed in the same units as MI1;
Thresh1 may be expressed in the same units as MI1;
Mn, Mp may be expressed in dBm in case of RSRP, or in dB in case of RSRQ and RS-SINR; and/or
Ofn, Ocn, Ofp, Ocp, Hys2, Off may be expressed in dB.
   Joint Event LTM-J4 [LTM-OD2 && LTM-A3] (Device Orientation and Distance Matching Better the Location of a Given TRP/Cell than the Serving TRP/Cell According to the Configured Thresholds and the Reference Cell in this Zone Becomes Better than SpCell)

In certain representative embodiments, a joint event LTM-J4 may be used.

In certain representative embodiments, the joint event LTM-J4 may be used to trigger WTRU 102 initiated switching and/or reporting leading to LTM switching based upon radio measurements, device orientation and/or location coordinates providing a distance estimate. The event may also be used to increase the measurement and/or reporting periodicity for a target neighbor candidate.

For example, the joint event LTM-J4 may be set on location and orientation estimation (e.g., which may be obtained through radio, non-radio, or combined radio and non-radio measurements) and a comparison of cell quality with a SpCell quality (e.g., radio measurements). The event may provide (e.g., very) refined control when a WTRU 102 should be moved from one LTM cell to another cell, such as under network control or WTRU 102 control itself through a prior configuration.

For example, a WTRU 102 may (e.g., shall):
consider the entering condition for this event to be satisfied when conditions J4-1, J4-2 and J4-3, as specified below, are fulfilled; and/or
consider the leaving condition for this event to be satisfied when any of the conditions J4-4, or J4-5 or J4-6, as specified below, is fulfilled.

For example, an inequality J4-1 (e.g., an entering condition 1), such as where the device has an absolute orientation aligning better with a target cell TRP than a serving cell orientation, may be defined as abs(Ou−On)−Hys1<abs(Ou−Op).

For example, an inequality J4-2 (e.g., an entering condition 2), such as where the device is within a suitable distance from a target TRP, may be defined as Dn-Hys2<Dp.

For example, an inequality J4-3 (e.g., an entering condition) may be defined as Mn+Ofn+Ocn−Hys3>Mp+Ofp+Ocp+Off.

For example, an inequality J4-4 (e.g., a leaving condition 1) may be defined as abs((Ou−On)+Hys1>abs(Ou−Op).

For example, an inequality J4-5 (e.g., a leaving condition 2) may be defined as Dn+Hys2>Dp.

For example, an inequality J4-6 (e.g., a leaving condition 3) may be defined as Mn+Ofn+Ocn+Hys3<Mp+Ofp+Ocp+Off.

For example, any of the foregoing variables may be defined as follows:
Ou may be the WTRU 102 reference orientation in absolute units estimated by WTRU 102 through its local sensors (e.g., not taking into account any offsets);
Op may be the orientation of the serving TRP in absolute units from the WTRU 102 as estimated by WTRU 102 using the location of the serving TRP received in the configuration;
On may be the orientation of the neighbour TRP in absolute units from the WTRU 102 as estimated by WTRU 102 using the location of the neighbour TRP received in the configuration;
Hys1 may be the hysteresis parameter for orientation condition used for this event;
Dp may be the distance between WTRU 102 location and the location of the serving TRP where the location of the serving TRP is part of the configuration;
Dn may be the distance between WTRU 102 location and the location of the neighbour TRP where the location of the neighbour TRP is part of the configuration;
Hys2 may be the hysteresis parameter for distance condition used for this event;
Mn may be the measurement result of the neighbouring cell (e.g., not taking into account any offsets);
Ofn may be the measurement object specific offset of the neighbour cell (e.g., offsetMO as defined within measObjectNR corresponding to the neighbour cell);
Ocn may be the measurement object specific offset of the neighbour cell (e.g., cellIndividualOffset as defined within measObjectNR corresponding to the neighbour cell), and set to zero if not configured for the neighbour cell;
Mp may be the measurement result of the SpCell (e.g., not taking into account any offsets);
Ofp may be the measurement object specific offset of the SpCell (e.g., offsetMO as defined within measObjectNR corresponding to the SpCell);
Ocp may be the cell specific offset of the SpCell (e.g., cellIndividualOffset as defined within measObjectNR corresponding to the SpCell), and is set to zero if not configured for the SpCell;
Off may be the offset parameter for this event (e.g., a3-Offset as defined within reportConfigNR for this event);
Thresh3 is the threshold parameter for this event (e.g., a4-Threshold as defined within reportConfigNR for this event);
Ou may be expressed in degrees with respect to a configured measurement reference. Ou may be expressed in radians. The units for Ou may be configured as part of the configuration;
Op, On and Hys1 may be expressed in the same units as Ou;
Dn may be expressed in meters;
Dp and Hys2 may be expressed in the same units as Dn;
Mn, Mp may be expressed in dBm in case of RSRP, or in dB in case of RSRQ and RS-SINR; and/or
Ofn, Ocn, Ofp, Ocp, Hys3, Off may be expressed in dB.
   Joint Event LTM-J5 [LTM-CM2 && LTM-V1 && LTM-A4] (Device Entering a Specific Zone in the Coverage Topology, Velocity Larger than a Configured Threshold and the Reference Cell in this Zone Becomes Better than a Threshold)

In certain representative embodiments, a joint event LTM-J5 may be used.

In certain representative embodiments, the joint event LTM-J5 may be used to trigger WTRU 102 initiated reporting leading to LTM switching based upon radio measurements and/or location coordinates. The event may also be used to increase the measurement and/or reporting periodicity for a target neighbor candidate.

For example, the joint event LTM-J5 may be set on location estimation (e.g., which may be obtained through radio, non-radio, or combined radio and non-radio Measurements), velocity estimation (e.g., non-radio measurements), and reference cell quality (e.g., radio measurements).

For example, the event may be triggered when a WTRU 102 enters a specific zone with a velocity larger than a threshold and with a cell quality of a reference cell becoming better than another threshold. For example, this event may be used over highways to determine the whereabouts of a WTRU 102, and the network may switch the cell which is deployed after the reference cell, such as due to a high velocity indication as part of the event setup.

For example, a WTRU 102 may (e.g., shall):
consider the entering condition for this event to be satisfied when condition J5-1, J5-2 and condition J5-3, as specified below, are fulfilled; and/or
consider the leaving condition for this event to be satisfied when condition J5-4 or J5-5 or J5-6, as specified below, is fulfilled.

For example, an inequality J5-1 (e.g., an entering condition 1), such as where the device crosses into a specific zone in a coverage topology, may be defined as MI−Hys1<Thresh1.

For example, an inequality J5-2 (e.g., an entering condition 2) may be defined as Mn+Ofn+Ocn−Hys2>Thresh2.

For example, an inequality J5-3 (e.g., an entering condition 3) may be defined as Mv−Hys3>Thresh3.

For example, an inequality J5-4 (e.g., a leaving condition 1) may be defined as MI+Hys1>Thresh1.

For example, an inequality J5-5 (e.g., a leaving condition 2) may be defined as Mn+Ofn+Ocn+Hys2<Thresh2.

For example, an inequality J5-6 (e.g., a leaving condition 3) may be defined as Mv+Hys1<Thresh3.

For example, any of the foregoing variables may be defined as follows:
MI may be the WTRU 102 location, represented by the distance between WTRU 102 and a reference location parameter for this event (e.g., not taking into account any offsets). The reference location is attributed to the specific zone to which this event is associated;
Hys1 may be the hysteresis parameter for this event (e.g., hysteresis as defined within reportConfigNR for this event) to be used in location conditions;
Thresh1 may be the threshold for this event defined as a distance from a reference location (e.g., reference gNB/TRP location of the reference zone) to a boundary of the coverage topology. A WTRU 102 may derive Thresh1 from a coverage topology using the information of its current location, the reference gNB/TRP location, and/or a boundary definition according to the configuration. A boundary definition may correspond to the coverage of a RNA, TA, PLMN and/or gNB/TRP coverage. The configuration provides the information whether Thresh1 is LOS distance (in that case, Thresh1 is the distance of the coverage boundary on the line joining the reference TRP and WTRU 102) or a different calculation is to be used;
Mn may be the measurement result of the neighbouring cell (e.g., not taking into account any offsets);
Ofn may be the measurement object specific offset of the neighbour cell (e.g., offsetMO as defined within measObjectNR corresponding to the neighbour cell);
Ocn may be the measurement object specific offset of the neighbour cell (e.g., cellIndividualOffset as defined within measObjectNR corresponding to the neighbour cell), and set to zero if not configured for the neighbour cell;
Hys2 may be the hysteresis parameter for this event (e.g., hysteresis as defined within reportConfigNR for this event) to be used in cell measurement conditions;
Thresh2 may be the threshold parameter for this event (e.g., a4-Threshold as defined within reportConfigNR for this event);
Mv may be the WTRU 102 velocity estimated by WTRU 102 through its local sensors (e.g., not taking into account any offsets);
Hys3 may be the hysteresis parameter for this event (e.g., hysteresis as defined within configuration for this event) to be used for velocity condition evaluation;
Thresh3 may be the threshold for this event defined as a reference velocity within the configuration for this event and used as velocity threshold to enter/exit this event. Two separate thresholds may be configured for entry and exit conditions;
MI may be expressed in meters;
Hys1 may be expressed in the same units as MI1;
Thresh1 may be expressed in the same units as MI1;
Mn may be expressed in dBm in case of RSRP, or in dB in case of RSRQ and RS-SINR;
Ofn, Ocn, Hys2 may be expressed in dB;
Thresh2 may be expressed in the same units as Mn;
Mv may be expressed in Km/hour;
Hys3 may be expressed in the same units as Mv, and/or
Thresh3 may be expressed in the same units as Mv.

### Additional Examples of Non-Radio Events and Joint Events

In certain representative embodiments, any of the foregoing events may be used for procedures described herein. For example, the events may combine measurement quantities obtained over radio measurements and non-radio measurements which may be used to update LTM related measurements, trigger reporting, trigger LTM switching controlled by the network, and/or trigger LTM switching locally at the WTRU 102. These examples may be used to create additional events jointly over radio measurement and non-radio measurement quantities. For example, the additional events may identify a target scenario in a very precise manner and/or allow a WTRU 102 to choose the most suitable candidate in intra-DU, inter-DU, and/or inter-CU scenarios.

In certain representative embodiments, the (e.g., new or additional) events may be defined over a set of non-radio measurement quantities. For example, this may be advantageous in cases where the environment is controlled, and/or the network may have thorough knowledge of the wireless environment in terms of terrain, buildings, and/or other objects.

In the examples of joint events, the events LTM-A3 and LTM-A4 may be combined with non-radio measurement quantities (e.g., combing device orientation, distance, and/or zone identity).

In an example, the event LTM-A5 may be combined with non-radio measurement quantities.

For example, the joint events LTM-J1, LTM-J2, LTM-J3 and LTM-J4 may be further combined with a speed and/or velocity condition (e.g., as used in event LTM-V1) to segregate high speed and low speed scenarios and trigger suitable action according to a given scenario.

For devices with heavy rotational mobility, the event LTM-R1 or event LTM-O1 may be combined with radio measurement quantity events (e.g., LTM-A3, LTM-A4 and/or LTM-A5) to create rotation focused conditional LTM events which may be used to trigger suitable actions leading to reporting, reporting updates, and/or monitoring updates.

In certain representative embodiments, joint events may be used where the execution conditions are set over a combination of legacy L3 measurement quantities and the LTM measurement quantities described herein.

In certain representative embodiments, WLAN, Bluetooth, and/or other RAT based events and/or conditions may be used (e.g., added). Such events and/or conditions may be defined where the network operator may have knowledge of the (e.g., public) deployment of such access points. For example, any of WLAN, Bluetooth, and/or other RAT based measurements may be combined with other radio and non-radio quantities to derive additional (e.g., further refined) joint events to the examples described above.

### UE Capability for Joint Radio and Non-Radio Measurements Based LTM Mobility

In certain representative embodiments, LTM mobility configurations and subsequent monitoring may require additional tracking at the WTRU 102 for the cells and/or beams which may be potential targets for LTM mobility, such as whether in the activated or deactivated states. LTM mobility features may require additional (e.g., new) WTRU 102 capabilities in terms of receiving and maintaining LTM configurations, handling LTM switches to intra-DU and inter-DU candidates, and/or to monitor and report LTM measurements.

With dense deployment of network access points (e.g., TRPs) and beam based transmission, with reference to LTM features and devices changing cells and/or beams more frequently than legacy systems, the number of measurements at different cells and/or beams may increase for WTRU 102s. A WTRU 102 may (e.g., need to) make measurements on serving cells, the cells configured for LTM mobility, different levels of measurements for activated LTM cells as compared to deactivated LTM cells, in addition to all the measurements required for channel state information and MIMO, and/or the higher layer measurements for legacy cell change procedures. In certain representative embodiments, LTM measurements may be intra-cell or inter-cell, such as where inter-cell measurements may be on different frequencies in a same frequency band or in different frequency bands.

With beam based transmissions, a WTRU 102 may need measurement gaps, such as with inter-frequency measurements. A WTRU 102 may (e.g., need to) apply suitable beamforming, that is the WTRU 102 may need to receive the signals having different QCL relations, and the WTRU 102 may not be capable of receiving (e.g., even) intra-frequency signals from different QCL relations at a same time. A WTRU 102 may need suitable measurement gaps to apply appropriate QCL relations and make measurements. For example, measurement gaps may potentially be larger than (e.g., just) the measurement time, such as to incorporate beam switching timings.

In certain representative embodiments, intra-frequency LTM Measurements may be distributed over any of: activated cells in a L1/L2 mobility configured set; deactivated cells in a L1/L2 mobility configured set; and/or current serving cells which are L1/L2 mobility candidates for PsCell.

In certain representative embodiments, inter-frequency LTM Measurements may be distributed over any of: activated cells in a L1/L2 mobility configured set; deactivated cells in a L1/L2 mobility configured set; and/or current serving cells which are L1/L2 mobility candidates for PsCell.

In certain representative embodiments, a minimal WTRU 102 capability may be defined in terms of intra-frequency and/or inter-frequency LTM measurements that WTRU 102s must support to have a LTM feature enabled and/or activated.

In certain representative embodiments, for more capable WTRU 102s, an additional capability may be defined (e.g., used) for any WTRU 102s which are capable of supporting larger numbers of intra-frequency and/or inter-frequency LTM measurements than the minimal WTRU 102 capability for LTM measurements.

In certain representative embodiments, any WTRU 102s having multiple antenna panels may be able to support and measure larger numbers of intra-frequency and/or intra-frequency LTM measurements. For example, these WTRU 102s may need fewer interruptions to make LTM measurements related to intra- and/or inter-frequency LTM measurements when they are able to use their unused panels for making these measurements. For example, one capability may be defined for WTRU 102s having multiple antenna panels to specify their supported number of LTM intra-frequency measurements and/or inter-frequency measurements and/or detailed information as to which of these may (e.g., can) be measured without measurement gaps. For example, a LTM measurement capability for a multi-panel WTRU 102 may increase the number of supported measurements (e.g., in direct proportion to the number of antenna panels implemented). For example, the number of supported measurements may be defined explicitly for multi panel WTRU 102s. For example, a table may specify (e.g., indicate) the number of supported intra-frequency and/or inter-frequency LTM measurements for 2 panel WTRU 102s, another table for 4 panel WTRU 102s, and/or another panel for 8 panel WTRU 102s. For example, a table may specify (e.g., indicate) the supported measurements for different numbers of panels a WTRU 102 may be (e.g., potentially) equipped with.

In certain representative embodiments, the measurements over radio and non-radio quantities and joint events may enable WTRU 102 autonomous handling of lower layer triggered mobility. In certain representative embodiments, the measurements over radio and non-radio quantities and joint events may enable WTRU 102 autonomous handling of other procedures than LTM mobility.

For example, WTRU 102 controlled mobility handling may include any of activation, deactivation, switching, and/or execution to a target mobility candidate. This autonomous handling of mobility may result in a WTRU 102 self-managing activation and/or deactivation of suitable mobility configurations and performing switching to a suitable LTM configuration, such as when network configured conditions are fulfilled. In addition to the 3GPP radio signal based capabilities, a WTRU 102 may (e.g., need to) inform the network about its capabilities related to non-3GPP radio signals, local sensors and/or other interfaces that can or are available to be used for joint radio and non-radio measurements based LTM procedures. A WTRU 102 may provide capability information to the network and based upon this knowledge, the network may choose a suitable set of joint radio and non-radio measurement quantities as part of LTM measurements and configurations. For example, a WTRU 102 may provide a source of these non-3GPP RATs, local sensors and/or other interfaces, and/or other relevant parameters, such as availability and/or accuracy levels, to help the network choose the suitable set of quantities to be used in joint radio and non-radio measurements based LTM procedures.

### Configuration for WTRU 102 Controlled Activation and Execution of LTM Candidate Configurations

### UE Controlled Activation and Deactivation

In certain representative embodiments, a WTRU 102 may select a suitable LTM configuration for execution. The WTRU 102 may (e.g., also) activate a suitable set of configured LTM configurations locally, such as per the network configuration. This may provide an advantage for reducing the latency for activating certain cell configurations when they are becoming potential candidates for LTM switching. One advantage for WTRU 102 controlled deactivation (e.g., if supported) is fast deactivation for reducing the monitoring overhead. In addition to this, the WTRU 102 controlled activation may lead to resource savings resulting in spectrum efficiency improvements.

In certain representative embodiments, as part of a configuration for a WTRU 102 controlled LTM procedure, the network may provide the conditions under which the WTRU 102 may (e.g., will) activate or enable a given LTM candidate configuration. For example, a WTRU 102 may activate the most suitable set of candidate configurations relevant for the non-radio measurement values obtained at the WTRU 102 (e.g., WTRU 102 location, position and/or orientation).

For example, the conditions to activate a candidate configuration may be specified (e.g., jointly) over radio and/or non-radio measurement quantities as described herein. For example, one or more events may be specified (e.g., along with one or more suitable threshold values) under which a WTRU 102 may (e.g., will) activate a given candidate LTM configuration. The network configuration may provide the association of one or more LTM candidate configurations and one or more events which trigger the activation of the (e.g., respective) candidate configurations.

For example, a LTM configuration may provide (e.g., include) the conditions under which candidate configurations may be deactivated (e.g., as a candidate configuration may not be a suitable target anymore). When a WTRU 102 is under mobility, the change of its geographic zone, derived from the non-radio measurements, such as location, position, and/or orientation, may cause one or more candidate configurations to become outdated (e.g., unsuitable) as potential targets as they may not be covering the neighboring zones. For example, where multiple configurations are kept in the activated state, a very large overhead for maintenance, monitoring, evaluation may be incurred. The network may configure the WTRU 102 to deactivate one or more ACTIVATED LTM configurations when certain conditions are fulfilled. For example, deactivation conditions may be specified (e.g., like the activation conditions) as part of the configuration. In an example, the information of WTRU 102 zone derived from non-radio measurements and coverage information may be used to deactivate an ACTIVATED configuration(s). As an example condition, the condition can specify one or more zones where a candidate configuration may (e.g., should) be activated and based on the WTRU 102 moving out of the zone(s), the WTRU 102 may (e.g., will) deactivate the associated candidate configuration(s).

### UE Controlled Execution

In certain representative embodiments, as part of the configuration for WTRU 102 controlled LTM procedure, the network may provide one or more conditions under which the WTRU 102 may (e.g., will) select a given LTM candidate configuration for switching.

For example, one or more conditions to execute WTRU 102 controlled LTM switching to a target candidate configuration may be specified jointly over radio and non-radio measurement quantities as described herein. One or more events may be specified (e.g., along with one or more suitable threshold values) under which the WTRU 102 may (e.g., will) select a given candidate LTM configuration. The network configuration may provide the association of one or more LTM candidate configurations and one or more events which trigger the selection of the (e.g., respective) candidate configurations for WTRU 102 controlled LTM based switching.

### Condition Design

In certain representative embodiments, the network may provide one or more conditions and/or triggers (e.g., solely) based upon non-radio measurement quantities to activate an LTM candidate configuration. This may be useful to contain the measurement overhead for a WTRU 102.

In certain representative embodiments, one set of conditions and/or events jointly over radio and non-radio measurement quantities may be provided to activate an LTM candidate configuration. Another set of conditions and/or events may be provided for selection and/or execution of an LTM candidate configuration.

In certain representative embodiments, one (e.g., only one) set of conditions and/or events may be set for activation, selection, and/or execution of an LTM candidate configuration. For example, different threshold values may be associated to activation purposes and selection and/or execution purposes.

In certain representative embodiments, the (de-)activation and/or execution conditions and/or triggers (e.g., LTM conditions) may be specified as part of the measurement identities. For example, the measurement identities may be linked to LTM candidate configurations. For example, the measurement identities (e.g., defining condition(s) and/or trigger(s) may be included as added (e.g., new) elements of a cell configuration. As an example, a candidate LTM configuration may include an information element “LTM_Activation” which provides the measurement identities which may define or be associated with activation conditions and/or events. For example, an (e.g., new) information element “LTM_Deactivation” may provide the identities defining deactivation conditions and/or events. For example, these two information elements may be combined as a single information element to provide (e.g., indicate) the measurement identities providing conditions and/or events triggering the activation and deactivation. For example, another information element may provide (e.g., indicate) the switching and/or execution conditions for an LTM candidate configuration.

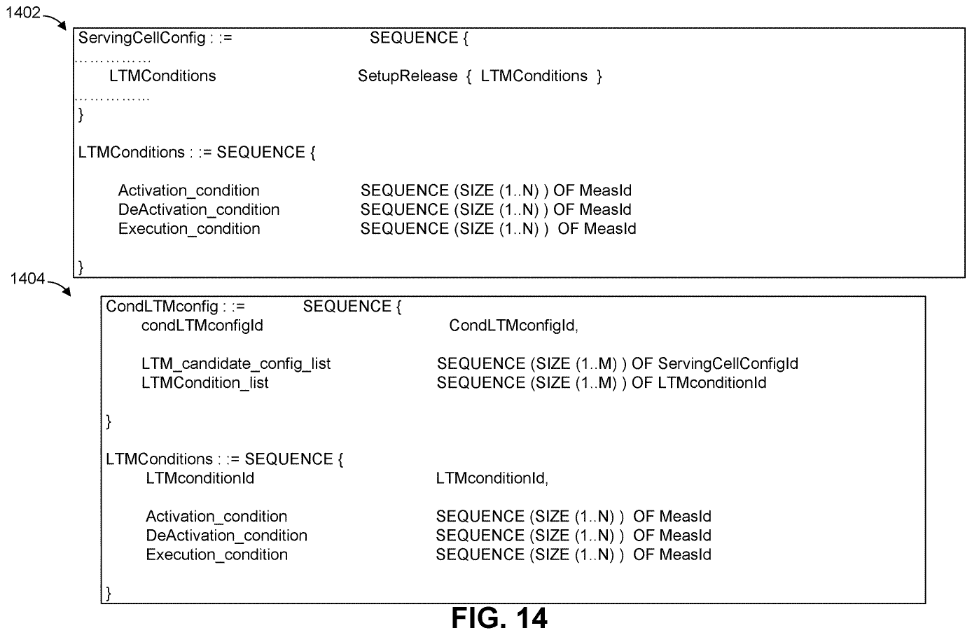

FIG. 14 is a syntax diagram illustrating examples of information elements which provide association of measurement identities with activation, deactivation and execution conditions. In FIG. 14, a ServingCellConfig 1402 may include LTM conditions as described above. In FIG. 14, a CondLTMconfig1404 may include LTM conditions as described above.

In FIG. 14, the “servingCellConfiguration” 1402 may be enhanced with a structure providing LTM relevant activation, deactivation, and switching/execution conditions. As an example, a structure “LTM_config” may be added in the “servingCellConfiguration” 1402. “LTM_config” may then include information elements which provide indications of (e.g., pointers to) measurement identities carrying conditions and/or events for activation, deactivation and switching/execution purposes. Although the example shown has separate information elements shown for activation, deactivation and execution, the conditions for these sub-procedures (activation, deactivation and execution) may be defined over a single set of common measurement identities.

In FIG. 14, a (e.g., top) level information element “CondLTMconfig” 1404 may be provided as part of a RRC configuration for the LTM procedure. “CondLTMconfig” 1404 may provide a list of LTM candidate configurations and a list of LTM conditions. The suitable LTM conditions for the first element of the LTM_candidate_config_list may be provided in the first element of LTMCondition_list and so on. The conditions may be be specified separately for activation, deactivation and execution as shown. In an example, the conditions may be specified under a common set of measurement configuration identities. For example, up to N conditions may be specified for each candidate configuration.

### Joint Radio and Non-Radio Measurements Based WTRU 102 Controlled LTM-Execution Phase

In certain representative embodiments, an execution phase for joint radio and non-radio measurements based WTRU 102 controlled LTM procedure may include the WTRU 102 monitoring the active candidate LTM configurations for the configured radio and non-radio measurement quantities. Based on triggering of the events configured by the network over these quantities, the WTRU 102 may perform cell switching to a target candidate configuration. The WTRU 102 controlled activation of the suitable candidate configurations may be based on a change in location and/or other radio quantities. The activation and the LTM cell switching procedures described herein may be solely controlled by the WTRU 102 itself according to the network configuration. For example, a suitable network configuration may allow the WTRU 102 to select the suitable LTM candidate configurations, activate them, monitor the activated candidates and perform a cell switch locally without active network intervention and/or without any message exchanges with the network (e.g., prior to performing the cell switch). This may result in significant benefits in terms of latency and overhead reduction for mobility procedures.

### UE Controlled Activation and Deactivation for LTM Candidate Configurations

In certain representative embodiments, once configured, a WTRU 102 may (e.g., will) start to monitor the configured measurement quantities relevant to the conditions and events set to activate a candidate LTM configuration which is in the deactivated state. To minimize the WTRU 102 overhead to monitor configured and deactivated LTM configurations, the network may set the activation conditions (e.g., solely) over non-radio measurement quantities or in a manner such that there is a condition over non-radio measurement quantities that is easy to measure and evaluate without large overhead. For example, an activation condition may be the event LTM-CM1 or LTM-CM2 where exiting or entering a specific zone will lead to activation of a candidate LTM configuration. Given the knowledge of the deployment, the network may know when a given cell and/or beam is a potential target and hence needs to be monitored (e.g., in a more active manner) prior to becoming usable as a target LTM candidate.

For example, a LTM configuration may provide one or more conditions under which candidate configurations may be deactivated as they may not be suitable targets anymore. The deactivation conditions may be specified (e.g., like the activation conditions) as part of the configuration. For the deactivation conditions, the conditions and/or events may be set jointly over radio and non-radio measurement quantities. As deactivation happens for configurations which are already ACTIVATED (e.g., and being monitored closely), there may little to no additional overhead for making measurements for deactivation checking purposes.

In certain representative embodiments, a WTRU 102 may be configured to provide an indication to the network when the WTRU 102 updates the (de-)activation status of one or more of the candidate configurations. For example, an indication may be transmitted by (e.g., explicitly) providing the candidate configuration identity (ID) of the candidate undergoing a status change to the network. For example, the WTRU 102 may provide the identities of currently activated LTM configurations. For example, the signaling can be explicit identity based (e.g., a list) or in a bitmap format (e.g., to save overhead).

For example, activation status information may be transferred as (e.g., sent as part of) a MAC-CE. For example, a (e.g., short) MAC-CE may be used which (e.g., only) provides the relevant identities of the configurations for which the WTRU 102 changed the (de-)activation status. For example, a MAC-CE may be used which can provide the identities of any (e.g., all) of the currently activated candidates, such as in a bitmap format. For example, an (e.g., extended) MAC-CE may be used which provides the identities of all the configured LTM candidates along with their activation statuses and/or deactivation statuses.

For example, information indicating any (e.g., all) of the (de-)activation statuses (e.g., updates) may be provided to the network as part of the RRC signaling.

For example, a (de-)activation status update may be provided to the network in PHY based signaling. For example, information indicating the identity of any (de-)activated LTM candidate configurations may be included as part of the uplink control information (UCI) and/or may be transmitted over PUCCH.

### UE Controlled LTM Target Selection and Switching/Execution

In certain representative embodiments, once the network configuration is complete for a WTRU 102 controlled LTM procedure, the WTRU 102 may (e.g., will) start to monitor the configured radio and non-radio measurement quantities for the activated LTM configurations. The network can indicate a set of LTM configurations as ACTIVATED as part of the LTM configuration. The network configuration can be without ACTIVATING the LTM candidates, and in that case, the WTRU 102 may (e.g., will) monitor and evaluate the activation conditions for the configured candidates and activate suitable LTM candidate configurations.

According to the LTM procedure, the WTRU 102 may (e.g., will continue to) actively monitor and evaluate the radio and non-radio measurements configured for the ACTIVATED LTM configurations. Once the joint events configured over radio and non-radio measurement quantities for at least one of the ACTIVATED LTM configuration is fulfilled, the WTRU 102 may (e.g., will) select that LTM candidate configuration as the target configuration for the LTM switching.

### UE Configuration Activation to LTM Switching Restrictions

In certain representative embodiments, for the WTRU 102 controlled LTM procedures, the WTRU 102 may locally activate the configured LTM candidate configurations when the specified activation conditions are fulfilled. The network may configure the WTRU 102 to report an indication of a newly activated configuration. For example, the network configuration may restrict that a WTRU 102 may not perform local LTM switching for an LTM configuration for which the activation status has not been reported to the network. For example, the WTRU 102 controlled LTM switching may be restricted for any configurations that the network has not acknowledged the activation indication. For example, another complementary or additional restriction may be specified as part of the configuration, such as where a minimum time duration is specified for which a configuration must be in activated state at WTRU 102 prior to WTRU 102 performing LTM switching to this configuration.

### Configuration Selection to LTM Switching Delay

In certain representative embodiments, for the WTRU 102 controlled LTM procedures, the WTRU 102 may select and execute the mobility switching procedure locally without network intervention. The network configuration may specify a maximum delay within which a given WTRU 102 will switch from a serving cell (e.g., a serving cell or primary cell of any of its cell groups) to the selected LTM target cell once the configured execution conditions and/or events get fulfilled and/or triggered.

### QCL Relation

In certain representative embodiments, cell switching to a LTM target configuration may involve switching the WTRU 102 transmit and/or receive beams. The WTRU 102 may be configured to derive QCL relations from the configured measurements and the quantities in the event conditions. The WTRU 102 may be configured to use the beams whose measurements are used to evaluate the selection and/or execution conditions. For example, the beams may include SSB and/or CSI-RS beams. For example, the WTRU 102 may be restricted (e.g., by the network) to use an SSB beam to initiate data transmission and/or reception upon a cell switch to a target configuration. For example, where the conditions are set against cell level measurements, the WTRU 102 may be configured to use the suitable (e.g., measured) beam as the beam of interest which it uses to derive the QCL relations. For example, the beam of interest may be a strongest beam among the measured beams which the WTRU 102 has used to derive the cell level quantities.

As part of the LTM procedure, a WTRU 102 may be configured to provide a measurement report to the network when the WTRU 102 selects a candidate LTM configuration. For example, a LTM reporting configuration may provide the necessary parameters to report the LTM measurements to the network. A measurement report may include the radio measurement quantities and non-radio measurement quantities configured as part of the LTM measurement configurations.

In certain representative embodiments, a LTM reporting configuration may be configured such that LTM measurements are reported as part of UCI. For example, LTM measurements are reported over PUCCH and/or PUSCH as specified in a LTM reporting configuration with suitable parameters and periodicities. For example, a measurement report may be transmitted as (e.g., in) a MAC CE with reported values and indication(s) of the measurement identity or identities.

In certain representative embodiments, a LTM reporting configuration may be configured for one or more quantities such that LTM measurements may be reported using RRC (e.g., as RRC messages). For example, use of RRC may be more suitable when latency is not an issue or concern.

In certain representative embodiments, a LTM reporting configuration may be provided as a hybrid reporting configuration. In a hybrid example, LTM measurements reporting may be configured partly as UCI transmitted over PUCCH and/or PUSCH (or used to trigger lower layer events) and partly reported over RRC messages. In a hybrid example, LTM reporting may be configured such that the reporting takes place over RRC when certain conditions are fulfilled. If these conditions are not fulfilled, the WTRU 102 may (e.g., then) start to report LTM measurements as part of UCI (e.g., via PUCCH and/or PUSCH).

### UE Data and Control Plane Handling Upon LTM Switching

In certain representative embodiments, when a WTRU 102 performs LTM switching to an LTM target candidate, the WTRU 102 applies the configuration of the LTM target candidate. Two primary use cases of LTM switching are when the LTM switching is performed to a target cell and/or beam candidate which is being served by a same DU (e.g., intra-DU switching) or being served by a different DU (e.g., inter-DU switching) compared to the cell (or beam) it replaces. As a function of intra-DU or inter-DU LTM switching, a WTRU 102 may need to handle the internal control and data plane entities, such as the MAC entity, RLC entity and PDCP in a different manner.

For an intra-DU LTM switch, a WTRU 102 may be configured to keep the MAC, RLC and PDCP entities unchanged (e.g., no resetting).

For an inter-DU LTM switch, a WTRU 102 may reset its MAC and RLC entities and create new MAC and RLC entities according to the configuration of the target LTM candidate. For the PDCP layer, the WTRU 102 may need to initiate data recovery, such as where RLC (e.g., buffered data) gets reset.

For example, the determination of behavior to apply for MAC, RLC and PDCP layers at an LTM switching event may be left for the WTRU 102 to decide, such as a function of whether an intra-DU or inter-DU LTM switching occurred. The WTRU 102 may derive the information of an LTM switch being intra-DU or inter-DU through the configuration of the serving cell and the candidate LTM configuration that is applied.

For example, each LTM configuration may provide indications whether MAC and/or RLC entities need to be reset or not, and if PDCP recovery is required, when the WTRU 102 performs LTM switching to the respective LTM configuration.

### UL Indication to the Network Upon LTM Switching and Timing Advance

In certain representative embodiments, when a WTRU 102 performs LTM switching to an LTM target candidate, the WTRU 102 may need to transmit an indication to the network so that both the WTRU 102 and the network have the same knowledge as to which cell and/or beam the WTRU 102 is performing the LTM switching for. The selection of an UL indication may be part of the LTM configuration. As an example, the configuration can specify whether the WTRU 102 will transmit RACH, or some specific PUCCH or some other signal on the target cell. For example, the mobility configuration may provide one single type of signaling and type of resource which should be used to provide the switching indication to the network. For example, each LTM candidate configuration may include the parameters (e.g., information) indicating how the WTRU 102 should provide a switching indication to the network if the WTRU 102 performs LTM switching to the respective LTM candidate configuration. For example, one candidate configuration may specify RACH transmission based indication upon switching, whereas another candidate configuration may specify a PUCCH based indication upon switching. For example, the indication information may be implicit as a function of other parameters of LTM target cell configuration and the nature of LTM switching (e.g., being intra-DU or inter-DU). These may include if, for example, the target cell is already a serving cell or an activated cell. For example, the LTM configuration may specify one type of signaling transmitted and/or a network indication for intra-DU switching scenarios, and another type of signaling and/or network indication to be transmitted for inter-DU switching scenarios. For example, the indication may be made robust by specifying a response from the network. The response from the network may be a custom acknowledgement or a simple signaling received over the resources of the new cell or beam to which the WTRU 102 has performed LTM switching. The acknowledgement response from the network may be a DCI (e.g., received over the CORESET and search space in the target cell). In the absence of the acknowledgement received from the network within a specified time, the WTRU 102 may be configured to repeat the uplink indication (e.g., through the same or a different signaling method). If there is no acknowledgement or signaling received from the network for the newly switched cell (e.g., either over the resources of the cell in question or through the primary cell of the cell group to which the cell belongs), the WTRU 102 may be configured to re-transmit the (e.g., same or different) indication. For example, when a configured number of indications have been transmitted without response, the WTRU 102 may be configured to initiate a legacy RACH procedure on the target cell.

### Timing Advance

In certain representative embodiments, a WTRU 102 may need to apply a suitable timing advance value when it performs LTM switching and transmits an indication to the network over the resources of the target cell it has switched to. The network may specify the timing advance value to be applied as part of the LTM cell configuration. For example, the timing advance value may be an absolute value which may represent the cell coverage. In another example, the timing advance value may be specified as a delta value against a suitable reference timing advance value. The reference timing advance value may be the WTRU 102's primary or secondary cell group timing advance value. In another example, the LTM mobility switching may need no timing advance application for WTRU 102 transmissions. As an example, if the deployment is for very small cells, the WTRU 102 may need to apply no timing advance. This may be known from the configuration or indicated explicitly. In another example of no timing advance, the target cell may have the same timing as of the current serving cell, potentially within the margin of the cyclic prefix. In other cases, the network may explicitly indicate the timing advance value that the WTRU 102 should apply while transmitting in the uplink direction to the target cell.

Once the WTRU 102 has applied the target LTM configuration, the WTRU 102 may (e.g., will) transmit an uplink indication to the network. The design details for uplink indications transmitted from the WTRU 102 to the network upon LTM switching are described as follows.

### PRACH Transmission Based Indication

In certain representative embodiments, a WTRU 102 may (e.g., will) perform a PRACH procedure to the LTM candidate cell and/or beam. A contention-free RACH configuration may be provided for LTM candidates (e.g., to speed up the RACH procedure). This may be especially helpful when there is a considerable timing advance difference and this type of signaling may let the network determine and provide the correct timing advance value to the WTRU 102 for the target cell.

### RACH Preamble Based Indication

In certain representative embodiments, a WTRU 102 may (e.g., will) perform the transmission of RACH preamble (e.g., only). The preamble identity and/or the resources may be assigned for the LTM candidate cell and/or beam. If the network has already provided the necessary cell configurations, and the timing advance is either zero or known to within cyclic prefix limits, the whole RACH procedure may not be necessary. For example, transmitting only the RACH preamble to the LTM target candidate may save transmission resources and speed up the reliable data communication over the selected target candidate. This latency saving may be very important for improving the latencies when cells and/or beams need to be switched in mobility procedures.

### Reference Signal Based Indication

In certain representative embodiments, a WTRU 102 may be configured to transmit one or more reference signals to the LTM target candidate cell and/or beam. For example, the reference signal can be one or more sounding reference signals (SRSs). The configuration parameters for the SRS transmission including sequence, power, and/or time-frequency resources may be provided to the WTRU 102 as part of the LTM configuration. The WTRU 102 may be configured to transmit one or more RSs based on an indication independent of a specific target LTM candidate. For example, the source cell may have already communicated and coordinated the SRS transmission possibility and relevant parameters to the LTM candidate that it configured to the WTRU 102. Here, the LTM target candidate may (e.g., will) recognize the transmission of the RSs (e.g., SRS) from the WTRU 102 and may register that this WTRU 102 has performed the LTM switch locally. For example, a RS based indication may have separate configuration parameters (e.g., sequence, resources, and/or timing) for different LTM candidate configurations.

### PUCCH Based Indication

In certain representative embodiments, a WTRU 102 may be configured to provide a switching indication with a PUCCH based transmission to the LTM target candidate upon LTM switching. The configuration of the PUCCH transmission (e.g., including PUCCH format assignment, sequence assignment and/or PUCCH time-frequency resources) may be specific to the target LTM candidate. Here, a configured PUCCH transmission may (e.g., will) indicate to the LTM target that the WTRU 102 has performed the LTM switch.

For example, a WTRU 102 may be configured to transmit a scheduling request (SR) to the LTM target candidate over the configured PUCCH resources. For example, the transmission may be restricted to short PUCCH (e.g., sequence based PUCCH format 0 transmission). For example, the PUCCH transmission may be a sequence based PUCCH transmission (e.g., with a configured set of parameters such as sequence, resources, and/or timing).

### Joint Radio and Non-Radio Measurement Quantities Based WTRU 102 Controlled LTM Procedure

In certain representative embodiments, a WTRU 102 may perform any (e.g., all) of the steps or actions below as part of a joint radio and non-radio measurement based LTM procedures. For example, the WTRU 102 may be assumed to start the LTM procedure from the RRC_Connected state.

For example, the WTRU 102 may send capability information associated with lower layer mobility/LTM handling and relevant assistance information. For example, the capability information may be accompanied with measurement reporting information associated with a set of radio and/or non-radio measurements. Along with LTM relevant capability information (e.g., in a suitable format), the WTRU 102 may also provide mobility assistance information to the network.

For example, the WTRU 102 may receive coverage and/or deployment topology information and/or the relevant configurations thereof.

For example, the WTRU 102 may receive LTM configuration information which may include one or more LTM configurations, one or more execution triggers over L1/L2 radio and/or non-radio measurement quantities, and/or one or more events serving to trigger target configuration selection and switching.

For example, the WTRU 102 may perform the configured radio and/or non-radio measurements, such as location and/or orientation information.

For example, the WTRU 102 may detect a change in radio and/or non-radio measurement quantities (e.g., based on the measurements thereof).

For example, the WTRU 102 may determine a (e.g., current) zone in the WTRU 102 is located based on the (e.g., non-radio) measurements.

For example, the WTRU 102 may determine one or more candidate cells and/or beams (e.g., which may be detectable) based on the (e.g., new) WTRU 102 location and/or position, such as based on the network coverage and/or deployment information.

For example, the WTRU 102 may determine one or more candidates (e.g., cells and/or beams) for which there is an activated LTM configuration.

For example, the WTRU 102 may make and evaluate (e.g., joint radio and non-radio) measurements according to the configured conditions for the LTM candidates.

For example, the WTRU 102 may select one of the LTM candidate configurations as a target for which configured joint events on the radio and non-radio measurements get triggered.

For example, the WTRU 102 may perform a (e.g., conditional) L1/L2 mobility switch to the selected target (e.g., LTM candidate configuration).

For example, the WTRU 102 may provide (e.g., send) information indicating the execution of the L1/L2 mobility switch. An indication may be provided according to network configured signaling (e.g., PRACH, RACH, RS, PUCCH transmission).

For example, the WTRU 102 perform protocol stack handling, such as may be configured as per the selected target (e.g., LTM candidate configuration).

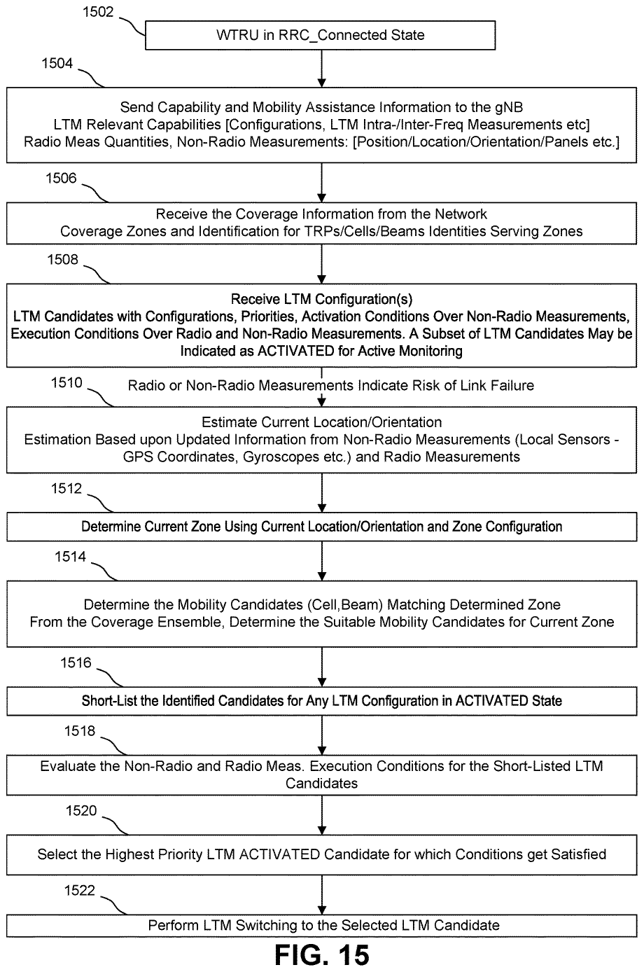

FIG. 15 is a procedural diagram illustrating an example of a WTRU 102 controlled lower layer mobility procedure using radio and non-radio measurements. In FIG. 15, various details for a conditional lower layer mobility procedure. For example, it may be assumed that the WTRU 102 starts the procedure from the RRC_Connected state at 1502.

In FIG. 15, the WTRU 102 may provide information indicating its capability to handle (e.g., different aspects) of lower layer mobility procedure at 1504. For example, the WTRU 102 capability may be grouped in suitable formats and/or which may be associated with different aspects of handling intra-DU, inter-DU configuration and mobility handling, a maximum number of configurations the WTRU 102 can be configured with, and/or a number of intra-frequency and/or inter-frequency measurements a WTRU 102 is capable of making. For example, other details of embodiments and examples related to WTRU 102 capability for LTM procedure are described herein. Along with LTM relevant capability in suitable format, the WTRU 102 may also provide mobility assistance information. Mobility assistance information may include (e.g., indicate) measurements and/or a capability to perform various non-radio measurements and/or non-3GPP measurements. The set of measurements (e.g., including legacy L3 measurement quantities) sent to the network may be used for preparation of suitable mobility configurations.

After receiving the capability and mobility assistance information, the network may provide coverage information to the WTRU 102 at 1506. The coverage information may include a snapshot of the network deployment in a proximity to the WTRU 102 location. The coverage information may be provided to the WTRU 102 with a suitable granularity according to the assistance information and the QoS and/or QoE requirements of the services that the WTRU 102 is using and/or intends to use. Various details of embodiment and examples on the coverage information configuration, contents and the signaling to provide such configuration are described herein.

In addition to the coverage configuration, the network may provide one or more lower layer mobility configurations (e.g., LTM configurations) to the WTRU 102 at 1508. A LTM configuration may include several candidate configurations. These configurations may be provided as serving cell configurations, cell group configurations and/or an RRC reconfiguration messages. In addition, these candidate configurations may be provided as individual configurations or as delta configurations against a suitable reference configuration. The suitable reference configuration may be configured to be the configurations of the serving cell or provided as a standalone configuration. Different configuration messages and styles for LTM target configurations are detailed in the various embodiments and examples described herein. A suitable subset of the LTM candidate configurations may be marked by the network in an ACTIVATED or ENABLED state whereas others may be treated as in a DEACTIVATED or DISABLED state. The WTRU 102 may monitor ACTIVATED candidates for potential LTM switching. The monitoring of a candidate configuration comprises of making the measurements and evaluating the conditions/events which are associated to that candidate configuration.

In FIG. 15, the network provides the event(s) and/or trigger(s) for the LTM candidate configurations. These events and triggers may be jointly defined over radio measurement quantities and non-radio measurement quantities. The lower layer LTM measurements framework, suitable radio and non-radio measurement quantities, filtering, events and suitable execution conditions are detailed in the various embodiments and examples described herein. After having received the suitable LTM configurations, the WTRU 102 may monitor the configured radio and non-radio measurement quantities in periodic, semi-persistent, aperiodic and/or event triggered fashion as per the received configurations.

When the WTRU 102 estimates degradation in the current serving link, such as where the degradation in link and/or beam quality is part of the configuration itself, the WTRU 102 may estimate its current location, position and/or orientation at 1510. There may be additional non-radio measurements configured either through local sensors at the WTRU 102 device and/or information received through different interfaces. The WTRU 102 may be configured to determine this information data in terms of location, position, and/or orientation periodically.

After determining the updated estimates of its non-radio measurements in terms of current location, position and/or orientation, the WTRU 102 may determine its current zone according to the network provided coverage information at 1512. The parameters and constants to derive the zone information as a function of non-radio measurements of one or more of position, location and/or orientation may be provided by the network as part of the coverage configuration.

The determination of current zone information according to the coverage map may be used by the WTRU 102 to determine the set of candidate cells and/or beams that may potentially serve the WTRU 102 in its current zone at 1514. Among the suitable coverage candidates from the coverage map, the WTRU 102 may short-list (e.g., determine) the cell and/or beam candidates for which it has LTM configurations in the ACTIVATED state at 1516.

For the determined ACTIVATED LTM configurations, the WTRU 102 may measure and evaluate the configured (e.g., joint) radio and non-radio measurement quantities and the configured conditions at 1518 to trigger a lower layer mobility switch.

If the execution conditions are satisfied for more than one candidate, the WTRU 102 may select a highest priority LTM configuration satisfying the execution conditions at 1520. The LTM configurations may be provided with an explicit priority identifier as part of the mobility configuration. In another example, the WTRU 102 may be configured to prioritize an LTM configuration which leads to an intra-DU LTM switch over an LTM configuration leading to an inter-DU LTM switch. In another example, the WTRU 102 may be configured with measurement quantities which it compares for the competing candidates and prioritizes a candidate with higher measurement values or higher margin over the configured thresholds. In another example, in cases where several LTM candidate configurations have execution conditions fulfilled, it may be up to WTRU 102 implementation to choose one candidate configuration to use to perform LTM switching.

After selecting the LTM candidate configuration to perform switching, the WTRU 102 will perform the LTM switching to the selected candidate at 1522. The switching may include local handling of MAC and RLC entities at the WTRU 102. In one example, an indication to perform a reset of MAC and/or RLC entities may be provided to the WTRU 102 explicitly as part of the LTM configuration candidates and the WTRU 102 may perform the reset of MAC and/or RLC entities as per the configuration of the selected LTM candidate. In another example, the WTRU 102 can derive such information based upon whether the LTM target candidate involves intra-DU switching or inter-DU switching and by performing the pre-configured MAC and/or RLC reset actions for each of the intra-DU or inter-DU switching scenarios. The details on MAC and/or RLC resets for different intra-DU and inter-DU scenarios are provided detailed in the various embodiments and examples described herein.

The WTRU 102 may provide the network with an indication of which LTM candidate is selected and switched to by the WTRU 102. For example, this may be necessary so that both the WTRU 102 and the network have a common view to communicate with each other after the LTM switching. The WTRU 102 may transmit an UL indication (e.g., on the switched-to target LTM candidate). The UL indication, relevant sequence selection and the selection of transmission resources where this indication is transmitted may be provided as part of the target LTM configuration itself. The UL indication subsequent to LTM switching are detailed in the various embodiments and examples described herein.

UE Controlled Radio and Non-Radio Events based Activation/Deactivation of LTM Candidate Configurations

In certain representative embodiments, WTRU 102 based activation and/or deactivation of LTM candidate configurations may be (e.g., significantly) beneficial in terms of latency reduction in having the suitable candidate configurations in ACTIVATED state for potential LTM switching. As part of the configuration, the network may provide the coverage topology information and also the parameters relevant to derive the WTRU 102 zone information. The network may (e.g., also) provide the measurement information which allows the WTRU 102 to derive its zone information. For example, zone information may be derived from location information which the WTRU 102 can obtain from local GNSS measurements. The WTRU 102 may obtain these measurements from a the local GNSS receiver. The location information may (e.g., also) be derived through other non-radio measurements. For example, the WTRU 102 may have a-priori informed the network about its capabilities in making non-3GPP radio and/or non-radio measurements.

For example, the network may provide the WTRU 102 with one or more LTM candidate configurations. The LTM candidate configuration may include any of a (e.g., respective) cell configuration and/or a (e.g., respective) measurement configuration. The WTRU 102 may (e.g., will) use the events and/or conditions over radio and/or non-radio measurements from the measurement configuration to evaluate the conditions and trigger LTM switching to the cell configuration. For example, any (e.g., each) LTM candidate configuration may (e.g., also) include joint radio and non-radio events and associated measurements which govern activation and/or deactivation of the respective candidate configuration. This may allow the network to make sure that suitable configurations get ACTIVATED by the WTRU 102 in a timely manner and without any overhead in terms of measurement reporting to the network and network commanded configuration regarding activation.

For example, the network may configure the WTRU 102 to periodically make radio and/or non-radio measurements which may be evaluated to activate and/or deactivate the candidate LTM configurations. For example, based on a subset of these periodic measurement estimates, the WTRU 102 may derive its zone information, such as per the coverage topology configuration. With each (e.g., new) set of configured measurements becoming available, the WTRU 102 may (e.g., will) evaluate the events which are configured with the configured LTM candidates for activation. The activation and/or deactivation of the candidate configurations may be governed by the evaluation of the configured events and conditions. With the results available from evaluation of all inequalities, making the activation/deactivation conditions and the events, the WTRU 102 may (e.g., will) proceed to activate and/or deactivate the candidate configurations. For example, the WTRU 102 may (e.g., will) deactivate any (e.g., all) of the candidate configurations in the ACTIVATED state for which respective deactivation events and/or conditions get fulfilled. For example, the WTRU 102 may (e.g., will) activate any (e.g., all) of the candidate configurations in the DEACTIVATED state for which respective activation events and/or conditions get fulfilled. For example, this may ensure that a (e.g., mobile) WTRU 102 will itself be capable of tracking and activating suitable candidate LTM configurations through joint radio and non-radio measurements. The ACTIVATED configurations may then be monitored by the WTRU 102 for the configured measurements and may then serve as a target configuration (e.g., after prioritization and/or selection). For example, this may be advantageous in terms of resource overhead and latency reduction. The measurements associated to the activation may be configured with suitable periodicity, such as to keep WTRU 102 overhead minimal. Timely deactivation may also be advantageous to keep WTRU 102 measurement overhead minimal for the ACTIVATED configurations.

For example, the WTRU 102 may be configured to provide a notification to the network associated with the ACTIVATED configurations. The WTRU 102 may be configured to send a MAC-CE where a suitable indication format may provide the information of the currently ACTIVATED (and/or DEACTIVATED) configurations. For example, one suitable format can be in the form of bitmap. The WTRU 102 may be configured to provide an indication of any (e.g., all) configurations which change their status from active to deactive and/or deactive to active. In another example, the WTRU 102 may provide an indication of all activated configurations whenever the WTRU 102 changes the state of some (e.g., one or more) of the configurations.

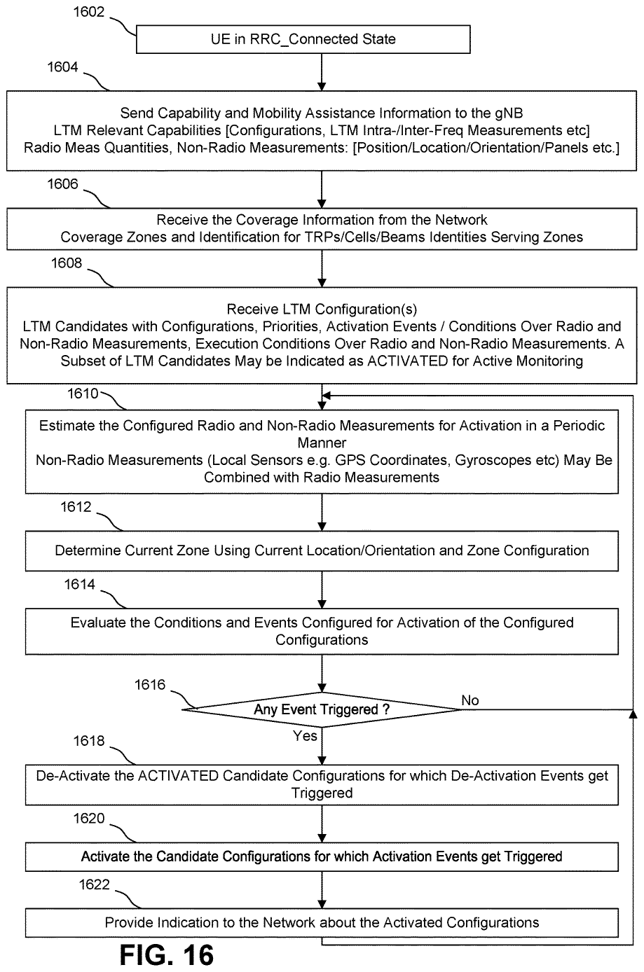

FIG. 16 is a procedural diagram illustrating an example procedure for WTRU 102 controlled non-radio measurement based activation of LTM configurations. In certain representative embodiments, a WTRU 102 may perform any (e.g., all) of the steps or actions below as part of a WTRU 102 controlled activation and/or deactivation procedure for one or more LTM candidate configurations. For example, the WTRU 102 may be assumed to start the LTM procedure from the RRC_Connected state at 1602.

As shown in FIG. 16, the WTRU 102 may provide information indicating its capability to handle (e.g., different aspects) of lower layer mobility procedure at 1604. For example, the WTRU 102 capability may indicate the WTRU 102 is able to support LTM procedure based upon joint radio and non-radio measurement quantities. Along with LTM relevant capability information (e.g., in a suitable format), the WTRU 102 may also provide mobility assistance information to the network.

For example, the WTRU 102 may receive coverage and deployment topologies and/or the relevant configurations related to zone determination at 1606.

For example, the WTRU 102 may receive one or more LTM configurations at 1608. The WTRU 102 may also receive LTM radio and non-radio measurement quantities and suitable joint events for LTM switching. Each LTM candidate configuration may include information indicating non-radio measurements and events governing its activation and deactivation. A subset of LTM configurations may be indicated as ACTIVATED by the network as part of the configuration and/or initialization.

For example, the WTRU 102 may perform any configured radio and non-radio measurements associated with any (e.g., each) of the ACTIVATED LTM configurations at 1610.

For example, the WTRU 102 may perform any configured non-radio measurements (e.g., necessary to evaluate configuration activation and/or deactivation of the LTM configurations) at 1610.

For example, the WTRU 102 may determine a (e.g., current) zone in which the WTRU 102 resides through non-radio measurements at 1612.

For example, the WTRU 102 may evaluate the events and conditions for activation and/or deactivation of configured LTM candidate configurations at 1614.

For example, the WTRU 102 may determine whether any conditions and/or events are triggered (e.g., get fulfilled) at 1616.

For example, the WTRU 102 may DEACTIVATE any (e.g., all) of the ACTIVATED candidate LTM configurations at 1618 for which deactivation conditions and/or events get fulfilled.

For example, the WTRU 102 may ACTIVATE any (e.g., all) of the DEACTIVATED LTM candidate configurations at 1620 for which activation conditions or events get fulfilled.

For example, the WTRU 102 may transmit at 1622 UL information indicating any (e.g., all) of the ACTIVATED LTM candidate configurations, such as per the network configuration.

### UE Controlled Zone Based Activation and Deactivation of LTM Candidate Configurations

In certain representative embodiments, a WTRU 102 may perform activation and/or deactivation of suitable LTM candidate configurations. WTRU 102 based activation and deactivation of network configured candidate configurations may be beneficial in terms of latency reduction in having suitable candidate configurations in ACTIVATED state for potential LTM switching. For example, a WTRU 102 may use zone information as at least part of the activation and/or deactivation of candidate configurations. For example, validation of candidate configurations candidate configurations may be achieved by using joint measurements over radio and non-radio signals.

For example, as part of the LTM configuration, the network may provide the coverage topology information. The network may also provide the parameters relevant to derive the WTRU 102 zone information. The network may also provide the measurements (e.g., configuration information) which allows the WTRU 102 to derive its zone information. The zone information may be derived from the location information which WTRU 102 can obtain from local GNSS measurements. For example, the WTRU 102 may obtain the measurements through a local GNSS receiver. The location information may (e.g., also) be derived through other non-radio measurements. The location and/or position information can be used as obtained solely or refined through 3GPP radio measurements with network assistance. For example, the WTRU 102 may have a-priori informed the network about its capabilities in making non-3GPP radio and non-radio measurements.

For example, the network may provide the WTRU 102 with LTM candidate configurations. The LTM candidate configuration may include any of a (e.g., respective) cell configuration, and/or a (e.g., respective) measurement configuration. The measurement configuration may specify the events and/or conditions set over radio and non-radio measurements which the WTRU 102 may evaluate. Upon triggering of these events, the WTRU 102 may trigger the LTM switching to the configured cell configuration.

For example, for WTRU 102 autonomous activation, a (e.g., each) LTM candidate configuration may include the conditions and/or events over radio and non-radio measurement quantities. The conditions and/or events may (e.g., each) be based on the WTRU 102 zone as a criterion. The radio and non-radio activation conditions and events may be associated with (e.g., as described for execution/switching purposes) with threshold values. Each candidate configuration may be configured with a list of active zones. The list of active zones may be a set of zones according to the topology configuration where the respective candidate configuration may be activated. This allows the network to make sure that suitable configurations get activated by the WTRU 102 in a suitable geographic area, in a timely manner, and/or with minimal overhead in terms of WTRU 102 measurements.

For example, a zone based condition (e.g., pre-condition) for configuration activation may be beneficial in terms of overhead reduction for configuration activation. This may allow the WTRU 102 to make minimal (e.g., low overhead) measurements related to zone determination and proceed to (e.g., only) make high overhead radio and non-radio measurements for suitable configured configurations which are currently deactivated.

For example, the network may configure the WTRU 102 to periodically estimate its location through configured measurements. Based upon these periodic estimates, the WTRU 102 may derive its zone information, such as per the coverage topology configuration. If a newly determined zone changes from a previous zone, the WTRU 102 may (e.g., will) deactivate the activated candidate configurations which don't have the determined zone in the list of active zones. The WTRU 102 may (e.g., will) activate the deactivated configured candidates which have the determined zone in the list of active zones and these candidates satisfy the accompanying radio and non-radio activation conditions. This may ensure that a (e.g., mobile) WTRU 102 will itself be capable of tracking its location and activating the suitable candidate configurations which can potentially serve as the target configuration. For example, this may be advantageous in terms of resource overhead and/or latency reduction.

For example, the WTRU 102 may (e.g., will) continue making the configured radio and non-radio measurements for the (e.g., most suitable) activated LTM configurations. This may prevent the WTRU 102 from making unnecessary measurements over the candidate configurations which are no longer suitable for its updated location. The WTRU 102 may be configured to provide a notification to the network about the ACTIVATED LTM configurations, such as when the WTRU 102 changes the activation status of at least one LTM configuration. The WTRU 102 may be configured to send, such as by using a MAC-CE, an indication in a format can provide the information of the currently ACTIVATED and/or DEACTIVATED configurations. One format may be in the form of a bitmap. The WTRU 102 may be configured to provide the indication of configurations which change their status from active to deactive and/or deactive to active. In another example, the WTRU 102 can provide an indication of all activated configurations whenever it changes the state of at least one of the configurations.

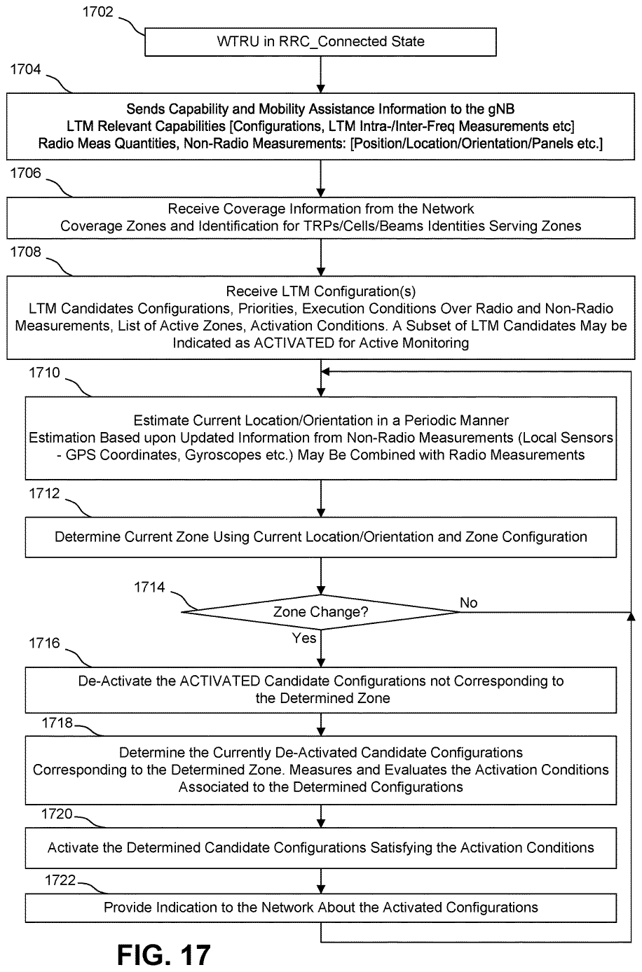

FIG. 17 is a procedural diagram illustrating an example procedure for WTRU 102 controlled zone based activation of LTM configurations.

In certain representative embodiments, a WTRU 102 may perform any (e.g., all) of the steps or actions below as part of a WTRU 102 controlled activation and/or deactivation procedure for one or more LTM candidate configurations using zone information. For example, the WTRU 102 may be assumed to start the LTM procedure from the RRC_Connected state at 1702.

As shown in FIG. 17, the WTRU 102 may provide information indicating its capability to handle (e.g., different aspects) of lower layer mobility procedure at 1704. For example, the WTRU 102 capability may indicate the WTRU 102 is able to support LTM procedure based upon joint radio and non-radio measurement quantities. Along with LTM relevant capability information (e.g., in a suitable format), the WTRU 102 may also provide mobility assistance information to the network.

For example, the WTRU 102 may receive coverage and deployment topologies and/or the relevant configurations related to zone determination at 1706.

For example, the WTRU 102 may receive one or more LTM Configurations at 1708. The WTRU 102 may also receive LTM radio and non-radio measurement quantities and suitable joint events for LTM switching. Each LTM candidate configuration may include information indicating a list of active zones where the WTRU 102 may (e.g., will) activate the respective configuration if the additional radio and non-radio activation conditions get fulfilled. A subset of LTM configurations may be indicated as ACTIVATED by the network as part of the configuration and/or initialization.

For example, the WTRU 102 may estimate its current location, position and/or orientation at 1710. There may be additional non-radio measurements configured either through local sensors at the WTRU 102 device and/or information received through different interfaces. The WTRU 102 may be configured to determine this information data in terms of location, position, and/or orientation periodically.

For example, the WTRU 102 may be configured with a set of additional (e.g., periodic) measurements, conditions, and/or events for configuration activation and/or deactivation. These measurements may be non-radio measurements, such as may be necessary to determine the WTRU 102 zone according to the coverage configuration.

For example, the WTRU 102 may perform any configured radio and non-radio measurements associated with any (e.g., each) of the ACTIVATED LTM configurations.

For example, the WTRU 102 may perform any configured non-radio measurements (e.g., necessary to evaluate configuration activation and/or deactivation of the LTM configurations).

For example, the WTRU 102 may determine a (e.g., current) zone in which the WTRU 102 resides through non-radio measurements at 1712.

For example, the WTRU 102 may determine the current zone in which the WTRU 102 resides has changed from a previously determined zone at 1714.

For example, the WTRU 102 may detect that a newly determined (e.g., current) zone is different from a previous zone, and the WTRU 102 may proceed to set to DEACTIVATED all the ACTIVATED candidate LTM configurations which do not have the newly determined zone in their list of active zones at 1716. The WTRU 102 may determine any configured LTM candidate configuration currently in the DEACTIVATED state which have the newly determined zone indicated in the list of active zones at 1718. For example, the WTRU 102 may measure and evaluate the respective activation conditions (e.g., if configured in addition to the zone information) for the determined candidate configurations set over the radio and non-radio measurements. For example, the WTRU 102 may set to ACTIVATED the determined candidate configurations for which radio and non-radio activation conditions and/or events get fulfilled at 1720. For example, the WTRU 102 may transmit UL information indicating any (e.g., all) of the ACTIVATED LTM candidate configurations, such as per the network configuration at 1722.

### UE Controlled LTM Switching Based Upon Joint Events on Radio and Non-Radio Quantities

In certain representative embodiments, a WTRU 102 may perform any (e.g., all) of the steps or actions below as part of a WTRU 102 controlled LTM switching decisions and execution. For example, the WTRU 102 may be assumed to start the LTM procedure from the RRC_Connected state.

For example, the WTRU 102 may provide information indicating its capability to handle (e.g., different aspects) of lower layer mobility procedure. For example, the WTRU 102 capability may indicate the WTRU 102 is able to support LTM procedure based upon joint radio and non-radio measurement quantities. Along with LTM relevant capability information (e.g., in a suitable format), the WTRU 102 may also provide mobility assistance information to the network.

For example, the WTRU 102 may receive coverage and deployment topologies and/or the relevant configurations related to zone determination.

For example, the WTRU 102 may receive one or more LTM configurations. The WTRU 102 may also receive LTM radio and non-radio measurement quantities and suitable joint events serving to trigger mobility switching. The network may indicate one or more joint events, such as LTM-J1 to LTM-J6, as part of the WTRU 102 controlled switching configuration to trigger the conditional switching.

For example, the WTRU 102 may perform any configured radio and non-radio measurements, such as according to the configured timing for the measurements and/or availability from local sensors.

For example, the WTRU 102 may determine a (e.g., current) zone in which the WTRU 102 resides through non-radio measurements.

For example, the WTRU 102 may evaluate the configured joint events with the conditions set over the measurements of radio and non-radio quantities.

For example, the WTRU 102 may determine that the one or more events associated with at least one of the ACTIVATED LTM configurations get triggered. The WTRU 102 may proceed to select one of the configurations as a target configuration (e.g., for which execution event/conditions get fulfilled). The selection may be based upon priority information indicated with LTM configurations, the intra-DU/inter-DU switching nature, and/or WTRU 102 implementation. The WTRU 102 may perform a LTM mobility switch to the target configuration. The WTRU 102 may perform MAC and/or RLC resetting and initiate PDCP data recovery. For example, the WTRU 102 may transmit UL information indicating the LTM mobility switch.

UE Controlled LTM Switching Based on Joint Events on Radio and Non-Radio Quantities with Differentiated Intra- and Inter-DU Handling

In certain representative embodiments, WTRU 102 controlled LTM switching may be performed with differentiated intra- and inter-DU handling.

For example, the network may provide one or more LTM configurations to the WTRU 102. The WTRU 102 may be provided with information indicating whether a candidate configuration is associated with intra-DU or inter-DU switching. For example, the network may provide for each LTM configuration candidate an identity referring to a certain DU. This can be a DU identity or another identity which (e.g., uniquely) identifies a DU. For example, any (e.g., all) the LTM configurations, whether provided individually from the network or against a reference configuration, may have DU identification information included therein. For example, the WTRU 102 may know the DU identity for the serving cell (configuration). This may allow the WTRU 102 to determine for each candidate configuration whether switching to the respective configuration from its current cell configuration involves intra-DU or inter-DU switching.

For example, the network may configure the WTRU 102 to perform a first set of actions for an intra-DU switching and perform a second (e.g., different) set of actions for an inter-DU switching. For example, the differentiated actions can include any of MAC and/or RLC resetting and/or PDCP data recovery procedures which may be configured to be performed if the WTRU 102 performs inter-DU switching. For an intra-DU switching, the network may configure the WTRU 102 to bypass the MAC and/or RLC resetting and/or PDCP data recovery. For example, a UL indication, that the WTRU 102 transmits to the network after LTM switching to a target configuration, may be configured to use a different signaling (e.g., type and/or format) if the LTM switching is to an intra-DU or inter-DU target configuration. As an example, an UL indication for intra-DU switching can be configured as a “slim” indication (e.g., PUCCH based signaling and/or transmission of SRS on a configured resource and/or a predetermined or special RS). The UL indication for inter-DU switching may be based upon RACH signaling (e.g., classic RACH procedure, or a slim RACH preamble only). For example, use of RACH signaling may be suitable for inter-DU switching as there may be a need to validate and (e.g., potentially) update the uplink timing advance for the WTRU 102.

For example, the WTRU 102 may be configured with differentiated handling for timing advances for intra- and inter-DU switching. As an example, the network may configure the WTRU 102 to keep a same timing advance value for a target cell for intra-DU switching. The network may indicate to apply a configured value of timing advance for a target configuration involving inter-DU switching. For example, timing advance values may be provided as delta values among different DUs. For example, where an UL indication after inter-DU switching is a RACH procedure or a signaling mechanism, the network may estimate the timing advance for inter-DU switching and may provide a (e.g., explicit) timing advance command to the WTRU 102.

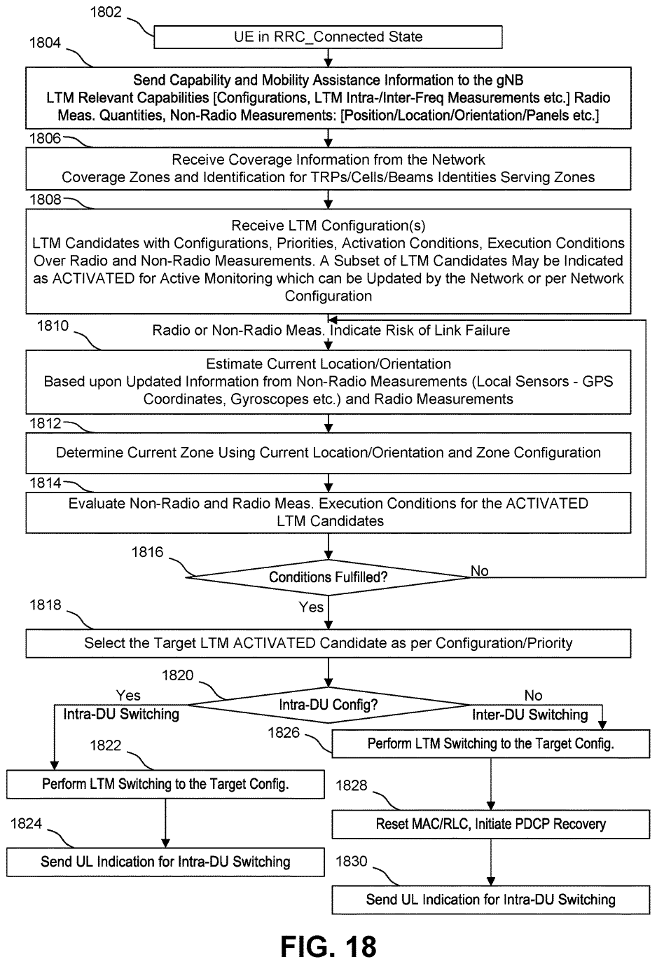

FIG. 18 is a procedural diagram illustrating a representative procedure for WTRU 102 controlled LTM with differentiated intra-DU and inter-DU handling.

In certain representative embodiments, a WTRU 102 may perform any (e.g., all) of the steps or actions below as part of a WTRU 102 controlled activation and/or deactivation procedure for one or more LTM candidate configurations. For example, the WTRU 102 may be assumed to start the LTM procedure from the RRC_Connected state at 1802.

As shown in FIG. 18, the WTRU 102 may provide information indicating its capability to handle (e.g., different aspects) of lower layer mobility procedure at 1804. For example, the WTRU 102 capability may indicate the WTRU 102 is able to support LTM procedure based upon joint radio and non-radio measurement quantities. Along with LTM relevant capability information (e.g., in a suitable format), the WTRU 102 may also provide mobility assistance information to the network.

For example, the WTRU 102 may receive coverage and deployment topologies and/or the relevant configurations related to zone determination at 1806.

For example, the WTRU 102 may receive one or more LTM configurations along with suitable joint events configured over radio and non-radio measurement quantities serving to trigger mobility switching at 1808. The network may indicate one or more joint events, such as LTM-J1 to LTM-J6, as part of the WTRU 102 controlled switching configurations to trigger the switching. Each LTM configuration may include identification information for intra- or inter-DU switching with respect to the DU of the serving cell.

For example, the WTRU 102 may perform any configured radio and non-radio measurements, such as according to the configured timing for the measurements and/or availability from local sensors.

When the WTRU 102 estimates degradation in the current serving link, such as where the degradation in link and/or beam quality is part of the configuration itself, the WTRU 102 may estimate its current location, position and/or orientation at 1810. There may be additional non-radio measurements configured either through local sensors at the WTRU 102 device and/or information received through different interfaces. The WTRU 102 may be configured to determine this information data in terms of location, position, and/or orientation periodically.

For example, the WTRU 102 may determine a (e.g., current) zone in which the WTRU 102 resides through non-radio measurements at 1812.

For example, the WTRU 102 may evaluate the configured joint events with the conditions set over the measurements of radio and non-radio quantities at 1814.

For example, at 1816, the WTRU 102 may determine whether the conditions and/or events associated to at least one of the ACTIVATED configurations are triggered.

For example, based on the conditions and events associated to at least one of the ACTIVATED configurations being triggered, the WTRU 102 may select one of the configurations for which the execution event and/or conditions get fulfilled at 1818. As an example, the selection may be based upon the intra-DU or inter-DU switching nature of the ACTIVATED configurations with the WTRU 102 (e.g., instructed to) prioritizing an (e.g., any) intra-DU configuration over an (e.g., any) inter-DU configuration.

For example, the WTRU 102 may determine whether the selected one of the configurations for which the execution event and/or conditions are fulfilled is an intra-DU configuration at 1820.

For example, where the switching to the target configuration results in intra-DU switching, the WTRU 102 may perform any of the following actions. The WTRU 102 may perform the LTM mobility switch to the target configuration at 1822, such as without any resetting of MAC and/or RLC layers. The WTRU 102 may send an UL indication, such as per the network configured signaling, indicating the intra-DU switching at 1824.

For example, where the switching to the target configuration results in inter-DU switching, the WTRU 102 may perform any of the following actions. The WTRU 102 may perform the LTM mobility switch to the target configuration at 1826. The WTRU 102 may perform resetting of the MAC and/or RLC layers and/or may initiate PDCP data recovery at 1828. The WTRU 102 may send an UL indication, such as per the network configured signaling, indicating the inter-DU switching at 1830.

### UE Controlled LTM Procedure Based on Radio Measurements

In certain representative embodiments, a WTRU 102 may perform any (e.g., all) of the steps or actions below as part of a WTRU 102 controlled activation and/or deactivation procedure for one or more LTM candidate configurations. For example, the WTRU 102 may be assumed to start the LTM procedure from the RRC_Connected state.

For example, the WTRU 102 may provide information indicating its capability to handle (e.g., different aspects) of lower layer mobility procedure. For example, the WTRU 102 capability may indicate the WTRU 102 is able to support LTM procedure based upon joint radio and non-radio measurement quantities. Along with LTM relevant capability information (e.g., in a suitable format), the WTRU 102 may also provide mobility assistance information to the network.

For example, the WTRU 102 may receive one or more LTM configurations. The WTRU 102 may also receive information indicating one or more execution triggers on L1/L2 radio measurement quantities and suitable lower layer events (e.g., as part of the LTM configurations).

For example, the WTRU 102 may perform the configured L1/L2 radio measurements.

For example, the WTRU 102 may detect a change in the radio measurement quantities.

For example, the WTRU 102 may determine the candidates for which it has LTM configurations.

For example, the WTRU 102 may make and evaluate measurements according to the configured conditions for the LTM candidates.

For example, the WTRU 102 may perform conditional L1/L2 mobility switching to a LTM target configuration after the configured events get triggered (e.g., on lower layers).

For example, the WTRU 102 may perform a LTM mobility switch to the target configuration.

For example, the WTRU 102 may perform MAC and/or RLC resetting and/or initiate PDCP data recovery, such as by using the information received with selected LTM candidate.

For example, the WTRU 102 may transmit an UL indication, such as per the network configuration signaling for WTRU 102 controlled switching.

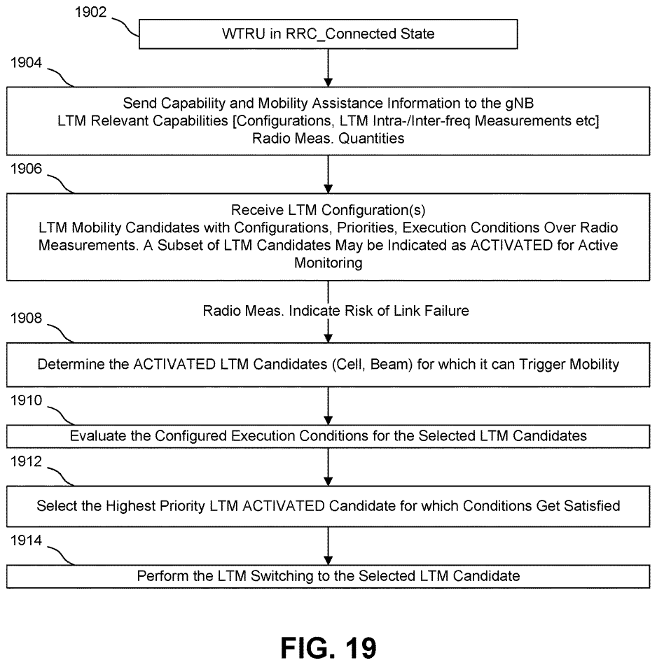

FIG. 19 is a procedural diagram illustrating an example procedure for conditional LTM mobility using radio measurements. For example, the WTRU 102 may be assumed to start the LTM procedure from the RRC_Connected state in FIG. 19.

In certain representative embodiments, a conditional LTM mobility procedure may include the WTRU 102 providing its capability information to the network at 1904. For example, the capability information may relate to the WTRU 102 capability to handle different aspects of lower layer mobility procedures. Along with LTM relevant capability information (e.g., in a suitable format), the WTRU 102 may also provide mobility assistance information to the network at 1904. This information can comprise of suitable measurements and the capability to perform various measurements.

After receiving the capability and mobility assistance information, the network provides one or more lower layer mobility configurations to the WTRU 102 at 1906. A lower layer mobility configuration (e.g., LTM configuration) may include one or more candidate configurations. A suitable subset of the LTM candidate configurations may be marked by the network in an ACTIVATED or ENABLED state whereas others may be treated as in a DEACTIVATED or DISABLED state. The WTRU 102 may (e.g., will) monitor the ACTIVATED candidates for potential LTM switching.

In certain representative embodiments, the lower layer mobility decision and switching may be performed autonomously by the WTRU 102 based upon lower layer events and trigger(s) which are set over radio measurement quantities. For example, when the WTRU 102 detects degradation in the current serving link, such as where the detection of degradation in a link and/or beam quality is part of the configuration itself according to the suitable configured thresholds, the WTRU 102 may determine the cell and/or beam candidates for which it has LTM configurations in the ACTIVATED state at 1908. For the determined ACTIVATED LTM configurations, the WTRU 102 may (e.g., will) measure and evaluate the configured measurement quantities and the configured conditions at 1910 to trigger the lower layer mobility switch.

For example, in cases where the execution conditions get satisfied for more than one of the candidates, the WTRU 102 may select one of them as the target LTM configuration, such as according to a configured priority, intra-DU switching priority and/or one or more other configured criterion, at 1912. After selecting a LTM candidate configuration to perform switching, the WTRU 102 may perform the LTM switching to the selected candidate at 1914. The switching may include local handling of MAC and/or RLC entity resetting and a PDCP date recovery procedure initiated and performed at the WTRU 102. For example, an indication to perform the resetting of MAC and/or RLC entities and/or PDCP data recovery can be provided to the WTRU 102 (e.g., explicitly) as part of the LTM configuration candidates, or may be based upon intra- or inter-DU switching.

After performing the LTM switch at 1914, the WTRU 102 may transmit an indication to the network over the target candidate. For example, an UL indication may be sent to that network so that both the WTRU 102 and the network have a common view to communicate with each other after the LTM switching occurs at the WTRU 102. The WTRU 102 may transmit an UL indication on the selected LTM candidate. The transmission of the UL indication, such as sequence selection and transmission resource selection (e.g., where this indication is transmitted) may be provided as part of the selected LTM configuration itself.

### UE Controlled Zone Based Activation and LTM Switching Based on Joint Events on Radio and Non-Radio Measurements

In certain representative embodiments, a WTRU 102 may perform any (e.g., all) of the steps or actions below as part of a WTRU 102 controlled zone based activation and LTM switching procedure based on joint events over radio and non-radio measurements. For example, the WTRU 102 may be assumed to start the LTM procedure from the RRC_Connected state.

In certain representative embodiments, the WTRU 102 controlled zone based activation and LTM switching procedure may be a combination of two procedures: (i) WTRU 102 controlled activation and deactivation of LTM configurations (e.g., based upon the configured list of active zones with each configuration along with other activation conditions) and (ii) WTRU 102 controlled LTM switching (e.g., based upon joint events on radio and non-radio measurement quantities).

### Preparation Phase—Configuration for Activation and LTM Switching

In certain representative embodiments, a WTRU 102 may provide information indicating its capability to handle (e.g., different aspects) of lower layer mobility procedure. For example, the WTRU 102 capability may indicate the WTRU 102 is able to support LTM procedure based upon joint radio and non-radio measurement quantities. Along with LTM relevant capability information (e.g., in a suitable format), the WTRU 102 may also provide mobility assistance information to the network.

For example, the WTRU 102 may receive coverage and deployment topologies and/or the relevant configurations related to zone determination.

For example, the WTRU 102 may receive one or more LTM configurations. The WTRU 102 may also receive LTM radio and non-radio measurement quantities and suitable joint events for LTM switching. A (e.g., each) LTM candidate configuration may include information indicating a list of active zones where WTRU 102 may (e.g., will) activate the respective configuration when (e.g., additional) activation conditions specified over radio and non-radio measurements get satisfied. For example, a subset of LTM configurations may be indicated as ACTIVATED (or DEACTIVATED) by the network as part of the configuration and/or initialization.

### Execution Phase—Configuration Activation

In certain representative embodiments, a WTRU 102 may perform a set of actions to activate a configured LTM candidate configuration (e.g., in the DEACTIVATED state). For example, a WTRU 102 may perform configured non-radio measurements (e.g., indicated for activation purposes). For example, the non-radio measurements may be associated with the determination of zone information.

For example, the WTRU 102 may determine a (e.g., current) zone in which the WTRU 102 resides through non-radio measurements. Based on the newly determined zone being different from a previously determined zone, the WTRU 102 may determine any configured LTM candidate configurations currently in the DEACTIVATED state which have the newly determined zone indicated in the list of active zones. The WTRU 102 may measure and evaluate any activation conditions (e.g., if configured in addition to the zone information) for the determined candidate configurations set over radio and non-radio measurements. The WTRU 102 may activate the determined candidate configurations (e.g., set in the ACTIVATED state) for which any radio and non-radio activation conditions and/or events get fulfilled.

For example, the WTRU 102 may be configured and/or conditioned to make additional activation measurements for a limited set of deactivated candidate configurations satisfying the zone based condition for activation. This may help limit the overhead related to the activation of LTM configurations.

### Execution Phase—Configuration Deactivation

In certain representative embodiments, a WTRU 102 may perform a set of actions to deactivate a configured LTM candidate configuration (e.g., in the ACTIVATED state). For example, a WTRU 102 may perform configured non-radio measurements (e.g., indicated for deactivation purposes). For example, the non-radio measurements may be associated with the determination of zone information.

For example, the WTRU 102 may determine a (e.g., current) zone in which the WTRU 102 resides through non-radio measurements. Based on the newly determined zone being different from a previously determined zone, the WTRU 102 may deactivate any (e.g., all) the ACTIVATED candidate LTM configurations which do not have the newly determined zone in their list of active zones.

Based on the newly determined zone being the same as the previously determined zone, the WTRU 102 may measure the additional radio and non-radio measurement quantities necessary to evaluate the deactivation conditions for the ACTIVATED candidate LTM configurations (e.g., if not available through the measurements made for ACTIVATED configurations as part of monitoring). The WTRU 102 may deactivate any (e.g., all) the ACTIVATED LTM candidate configurations satisfying the deactivation conditions/events. The WTRU 102 may transmit an UL indication of any (e.g., all) of the deactivated LTM candidate configurations, such as per the network configuration.

For example, the indication of deactivated LTM candidate configuration may include the transmitting of the identities of configurations for which the status is changed to DEACTIVATED, or the configurations for which the status changes, or the list of currently ACTIVATED configurations.

### Execution Phase—WTRU 102 Controlled LTM Switching

In certain representative embodiments, a WTRU 102 may perform a set of actions for LTM switching to one of the candidate LTM configurations.

For example, a WTRU 102 may perform configured radio and non-radio measurements for the ACTIVATED LTM candidate configurations according to the configured timing for the measurements and/or availability from local sensors (e.g., for switching purposes).

For example, a WTRU 102 may determine its zone through non-radio measurements.

For example, a WTRU 102 may evaluate the configured joint events with the conditions set over measurements of radio and non-radio quantities.

For example, based on the events associated to at least one of the ACTIVATED LTM configurations being triggered, a WTRU 102 may select one of the configurations for which execution events and/or conditions get fulfilled. The selection may be based upon priority information indicated with LTM configurations, intra-DU or inter-DU switching based priority, and/or selection through WTRU 102 implementation.

For example, a WTRU 102 may perform the LTM mobility switch to the target configuration.

For example, a WTRU 102 may perform MAC and/or RLC resetting and initiate PDCP data recovery.

For example, a WTRU 102 may transmit an UL indication as per the network configured signaling.

In certain representative embodiments, some of the WTRU 102 actions (e.g., measurements, zone determination) may be common across the configuration activation, deactivation and LTM switching procedures. The (de-)activation and LTM switching procedures may be performed in parallel at the WTRU 102 according to the configured timings over signals and measurements for these procedures. Although the procedures are described above as individual actions, a WTRU 102 may not perform some actions twice (e.g., relevant measurements from one procedure may be used in another procedure, such as when such information is not outdated).

For example, a WTRU 102 may perform updating of ACTIVATED set of LTM configurations through configured measurements and local decisions, and then these ACTIVATED configurations may be tracked locally through radio and non-radio measurements and executed when the execution conditions get fulfilled. This may be advantageous in terms of latency and overhead reduction. Avoiding periodic measurement reporting to the network and feedback loops where the network makes decisions and informs the WTRU 102s may be beneficial for future (e.g., 6G and beyond) networks. Future networks are expected to have very large numbers of connected devices, and the mobility events may be much more frequent for each of the devices due to high frequency operation and network densification. This may lead to onerous information exchanges for network controlled mobility decision making related to activation and switching decisions. The procedures described herein may bypass (e.g., all) this overhead through enabling intelligent decision making at the mobile devices through a combination of network knowledge, WTRU 102 capabilities and procedures execution being set over joint radio and non-radio conditions and may make mobility much more predictive.

UE Initiated Request to Receive LTM Configuration Candidates based on Radio and Non-Radio Measurements

In certain representative embodiments, a WTRU 102 may perform any (e.g., all) of the steps or actions below as part of a mobility procedure where a WTRU 102 provides an indication to the network requesting to receive suitable LTM candidate configurations based upon radio and non-radio measurements. For example, a WTRU 102 location and/or position, captured in the zone information can be used for triggering a request for LTM candidates. A zone determination may be performed at the WTRU 102 according to the network configuration and parameters.

In certain representative embodiments, a WTRU 102 may have received a network configuration for a WTRU 102 autonomous LTM switching procedure, but the WTRU 102 may lack the candidate configurations after undergoing mobility. For example, the WTRU 102 may not have suitable candidates for its updated location and/or position. For example, the WTRU 102 may transmit information indicating a request to the network to be provided with the configurations of suitable LTM candidates. To keep WTRU 102 overhead minimal, a zone change may be checked as a first condition prior to making a request for additional LTM configurations. This may allow the WTRU 102 to keep processing to a minimum unless (i) the determined zone is different from the previous zone, and/or (ii) there are no configured LTM candidates for the determined zone. When there are no configured candidates for the determined zone, the WTRU 102 may determine the cells in the determined zone, and may make additional radio and non-radio measurements to select suitable cells among those cells. For example, the selected cells may be transmitted to the network to subsequently receive configurations of the selected cells.

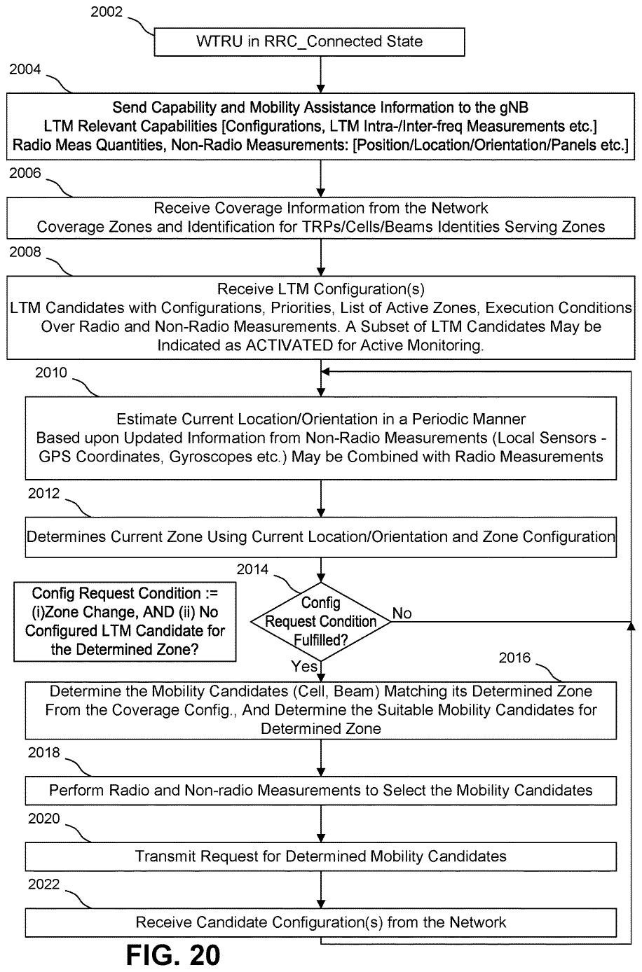

FIG. 20 is a procedural diagram illustrating a representative example of a WTRU 102 candidate configuration request procedure. In certain representative embodiments, a WTRU 102 may perform any (e.g., all) of the steps or actions below as part of a mobility procedure where a WTRU 102 provides an indication to the network requesting to receive suitable LTM candidate configurations based upon radio and non-radio measurements. For example, the WTRU 102 may be assumed to start the LTM procedure from the RRC_Connected state at 2002. The procedure shown in FIG. 20, may be separated into preparation and execution phases.

### Preparation Phase—Configuration

For example, a WTRU 102 may provide information indicating its capability to handle (e.g., different aspects) of lower layer mobility procedure at 2004. For example, the WTRU 102 capability may indicate the WTRU 102 is able to support LTM procedure based upon joint radio and non-radio measurement quantities. Along with LTM relevant capability information (e.g., in a suitable format), the WTRU 102 may also provide mobility assistance information to the network.

For example, the WTRU 102 may receive coverage and deployment topologies and/or the relevant configurations related to zone determination at 2006.

For example, the WTRU 102 may receive one or more LTM configurations at 2008. The WTRU 102 may also receive LTM radio and non-radio measurement quantities and suitable joint events serving to trigger mobility switching. A (e.g., each) LTM candidate configuration may include information indicating a list of active zones where the WTRU 102 may (e.g., will) ACTIVATE this configuration. For example, a subset of LTM configurations may be indicated as ACTIVATED by the network as part of the configuration and/or initialization. The WTRU 102 may be configured with a set of additional periodic measurements for configuration activation and/or deactivation purposes. These measurements may be non-radio measurements, such as those necessary to determine WTRU 102 zone according to the coverage configuration. The WTRU 102 may be configured to request candidate configurations on a zone basis, such as when the WTRU 102 has no configured candidates for the determined zone. Where the WTRU 102 does have one or more candidates associated to the determined zone, the WTRU 102 is further configured to select the most suitable candidates for their radio conditions.

### Execution Phase—Request for Suitable LTM Candidate Configurations

For example, a WTRU 102 may perform configured periodic non-radio measurements. The WTRU 102 may estimate its current location, position and/or orientation at 2010. There may be additional non-radio measurements configured either through local sensors at the WTRU 102 device and/or information received through different interfaces. The WTRU 102 may be configured to determine this information data in terms of location, position, and/or orientation periodically.

For example, the WTRU 102 may determine its zone through the non-radio measurements according to the topology configuration at 2012.

For example, based on the newly determined zone being different from the previous zone and there being no candidate configurations available having the determined zone in their list of active zones at 2014, the WTRU 102 may determine one or more mobility candidates for its determined zone, such as by using the topology configuration received from the network, at 2016. The WTRU 102 may perform additional radio and non-radio measurements to select suitable LTM candidates at 2018. The non-radio measurements may include distance and orientation computation for the candidates. These radio measurements may include the SSB and/or CSI-RS signal quality for the candidates. The WTRU 102 may select a configured number of cells as potential candidates for which the WTRU 102 then transmits an indication to the network requesting to receive the configuration information for the potential candidates at 2020. The WTRU 102 may transmit an UL indication requesting the network to provide the configurations for the potential candidates for the determined zone. The UL indication for configuration request may include the transmission of information indicating the determined zone identity and/or the potential candidate cell IDs which were selected by the WTRU 102.

For example, the WTRU 102 may then receive updated configurations for LTM where at least one of (e.g., each of) the candidate configurations have the determined zone as part of their list of active zones at 2022.

For example, the WTRU 102 may transmit the UL indication for configuration request as (e.g., information in) a MAC CE.

For example, the WTRU 102 can select the cell IDs associated to the determined zone, such as those with which they are aligned with its orientation. The WTRU 102 may select the cell IDs for which there are TRPs are located in the directions matching WTRU 102 orientation (e.g., within a configured threshold margin). For example, this can be achieved by configuring the WTRU 102 with a measurement configuration with the event LTM-OT1 where the target cells those which are associated to the WTRU 102 determined zone, and the reporting may be done for the cell IDs that match the WTRU 102 orientation within the configuration threshold.

For example, the determined cell IDs may be (e.g., additionally) validated based upon radio measurements. These radio measurements may be made using RSs (e.g., SSBs) of these determined cells. The WTRU 102 may be configured to select a (e.g., configured or predetermined) number of the strongest cells for indication as part of the request to the network. The cell strength may be (e.g., configured or predetermined to be) estimated as RSRP and/or RSRQ values.

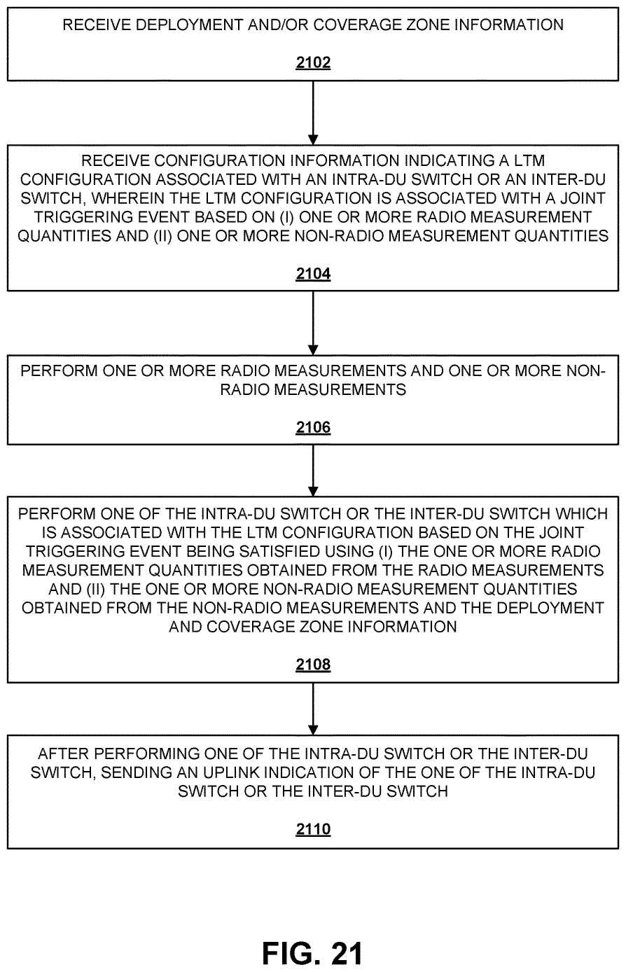

FIG. 21 is a procedural diagram illustrating a representative example of a LTM procedure. In FIG. 21, a WTRU 102 may receive deployment and/or coverage zone information at 2102. At 2104, the WTRU 102 may receive configuration information indicating a LTM configuration associated with an intra-distributed unit (intra-DU) switch or an inter-DU switch. For example, the LTM configuration may be associated with a joint triggering event based on (i) one or more radio measurement quantities and (ii) one or more non-radio measurement quantities. At 2106, the WTRU 102 may perform one or more radio measurements and one or more non-radio measurements. At 2108, the WTRU 102 may perform one of the intra-DU switch or the inter-DU switch which is associated with the LTM configuration based on the joint triggering event being satisfied using (i) the one or more radio measurement quantities obtained from the radio measurements and (ii) the one or more non-radio measurement quantities obtained from the non-radio measurements and the deployment and coverage zone information. At 2110, the WTRU 102 may, after performing one of the intra-DU switch or the inter-DU switch, send an uplink indication of the one of the intra-DU switch or the inter-DU switch.

In certain representative embodiments, the WTRU 102 may determine whether to perform the one of the intra-DU switching or the inter-DU switching based on a parameter of the LTM configuration and a parameter of a serving cell configuration.

In certain representative embodiments, the intra-DU switch is performed from a first cell to a second cell. The first cell and the second cell may be associated with a same DU of a RAN.

In certain representative embodiments, the WTRU 102 may, after performing the intra-DU switch, send and/or receive communications using a MAC entity, a RLC entity and/or PDCP entity which are respectively the same as a MAC entity, a RLC entity and/or a PDCP entity used by the WTRU 102 prior to the intra-DU switch.

In certain representative embodiments, the inter-DU switch is performed from a first cell to a second cell. The first cell and the second cell may be associated with different DUs (e.g., of a RAN).

In certain representative embodiments, the WTRU 102 may, after performing the inter-DU switch, send and/or receive communications using a MAC entity and/or a RLC entity which are respectively different than a MAC entity and/or a RLC entity used by the WTRU 102 prior to the inter-DU switch.

In certain representative embodiments, the WTRU 102 may, after performing the inter-DU switch, perform PDCP data recovery.

In certain representative embodiments, the WTRU 102 may send capability information indicating support of WTRU-controlled LTM prior to receiving the configuration information indicating the LTM configuration.

In certain representative embodiments, the WTRU 102 may receive configuration information indicating the joint triggering event.

In certain representative embodiments, the WTRU 102 may receive information indicating to activate the LTM configuration.

In certain representative embodiments, the WTRU 102 may determine to activate the LTM configuration based on the deployment and coverage zone information, the one or more radio measurements, and the one or more non-radio measurements.

In certain representative embodiments, the WTRU 102 may determine the joint triggering event is satisfied using the one or more radio measurement quantities obtained from the radio measurements and the one or more non-radio measurement quantities obtained from the non-radio measurements.

In certain representative embodiments, the WTRU 102 may determine the joint triggering event is satisfied based on (i) the WTRU being located in a zone indicated by the coverage zone information and (ii) a comparison of a radio measurement quantity associated with a neighbor cell in the zone and a threshold.

In certain representative embodiments, the WTRU 102 may determine the joint triggering event is satisfied based on (i) a comparison of a difference between an orientation of the WTRU and an orientation of a neighbor transmission/reception point (TRP) and a difference between the orientation of the WTRU and an orientation of a serving TRP, (ii) a comparison of a distance of the WTRU to the serving TRP and a distance of the WTRU to the neighbor TRP, and (iii) a comparison of a radio measurement quantity associated with the neighbor TRP and a threshold.

In certain representative embodiments, the WTRU 102 may determine the joint triggering event is satisfied based on (i) the WTRU being located in a zone indicated by the coverage zone information and (ii) a comparison of a radio measurement quantity associated with a reference cell in the zone and a radio measurement quantity associated with a serving cell.

In certain representative embodiments, the WTRU 102 may determine the joint triggering event is satisfied based on (i) a comparison of a difference between an orientation of the WTRU and an orientation of a serving cell and a difference between the orientation of the WTRU and an orientation of a reference cell, (ii) a comparison of a distance of the WTRU to the serving cell and a distance of the WTRU to the reference cell, and (iii) a comparison of a radio measurement quantity associated with the serving cell and a radio measurement quantity associated with the reference cell.

In certain representative embodiments, the WTRU 102 may determine the joint triggering event is satisfied based on (i) the WTRU being located in a zone indicated by the coverage zone information, (ii) a comparison of a velocity of the WTRU and a first threshold, and (iii) a comparison of a radio measurement quantity associated with a reference cell in the zone and a second threshold.

In certain representative embodiments, the one or more radio measurement quantities may include ude any of a reference signal received power (RSRP), a reference signal received quality (RSRQ), a signal-to-noise and interference (SINR), a received signal strength indicator (RSSI), a reference signal time difference (RSTD), and/or a reference signal antenna relative phase (RSARP).

In certain representative embodiments, the one or more non-radio measurement quantities include any of a global navigation satellite system (GNSS) code measurement quantity, a GNSS carrier phase measurement quantity, a wireless local area network (WLAN) received signal strength indicator (RSSI), a Bluetooth signal power, a Bluetooth source identifier, a radio frequency pattern identifier, a terrestrial beacon system quantity, a linear acceleration quantity and/or change thereof, a linear velocity and/or change thereof, an orientation and/or change thereof, an angular velocity and/or change thereof, an atmospheric pressure and/or change thereof, and/or a magnetic field strength and/or change thereof.

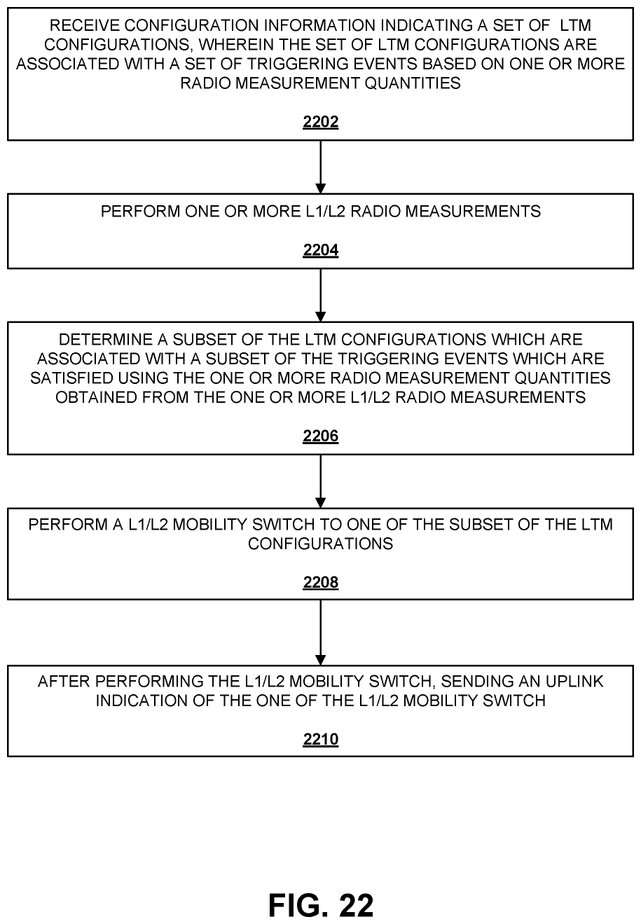

FIG. 22 is a procedural diagram illustrating a representative example of another LTM procedure. In FIG. 22, the WTRU 102 may receive configuration information indicating a set of LTM configurations at 2202. For example, the set of LTM configurations are associated with a set of triggering events based on one or more radio measurement quantities. At 2204, the WTRU 102 may perform one or more L1/L2 radio measurements. At 2206, the WTRU 102 may determine a subset of the LTM configurations which are associated with a subset of the triggering events which are satisfied using the one or more radio measurement quantities obtained from the one or more L1/L2 radio measurements. At 2208, the WTRU 102 may perform a L1/L2 mobility switch to one of the subset of the LTM configurations. At 2210, the WTRU 102 may, after performing the L1/L2 mobility switch, send an uplink indication of the L1/L2 mobility switch (e.g., intra- or the inter-DU switch).

In certain representative embodiments, the WTRU 102 may determine the one of the subset of the LTM configurations which is associated with a highest priority from among the subset of the LTM configurations.

In certain representative embodiments, the WTRU 102 may receive information indicating to activate two or more of the set of LTM configurations. For example, the subset of the LTM configurations are determined from among the activated LTM configurations.

In certain representative embodiments, the WTRU 102 may determine the subset of the LTM configurations which includes determining a first LTM configuration, of the LTM configurations, which is associated with a first triggering event which is satisfied using a first radio measurement quantity obtained from the one or more L1/L2 radio measurements, and determining a second LTM configuration, of the LTM configurations, which is associated with a second triggering event which is satisfied using a second radio measurement quantity obtained from the one or more L1/L2 radio measurements.

In certain representative embodiments, the WTRU 102 may, after performing the L1/L2 mobility switch, send and/or receive communications using a medium access control (MAC) entity and/or a radio layer control (RLC) entity which are respectively different than a MAC entity and/or a RLC entity used by the WTRU prior to the L1/L2 mobility switch.

In certain representative embodiments, the WTRU 102 may, after performing the L1/L2 mobility switch, perform packet data convergence protocol (PDCP) data recovery based on the one of the subset of the LTM configurations.

In certain representative embodiments, the WTRU 102 may determine a first triggering event, which is associated with a first LTM configuration of the LTM configurations, is satisfied based on a comparison of a first radio measurement quantity obtained from the one or more L1/L2 radio measurements associated with a serving TRP and a threshold.

In certain representative embodiments, the WTRU 102 may determine a first triggering event, which is associated with a first LTM configuration of the LTM configurations, is satisfied based on a comparison of a first radio measurement quantity obtained from the one or more L1/L2 radio measurements associated with a neighbor TRP and a second radio measurement quantity obtained from the one or more L1/L2 radio measurements associated with a serving TRP.

In certain representative embodiments, the WTRU 102 may determine a first triggering event, which is associated with a first LTM configuration of the LTM configurations, is satisfied based on a comparison of a first radio measurement quantity obtained from the one or more L1/L2 radio measurements associated with a neighbor TRP and a threshold.

In certain representative embodiments, the WTRU 102 may determine a first triggering event, which is associated with a first LTM configuration of the LTM configurations, is satisfied based on (i) a comparison of a first radio measurement quantity obtained from the one or more L1/L2 radio measurements associated with a serving TRP and a first threshold, and (ii) a comparison of a second radio measurement quantity obtained from the one or more L1/L2 radio measurements associated with a neighbor TRP and a second threshold.

In certain representative embodiments, the WTRU 102 may determine a first triggering event, which is associated with a first LTM configuration of the LTM configurations, is satisfied based on a comparison of a first radio measurement quantity obtained from the one or more L1/L2 radio measurements associated with a serving TRP and a second radio measurement quantity obtained from the one or more L1/L2 radio measurements associated with a neighbor TRP.

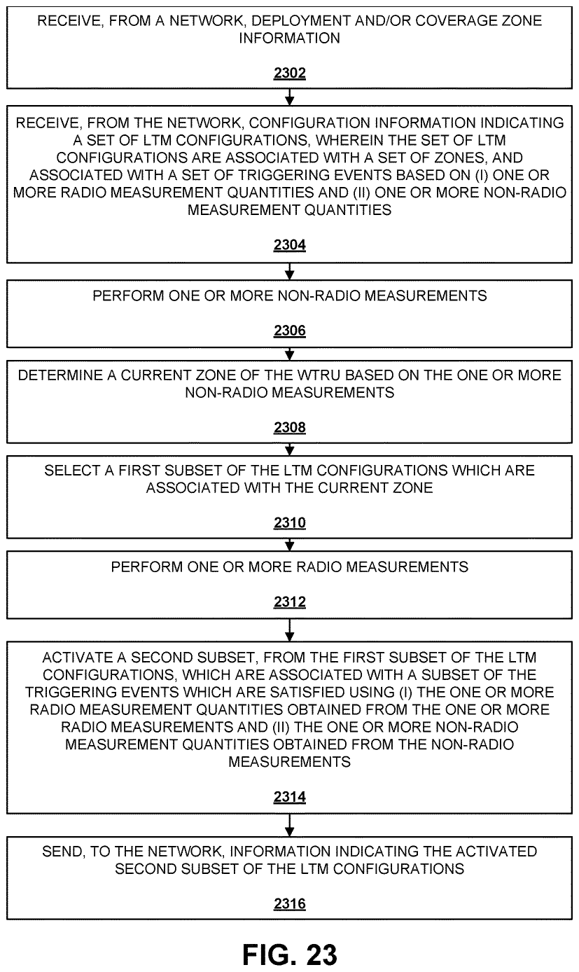

FIG. 23 is a procedural diagram illustrating a representative example of another LTM procedure. In FIG. 23, the WTRU 102 may receive, from a network, deployment and/or coverage zone information at 2302. At 2304, the WTRU 102 may receive, from the network, configuration information indicating a set of LTM configurations. For example, the set of LTM configurations may be (e.g., respectively) associated with a set of zones, and (e.g., respectively) associated with a set of triggering events based on (i) one or more radio measurement quantities and (ii) one or more non-radio measurement quantities. At 2306, the WTRU 102 may perform one or more non-radio measurements. At 2308, the WTRU 102 may determine a current zone of the WTRU 102 (e.g., based on the one or more non-radio measurements). At 2310, the WTRU 102 may select a first subset of the LTM configurations which are associated with the current zone. At 2312, the WTRU 102 may perform one or more radio measurements. At 2314, the WTRU 102 may activate a second subset, from the first subset of the LTM configurations, which are associated with a subset of the triggering events which are satisfied using (i) the one or more radio measurement quantities obtained from the one or more radio measurements and (ii) the one or more non-radio measurement quantities obtained from the non-radio measurements. At 2316, the WTRU 102 may send, to the network, information indicating the activated second subset of the LTM configurations.

In certain representative embodiments, the WTRU 102 may determine the current zone of the WTRU based on the one or more non-radio measurements including determining a current location of the WTRU 102 using the one or more non-radio measurements, and determining the current zone using the current location of the WTRU 102 and the deployment and/or coverage information.

In certain representative embodiments, each of the LTM configurations is respectively associated with a subset of zones. For example, the WTRU 102 may select the first subset of the LTM configurations which are associated with the current zone which includes deactivating all, or any activated, LTM configurations of the set of LTM configurations, and determining (e.g., activating) the first subset of the LTM configurations as each of the deactivated LTM configurations which includes the current zone in the associated subset of zones.

In certain representative embodiments, the configuration information may include an indication to activate two or more of the set of LTM configurations.

In certain representative embodiments, the WTRU 102 may activate the second subset from the first subset of the LTM configurations which includes activating a first LTM configuration, from the first subset of the LTM configurations, which is associated with a first triggering event which is satisfied using a first radio measurement quantity obtained from the one or more radio measurements, and a first non-radio measurement quantity obtained from the non-radio measurements, and activating a second LTM configuration, from the first subset of the LTM configurations, which is associated with a second triggering event which is satisfied using a second radio measurement quantity obtained from the one or more radio measurements, and a second non-radio measurement quantity obtained from the non-radio measurements.

In certain representative embodiments, the WTRU 102 may perform a L1/L2 mobility switch (e.g., intra- or inter-DU switch) to (e.g., using) one of the activated second subset of the LTM configurations.

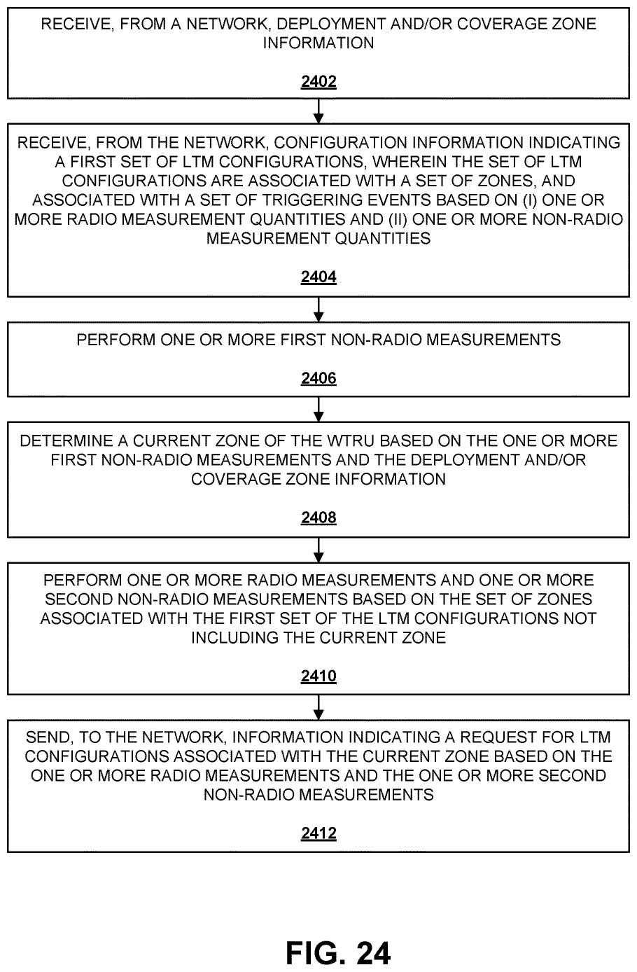

FIG. 24 is a procedural diagram illustrating a representative example of another LTM procedure. In FIG. 24, a WTRU 102 may receive, from a network, deployment and/or coverage zone information at 2402. At 2404, the WTRU 102 may receive, from the network, configuration information indicating a first set of LTM configurations. For example, the set of LTM configurations may be (e.g., respectively) associated with a set of zones, and may be associated with a set of triggering events based on (i) one or more radio measurement quantities and (ii) one or more non-radio measurement quantities. The WTRU 102 may perform one or more first non-radio measurements at 2406. At 2408, the WTRU 102 may determine a current zone of the WTRU 102 (e.g., based on the one or more first non-radio measurements and the deployment and/or coverage zone information). At 2410, the WTRU 102 may perform one or more radio measurements and one or more second non-radio measurements based on the set of zones associated with the first set of the LTM configurations not including the current zone (e.g., not having any active LTM configurations for the current zone). At 2412, the WTRU 102 may send, to the network, information indicating a request for LTM configurations associated with the current zone based on the one or more radio measurements and the one or more second non-radio measurements.

In certain representative embodiments, the information indicating the request may be included in a MAC-CE.

In certain representative embodiments, the WTRU 102 may select a set of candidate cells using the one or more radio measurements, the one or more second non-radio measurements, and the deployment and/or coverage zone information. For example, the information indicating the request for LTM configurations associated with the current zone may include information indicating the set of candidate cells (and/or beams).

In certain representative embodiments, the WTRU 102 may select the set of candidate cells using SSB and/or CSI-RS measurements associated with the set of candidate cells (and/or beams) as the one or more radio measurements.

In certain representative embodiments, the WTRU 102 may select the set of candidate cells using using distance and/or orientation measurements associated with the set of candidate cells as the one or more second non-radio measurements.

In certain representative embodiments, the WTRU 102 may select the set of candidate cells using the one or more radio measurements, the one or more second non-radio measurements, and the deployment and/or coverage zone information based on a determination that a LTM non-radio event is triggered for the set of candidate cells using the one or more second non-radio measurements.

In certain representative embodiments, the WTRU 102 may select the set of candidate cells using the one or more radio measurements, the one or more second non-radio measurements, and the deployment and/or coverage zone information based on a determination that a LTM non-radio event is triggered for the set of candidate cells using the one or more second non-radio measurements and/or the deployment and/or coverage zone information.

In certain representative embodiments, the WTRU 102 may select the set of candidate cells using the one or more radio measurements, the one or more second non-radio measurements, and the deployment and/or coverage zone information based on a determination that a RSRP and/or RSRQ threshold is satisfied for (e.g., each respective one of) the set of candidate cells using the one or more radio measurements.

In certain representative embodiments, the WTRU 102 may receive configuration information indicating a maximum number for the set of candidate cells.

In certain representative embodiments, the WTRU 102 may receive, from the network, configuration information indicating a second set of LTM configurations. For example, the second set of LTM configurations may be associated with a set of zones which include the current zone, and associated with a set of triggering events based on (i) one or more radio measurement quantities and (ii) one or more non-radio measurement quantities.

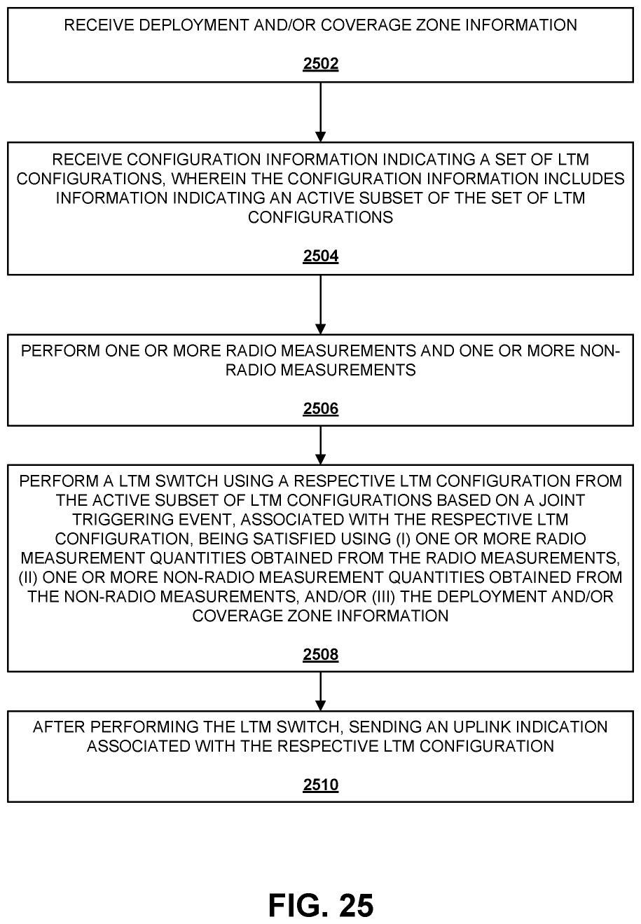

FIG. 25 is a procedural diagram illustrating a representative example of another LTM procedure. In FIG. 25, a WTRU 102 may receive deployment and/or coverage zone information at 2502. Various examples of the deployment and coverage information are described herein. At 2504, the WTRU 102 may receive configuration information indicating a set of LTM configurations. For example, the configuration information may include information indicating an active subset of the set of LTM configurations. At 2506, the WTRU 102 may perform one or more radio measurements and one or more non-radio measurements. At 2508, the WTRU 102 may perform a LTM switch (e.g., intra- or inter-DU switch) using a respective LTM configuration from the active subset of LTM configurations based on a joint triggering event being satisfied using (i) one or more radio measurement quantities obtained from the radio measurements, (ii) one or more non-radio measurement quantities obtained from the non-radio measurements, and/or (iii) the deployment and/or coverage zone information. The joint triggering event may be associated with the respective LTM configuration. Various examples of joint triggering events are described herein. After performing the LTM switch, the WTRU 102 may send an uplink indication associated with the respective LTM configuration at 2510. Various examples of the uplink indication are described herein.

In certain representative embodiments, a WTRU 102 may receive information indicating one or more LTM configurations. For example, the one or more LTM configurations may be associated with (or include) one or more events for triggering LTM switching to one or more respective candidate cells and/or beams. The WTRU 102 may perform a first set of radio measurements and non-radio measurements. The WTRU 102 may perform an LTM switch to one of the candidate cells and/or beams based on (e.g., using) one of the LTM configurations. For example, the one of the LTM configurations may be associated with one of the events that is triggered using the first set of radio and non-radio measurements.

In certain representative embodiments, the WTRU 102 may, after performing the LTM switch, transmit information indicating the LTM switch to the one of the candidate cells and/or beams. For example, the information indicating the LTM switch may include any of a PRACH transmission, a RACH preamble, a reference signal, and/or a PUCCH transmission.

In certain representative embodiments, the WTRU 102 may determine a current zone of the WTRU 102 based on a second set of non-radio measurements (e.g., location and/or orientation measurements). The WTRU 102 may select at least one of the LTM configurations based on the current zone of the WTRU 102.

In certain representative embodiments, the first set of radio measurements and non-radio measurements may be performed based on the selected at least one of the LTM configurations. The LTM switch may be performed based on the selected at least one of the LTM configurations.

In certain representative embodiments, the LTM switch to the one of the candidate cells and/or beams may be performed based on priority information included in the one of the LTM configurations.

In certain representative embodiments, the LTM switch may be an intra-DU switch from a serving cell to the one of the candidate cells which are deployed through a single DU (e.g., at the RAN 113).

In certain representative embodiments, the LTM switch may be an inter-DU switch from a serving cell deployed through a first DU to the one of the candidate cells deployed through a second DU different than the first DU.

In certain representative embodiments, the LTM switch may be a conditional LTM switch from a serving cell to the one of the candidate cells.

### CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

1. A method implemented by a wireless transmit/receive unit (WTRU), the method comprising:
receiving deployment and/or coverage zone information;
receiving configuration information indicating a L1/L2 Triggered Mobility (LTM) configuration associated with an intra-distributed unit (intra-DU) switch or an inter-DU switch, wherein the LTM configuration is associated with a joint triggering event based on (i) one or more radio measurement quantities and (ii) one or more non-radio measurement quantities;
performing one or more radio measurements and one or more non-radio measurements;
performing one of the intra-DU switch or the inter-DU switch which is associated with the LTM configuration based on the joint triggering event being satisfied using (i) the one or more radio measurement quantities obtained from the radio measurements and (ii) the one or more non-radio measurement quantities obtained from the non-radio measurements and the deployment and/or coverage zone information; and
after performing the one of the intra-DU switch or the inter-DU switch, sending an uplink indication of the one of the intra-DU switch or the inter-DU switch.

2.-3. (canceled)

4. The method of claim 1, further comprising:
after performing the intra-DU switch, sending and/or receiving communications using a medium access control (MAC) entity, a radio layer control (RLC) entity and/or packet data convergence protocol (PDCP) entity which are respectively the same as a MAC entity, a RLC entity and/or a PDCP entity used by the WTRU prior to the intra-DU switch.

5. (canceled)

6. The method of claim 15, further comprising:
after performing the inter-DU switch, sending and/or receiving communications using a medium access control (MAC) entity and/or a radio layer control (RLC) entity which are respectively different than a MAC entity and/or a RLC entity used by the WTRU prior to the inter-DU switch.

7. The method of claim 1, further comprising:
after performing the inter-DU switch, performing packet data convergence protocol (PDCP) data recovery.

8.-12. (canceled)

13. The method of claim 1, further comprising:
determining the joint triggering event is satisfied based on (i) the WTRU being located in a zone indicated by the deployment and/or coverage zone information and (ii) a comparison of a radio measurement quantity associated with a neighbor cell in the zone and a threshold.

14. (canceled)

15. The method of claim 1, further comprising:
determining the joint triggering event is satisfied based on (i) the WTRU being located in a zone indicated by the deployment and/or coverage zone information and (ii) a comparison of a radio measurement quantity associated with a reference cell in the zone and a radio measurement quantity associated with a serving cell.

16. The method of claim 1, further comprising:
determining the joint triggering event is satisfied based on (i) a comparison of a difference between an orientation of the WTRU and an orientation of a serving cell and a difference between the orientation of the WTRU and an orientation of a reference cell, (ii) a comparison of a distance of the WTRU to the serving cell and a distance of the WTRU to the reference cell, and (iii) a comparison of a radio measurement quantity associated with the serving cell and a radio measurement quantity associated with the reference cell.

17. The method of claim 1, further comprising:
determining the joint triggering event is satisfied based on (i) the WTRU being located in a zone indicated by the deployment and/or coverage zone information, (ii) a comparison of a velocity of the WTRU and a first threshold, and (iii) a comparison of a radio measurement quantity associated with a reference cell in the zone and a second threshold.

18. The method of claim 1, wherein the one or more radio measurement quantities include any of a reference signal received power (RSRP), a reference signal received quality (RSRQ), a signal-to-noise and interference (SINR), a received signal strength indicator (RSSI), a reference signal time difference (RSTD), and/or a reference signal antenna relative phase (RSARP).

19. The method of claim 1, wherein the one or more non-radio measurement quantities include any of a global navigation satellite system (GNSS) code measurement quantity, a GNSS carrier phase measurement quantity, a wireless local area network (WLAN) received signal strength indicator (RSSI), a Bluetooth signal power, a Bluetooth source identifier, a radio frequency pattern identifier, a terrestrial beacon system quantity, a linear acceleration quantity and/or change thereof, a linear velocity and/or change thereof, an orientation and/or change thereof, an angular velocity and/or change thereof, an atmospheric pressure and/or change thereof, and/or a magnetic field strength and/or change thereof.

20. A wireless transmit/receive unit (WTRU) comprising:
a processor, memory, and a transceiver which are configured to:
receive deployment and/or coverage zone information,
receive configuration information indicating a L1/L2 Triggered Mobility (LTM) configuration associated with an intra-distributed unit (intra-DU) switch or an inter-DU switch, wherein the LTM configuration is associated with a joint triggering event based on (i) one or more radio measurement quantities and (ii) one or more non-radio measurement quantities,
perform one or more radio measurements and one or more non-radio measurements,
perform one of the intra-DU switch or the inter-DU switch which is associated with the LTM configuration based on the joint triggering event being satisfied using (i) the one or more radio measurement quantities obtained from the radio measurements and (ii) the one or more non-radio measurement quantities obtained from the non-radio measurements and the deployment and/or coverage zone information, and
after performing the one of the intra-DU switch or the inter-DU switch, send an uplink indication of the one of the intra-DU switch or the inter-DU switch.

21.-22. (canceled)

23. The WTRU of claim 20, wherein the processor, memory, and the transceiver are configured to:
after performing the intra-DU switch, send and/or receive communications using a medium access control (MAC) entity, a radio layer control (RLC) entity and/or packet data convergence protocol (PDCP) entity which are respectively the same as a MAC entity, a RLC entity and/or a PDCP entity used by the WTRU prior to the intra-DU switch.

24. (canceled)

25. The WTRU of claim 20, wherein the processor, memory, and the transceiver are configured to:
after performing the inter-DU switch, send and/or receive communications using a medium access control (MAC) entity and/or a radio layer control (RLC) entity which are respectively different than a MAC entity and/or a RLC entity used by the WTRU prior to the inter-DU switch.

26. The WTRU of claim 20, wherein the processor, memory, and the transceiver are configured to:
after performing the inter-DU switch, perform packet data convergence protocol (PDCP) data recovery.

27.-31. (canceled)

32. The WTRU of claim 20, wherein the processor, memory, and the transceiver are configured to:
determine the joint triggering event is satisfied based on (i) the WTRU being located in a zone indicated by the deployment and/or coverage zone information and (ii) a comparison of a radio measurement quantity associated with a neighbor cell in the zone and a threshold.

33. (canceled)

34. The WTRU of claim 20, wherein the processor, memory, and the transceiver are configured to:
determine the joint triggering event is satisfied based on (i) the WTRU being located in a zone indicated by the deployment and/or coverage zone information and (ii) a comparison of a radio measurement quantity associated with a reference cell in the zone and a radio measurement quantity associated with a serving cell.

35. The WTRU of claim 20, wherein the processor, memory, and the transceiver are configured to:
determine the joint triggering event is satisfied based on (i) a comparison of a difference between an orientation of the WTRU and an orientation of a serving cell and a difference between the orientation of the WTRU and an orientation of a reference cell, (ii) a comparison of a distance of the WTRU to the serving cell and a distance of the WTRU to the reference cell, and (iii) a comparison of a radio measurement quantity associated with the serving cell and a radio measurement quantity associated with the reference cell.

36. The WTRU of claim 20, wherein the processor, memory, and the transceiver are configured to:
determine the joint triggering event is satisfied based on (i) the WTRU being located in a zone indicated by the deployment and/or coverage zone information, (ii) a comparison of a velocity of the WTRU and a first threshold, and (iii) a comparison of a radio measurement quantity associated with a reference cell in the zone and a second threshold.

37. The WTRU of claim 20, wherein the one or more radio measurement quantities include any of a reference signal received power (RSRP), a reference signal received quality (RSRQ), a signal-to-noise and interference (SINR), a received signal strength indicator (RSSI), a reference signal time difference (RSTD), and/or a reference signal antenna relative phase (RSARP).

38. The WTRU of claim 20, wherein the one or more non-radio measurement quantities include any of a global navigation satellite system (GNSS) code measurement quantity, a GNSS carrier phase measurement quantity, a wireless local area network (WLAN) received signal strength indicator (RSSI), a Bluetooth signal power, a Bluetooth source identifier, a radio frequency pattern identifier, a terrestrial beacon system quantity, a linear acceleration quantity and/or change thereof, a linear velocity and/or change thereof, an orientation and/or change thereof, an angular velocity and/or change thereof, an atmospheric pressure and/or change thereof, and/or a magnetic field strength and/or change thereof.
